(19) United States
(12) Patent Application Publication
(10) Pub. No.: US 2006/0101133 A1
(43) Pub. Date: May 11, 2006

(54) System and method for intermediation of services

(76) Inventors: Patrick Sbrzesny, Stuttgart (DE); Heiko Wohr, Stuttgart (DE)

Correspondence Address: WILMER CUTLER PICKERING HALE AND DORR LLP, 60 STATE STREET, BOSTON, MA, 02109, US

(21) Appl. No.: 11/220,941

(22) Filed: Sep. 7, 2005

Related U.S. Application Data
(60) Provisional application No. 60/626,457, filed on Nov. 10, 2004.

(51) Int. Cl. G06F 15/177

(52) U.S. Cl. 709/220

(57) ABSTRACT

A rule-based system and method for querying scale-free social networks for solving problems based on problem criteria is disclosed. The rule-based system may be facilitated by a computer-based system. The rule-based system will enable the effective and efficient use of the human-to-human interactions of experts and knowledgeable individuals to obtain solutions to all types of problems. The entity desiring a solution to a problem will interact with scale-free social networks using the rule-based system. The rule-based system will be used to define the parameters of the problem and provide these parameters to individuals who agree to participate in attempting to reach a solution to the problem. Facilitated by a computer-based system using a global communications network, such as the Internet, the entity seeking a problem solution will contact individuals who are believed to have the solution to the problem. The first individual from whom the solution is sought will receive the question over the Internet. That individual may take one of three actions upon receipt of the question. The first is to answer the question, the second is to forward the question to another entity for answering, and the third is to reject the question. Each selection will have a different effect on the process for finding a solution to the problem.

### RELATED APPLICATIONS

This application claims the benefit of priority under 35 U.S.C. § 19(e) from U.S. Provisional Application Ser. No. 60/626,457 filed Nov. 10, 2004, entitled “System und Verfahren zur Vermittlung von Leistungen.”

### FIELD OF THE INVENTION

The present invention relates to systems and methods that will assist in reaching a solution to a problem that may be implemented using an interactive global communications network, such as the Internet.

### BACKGROUND OF THE INVENTION

In the past, if there was a problem to be solved, the tendency has been for an individual to amass as much information as possible, then attempt to distill the collected information, draw on his/her experience, gather anecdotal information from others, and come to a decision on the solution to the problem. If there were any two problems before that individual, the decision process most likely took two different paths. Moreover, even when the individual was faced with the same set of problem facts at different times, that individual would tend to take two different decision paths to reach a solution because it was hard to remember exactly what he/she had done before. This was partly because there were no rules to control the process for obtaining a problem solution; they tended to take purely random paths.

In May 2003, there was recognition of scale-free networks. These networks addressed the issues of complex networks having some nodes with a tremendous number of connections while other nodes may have just a few connections. It was found that these types of networks had applicability to solution paths for solving problems.

To put scale-free networks into perspective, one node of the network may have hundreds, thousands, or even millions of links, and other nodes of the same network may have just a handful. The important nodes, the ones with what would be considered a disproportionate number of links are referred to as hubs.

Typically, scale-free networks do not follow a Poisson distribution (bell curve) but principally follow the power laws, which is that the probability that any given node would be connected to “k” other nodes would be proportionate to 1/kⁿ, where “n” was approximately 2 for incoming lines. As such, any node was approximately four times as likely to have just half the number of incoming links as another node. Power laws differ greatly from Poisson distributions that are typically used to characterize random networks, which would include random problem solutions.

Unlike random networks, scale-free networks permit the existence of hubs. Social networks, which involve human-to-human interaction, are scale-free networks with hubs when probed to search for a solution for any given problem. The person with this problem will first seek someone who is believed to have the answers rather than just randomly selecting someone to answer the question. However, an issue that is always present in scale-free networks, particularly scale-free social networks, is how to effectively harness and control such networks because it involves humans as network nodes and hubs.

Noting this and other issues to be discussed herein, when an individual is faced with a set of problem facts, there are a number of strategies that may be employed to solve the problem in a social scale-free network. These may include only the individual or others, or a combination of both. For example, the strategies that may be considered by the individual faced with certain problem facts are ones that have primary reliance on the individual or reliance on probing the social scale-free network. If there is a reliance on the individual to solve his/her problem, he/she may (i) acquire additional information to solve the problem or (ii) acquire a physical product if that will in fact solve the problem. If the individual desires to use a social scale-free network, typically it results in not really making use of the entire network because there is no rule-based structured way to make inquiries into the network. What typically happens is the individual with the problem will seek out and identify a third person presumably with the special skill set needed to resolve the problem. There is no significant network penetration that would result in increasing the probability of finding an answer. The rather superficial inquiry methods just discussed usually result in no answer being found at the first or second levels that ends the inquiry. Part of the reason for this is that there is no rule-based method to drill down into the social scale-free network that, in most cases, would allow a level of branching for finding the answer to his/her problem whether it is simple or complex. Examples of existing methods of making inquiries in social and other networks will be discussed.

Information

Generally, if the solution to a problem falls in this category, the required information (solution) may be obtained by research or by asking another person. Examples of problems that may be solved by research or asking someone are:
1. When was Maria Montessori born and in what year did she die?
2. What are the issues one must be careful about in filling out a tenancy agreement?
3. On what type of architecture should a Portfolio Management System be based?
4. What is the appropriate procedure for applying for a United States patent?
5. What is the best procedure the import historic automobiles from California to Germany, and what are the pitfalls?

Researching publicly available documents would be an effective method to find a solution to the problems listed above because they are all essentially fact-based. This research could be accomplished, for example, in a library or on-line using a global communications network, such as the Internet or World-Wide Web (“WWW”).

Being more specific, on-line search engines and catalogues would be helpful tools for finding the solution to problem “1” since it is highly specific and a focused search, in all likelihood, would produce the solution. If an on-line or off-line library search was conducted to obtain the problem solution, it should be successful given that the problem would be one of general public interest, which would increase the probability the solution would be found using such a solution strategy.

If the problem is more general in nature, such a problems “2,” “3,” and “4,” then the chance of finding the solution by a simple on-line or off-line search is significantly reduced. One of the principal reasons for the ineffectiveness of using the methods that were used to solve problem “1” is the ambiguity of the words that would be used to describe the problem. For example, in problem “3,” the term “architecture” may be associated with a building rather than a computer system to which the question was directed. Therefore, the individual conducting the search may have to try a large number of requests with key words modifying architecture or use appropriate synonyms to attempt to solve the problem. Thus, the individual conducting the search must be very skilled in using search engines to possibly obtain a successful result.

There is a greater challenge in attempting to find the solution to problems “4” and “5” using on-line and off-line searching. As the problems themselves suggest, the solution will require an array of answers. The first challenge with regard to these problems is the individual's ability to understand and comprehend the scope of the question. That, in and of itself, would require considerable research and study. Once that was accomplished, then, and only then, would the individual be able to try to tackle the issues of these problems.

One possible strategy for attempting to solve problems, such as those posed by question “3” and “5,” would be to consult an expert in the particular area of interest. This can considerably reduce the time needed to find a solution. Moreover, an expert may be able to provide advice that has greater credibility than a non-expert who has simply waded through public documents that allegedly contain the needed information. The expert also can proactively provide additional content that the non-expert would not be able to provide. However, consulting an expert will begin the process of entering scale-free social networks.

Even contacting an expert does not guarantee that a solution will be found because the expert you contact may not readily have the answer. In such a case, an expert without the answer is no better than a non-expert if he/she could not point out someone else who could provide the solution. Even if the first expert does point out a second expert, this is again no guarantee that the second expert would have the answer and, if not, would pass the question on to another expert. It is expected that at one of these first few levels, the question will just languish and remain unanswered because of the lack of a rule-based way to drill down into the scale-free social network.

Physical Products

Another strategy discussed above is one in which the solution to a problem is a physical product. The following four examples are problems that require a physical product as the solution:
6. When can someone obtain a Porsche 933, model year 1993, with no greater than 60,000 km, for no more than 30,000 Euros?
7. Who can provide two tickets to Don Giovanni for the show in 14 days at the Stuttgart Opera?
8. Who can help find a room in an apartment-sharing community in Tübingen for the period Oct. 1, 2004 through Feb. 28, 2005?
9. Where may someone obtain a telephone system suitable for a medium-sized business?

The fulfillment of most daily needs for physical products can be accomplished using traditional time-tested methods such as searching through stores and shops, or identifying products in catalogues, yellow pages, or the like. As personal computers have become more prevalent, many individuals are finding that there are many on-line and on-line-identified off-line marketplaces to find a multitude of products beyond the general accessibility of the average individual using traditional searching methods. This extends to many different types of products including those that are complex and require significant explanation, and are not susceptible to simple one- or two-word search criteria.

When an individual searches for typical products, there is little explanation needed. Sometimes, one or two words of explanation are all that is needed to identify the product and acquire it. This would apply to both on-line and off-line searches for products. Examples of these types of inquires are found in problems “6” and “7.” In problem “6,” there is a very specific need that can be solved by a series of very specific questions. Problem “7,” on the other hand, could be searched using an on-line search engine that could lead to an offer for the requested tickets.

Problem “8” would be a typical problem that would be faced by a college student. This may involve a different type of searching beyond what is normally done. Students could make inquires of persons known to them to have knowledge of student living accommodations in the geographic area of interest. This could be done by informal inquiries along with a formal on-line search.

The solution to problem “9” may be found using a method similar to that used for solving problem “8.” In many cases, manufacturers of mid-sized telecommunications systems directly support a large number of clients. Therefore, consulting a manager of one or more mid-sized business(es) may provide the information to solve the problem. This type of informal input may help an individual make an informed selection of a telecommunications system without the need for an in-depth knowledge of the system the manager wants to acquire.

The use of the tools mentioned above to find a physical object required, in any case, a great deal of persistence on the part of the individual seeking the physical product. For example, the college student may be required to talk to a large number of first level individuals and to each of them explain the same problem. The student would gain no benefit from all of his/her previous inquiries. By remaining at the first and second levels of inquiries in this fashion, the student may speak to many people attempting to have his/her problem solved. If they could do this, it would increase the probability an answer will be obtained.

The solutions to problems 8 and 9 require solutions from a scale-free social network. The examples given do not provide a rule-based method to exploit searching such a network. If this could be done, it would increase the probability that the answer will be obtained.

Expertise

Yet another strategy relates to problems that may require a person of particular expertise to provide a solution. The following five problems are ones in which the solution may be found with a person with particular expertise:
10. Who can paint my apartment?
11. Who can cover my walls with veneziano?
12. Who can optimize the memory management of a Java virtual system for use in a real-time environment?
13. Who can help me do the taxes for my small business?
14. Who can set up a DSL and a wireless LAN for me?

There are certain problems that require a person with a particular skill set to solve. Once that skill set is determined, then that person may be found. There are a number of existing resources that list experts that solve problems beyond the capabilities of normal professionals. Problem “10” is one that could be solved by a normal professional and does not require a particular special skill set. A local telephone directory, for example, would provide a number of individuals who could solve the problem. Problem “11,” on the other hand, is one in which the solution will require skills within an area of expertise. An efficient method to solve the problem may be to search the Internet with search engines inputting the appropriate key words.

There are software-based systems currently being developed that provide more sophisticated capabilities to identify experts. Some of these systems provide methods to automatically search for experts based on the problem description rather than just seeking to identify an expert in a particular technology or non-technology area of interest. These systems under development are becoming possible because the knowledge base includes the profiles of these experts.

There are other situations where the problem to be solved does require expert skill but this expert skill is of a general nature that may be obtained with resources that are generally available to an individual. This is the case in problem “13.” Although a tax expert may be consulted, a number of other small business owners or friends could be asked to help solve the problem.

Problem “14” may be solved using local off-line directories or the identification of an appropriate person by an on-line search. The purchase of such services may be fine in the business environment, but this may be an expensive undertaking for an individual. The individual may try to find someone in his or her own circle of friends to help, but that would not guarantee a solution. Therefore, it may not be as easy for an individual to find the solution at a reasonable price.

The use of experts in the context of the last strategy category will suffer from several of the problems identified for the first and second strategies in the use of experts. One of the principal problems in the use of experts or even knowledgeable individuals is an effective rule-based method to drill down into scale-free social networks to obtain a solution to a problem using human beings.

The three strategies that have been discussed provide adequate problem-solving results if the problem is rather simple in nature and can be exactly defined by key words or described in a sentence. This is easily seen to be true in the structured searches associated with the first strategy and for the search for standardized products according to the second strategy. Even under the third strategy, a simple solution may be found in the search for persons with particular skill sets given the existence of directories and friends to ask.

It has been found that even to solve easy structured problems using on-line searches required a good deal of time. This time is severely increased if the searcher uses improper syntax or his/her searching skills are not that proficient.

Even with the ever-advancing ability of on-line searching systems to identify documents that appear directed to the subject being searched, these systems have distinct limitations. One example of this is that an individual conducting a search may not have a sufficient level of knowledge of the subject matter being searched. Another is that a complex problem actually requires a human to provide the solution. Further, to reach a solution, there may be the need for human-to-human conversations.

The human-to-human search for information can be even more powerful than the use of computer-based searching and a non-rule-based use of alleged experts. There is a need for a rule-based system and method that would be of assistance to effectively and efficiently use scale-free social networks to solve problems of all types.

### SUMMARY OF THE INVENTION

The present invention is a rule-based system and method for querying scale-free social networks for solving problems based on problem criteria. The present invention may be facilitated by a computer-based system. The system and method of the present invention will enable the effective and efficient use of the human-to-human interactions of experts and knowledgeable individuals in a rule-based way to obtain solutions to all types of problems. The entity desiring a solution to a problem will interact with scale-free social networks using the system and method of the present invention. The system and method will be used to define the parameters of the problem and provide these parameters to individuals who agree to participate in attempting to reach a solution to the problem. Facilitated by a computer-based system using a global communications network, such as the Internet, the entity seeking a problem solution will contact individuals who are believed to have the solution to the problem. Other communication networks that are contemplated include, but are not limited to, an intranet, a Lotus Notes™ infrastructure, Microsoft Exchange™ infrastructure, a cellular telephone network, a local area network (“LAN”), a municipal area network (“MAN”), wide area network (“WAN”) or the like.

The first individual from whom the solution is sought will receive the question, for example, over the Internet. That individual can take one of three actions upon receipt of the question. The first is to answer the question, the second is to forward the question to another entity for answering, and the third is to reject the question. Each selection will have a different effect on the process for finding a solution to the problem.

If the individual chooses to answer the question, the answer will be communicated to the entity seeking the answer and the process will end. If the individual forwards the question to another entity to provide the solution, the system will track the individuals presented with the question. The entity seeking the answer will be informed of the series of individuals who were presented the question and participated in finding the solution.

Each entity to which the question is presented will have the same three options. This process will continue to “branch” until the original requestor is provided with the solution or notified that the question could not be answered. However, except as limited by the requestor, the rule-based system and method of the present invention will drill down into the scale-free social network to find a solution to the problem. In this context, the rule-based system and method is unbounded.

If the individual rejects the question, that individual will send a message to the original requester to that effect if that individual is the first intermediary that rejected the question. If a downstream individual rejected the question, the question is sent back to the preceding individual that sent it, and that individual again has the three choices of action. This process will continue to send the question back toward the original requester until the question is either answered or all of the individuals that were presented the question rejected it. If the latter happens, the original requester starts the method of the present invention again with a different expert or knowledgeable individual.

The method of the present invention provides a rule-based environment that is conducive to finding a solution to a problem. The system and method do not rely on a knowledge-based system for carrying out the method, but relies on the human element for performing the necessary actions to obtain a problem solution. The human element provides a convivial atmosphere that assists in reaching the solution in a pleasant manner. It also enhances the probability of obtaining the solution to the problem.

The individuals that participate in the method of the present invention may be termed intermediaries. An intermediary will become the service provider if he/she provides the solution to the problem. Moreover, an intermediary will become a value-generating intermediary if he/she facilitates reaching the solution to the problem.

At each intermediary level of branching, there will be analysis of the problem parameters. At these junctures, the problem parameters will be redefined to increase the likelihood a solution will be found. During this process, the collective wisdom found at each intermediary level of branching adds to finding the solution. The personal interaction between the requester and intermediaries increases the chances that a solution will be found.

The actions that are carried out by the service provider and value-generating intermediaries may be done for profit or free. This will provide the system with great flexibility in design. This also is helpful for system set-up since the intermediaries may include paid experts or intermediaries who will participate only if there is the possibility of remuneration if they provide either the solution or are in the chain of intermediaries that provide the solution.

Further, the system may be configured so that a fee will be charged for using the system to solve a problem.

Each of the process participants (the requester, intermediaries, and service provider) has different motivations for participating in the system. The requestor's motivation may be solely to obtain the solution to its problem. In this context, the requester must evaluate the value of the solution. This value may be emotionally driven or based on empirical data from research on typical costs for such problem solutions. An intermediary may provide the service based on an established relationship with the requester or for a monetary or other reward, or to establish new relationships with experts in a particular field. The service provider may be motivated for a monetary or other reward, e.g., have recognition that he/she is the smartest in a particular field.

The system has the capability to keep statistics on system success. This will include tracking the solution paths for the various problems handled by the system and determine the entities that should share in the reward for finding the solution. This will also provide a means to objectively assess system performance. This performance evaluation will extend to the participants in the system, such as the responsiveness of intermediaries.

The rule-based system and method of the present invention will be described in detail in the remainder of the specification along with the attached drawings.

### BRIEF DESCRIPTION OF THE DRAWINGS

FIG. 1 shows an embodiment of the system of the present invention in which the Internet is used for facilitating communications among process participants.

FIG. 2 shows an example of roles of process participants according to the present invention.

FIG. 3 shows an example of the states for the process according to the present invention.

FIG. 4 shows an example of the basic relationship among process participants, message types, and message flow according to the present invention.

FIG. 5 shows an example of the message types and possible actions relating to the message types according to the present invention.

FIG. 6 shows an example of preliminary considerations and relevant data according to an embodiment of the process of the present invention.

FIG. 7 shows an example of decision criteria for entering an embodiment of the process of the present invention.

FIG. 8 shows an example of the method for defining additional request parameters according to an embodiment of the process of the present invention.

FIG. 9 shows an example of the process to initiate a service request for a solution of a problem according to the present invention.

FIG. 10 shows an example of the method for processing a request according to an embodiment of the process of the present invention.

FIG. 11 shows an example of the method for processing an answer according to an embodiment of the process of the present invention.

FIG. 12 shows an example of the method of payment processing according to an embodiment of the process of the present invention.

FIG. 13 shows examples for aborting a process and rescheduling the due date according to the process of the present invention.

FIG. 14 shows an example of the complex relationship among process participants, message types, and message flow according to the present invention.

FIG. 15 shows an example of the distribution of clearing unit shares according to an embodiment of the present invention.

FIG. 16 shows an example of a screen display associated with a “sent question” message sent by a requester (prospect).

FIG. 17 shows an example of a screen display associated with the activities of the requester (prospect) at the beginning of the process.

FIG. 18 shows an example of a screen display associated with a first intermediary (player) that receives the question.

FIG. 19 shows an example of a screen display associated with actions available to be taken by the first intermediary (player).

FIG. 20 shows an example of a screen display associated with the action taken by the first intermediary (player).

FIG. 21 shows an example of a screen display associated with the action relating to the first intermediary (player).

FIG. 22 shows an example of a screen display associated with a second intermediary (player).

FIG. 23 shows an example of a screen display associated with actions available to be taken by the second intermediary (player) that includes the original question.

FIG. 24 shows an example of a screen display associated with actions available to be taken by the second intermediary (player) that includes the message sent to the second intermediary (player).

FIG. 25 shows an example of a screen display associated with the second intermediary (player) providing an answer.

FIG. 26 shows an example of a screen display associated with the actions of the second intermediary (player).

FIG. 27 shows an example of a screen display associated with the actions of the requester (prospect).

FIG. 28 shows an example of a screen display associated with actions available to be taken by the requester (prospect) after receiving the answer.

FIG. 29 shows an example of a screen display associated with the answer-acceptance sent by the requester (prospect) to the second intermediary (player).

FIG. 30 shows an example of a screen display associated with a payment request.

FIG. 31 shows an example of a screen display associated with payment-affirmation.

FIG. 32 shows an example of a screen display associated with a value-generating intermediary.

FIG. 33 shows an example of a screen display associated with the system provider.

FIG. 34 shows an example of a screen display associated with a request-rejection.

FIG. 35 shows an example of a screen display associated with a second intermediary (player) that has sent a request back.

FIG. 36 shows an example of a screen display associated with the first intermediary (player).

FIG. 37 shows an example of a screen display associated with the first intermediary (player) after the request was sent back to it.

FIG. 38 shows an example of a screen display associated with the first intermediary (player) forwarding the request to another intermediary (player).

FIG. 39 shows an example of a screen display associated with the first intermediary (player) after it forwarded the request to another intermediary (player).

FIG. 40 shows an example of a screen display associated with a third intermediary (player).

FIG. 41 shows an example of a screen display associated with the actions available to be taken by the third intermediary (player).

FIG. 42 shows an example of a screen display associated with the third intermediary (player) regarding answering the question.

FIG. 43 shows an example of a screen display associated with the service provider.

FIG. 44 shows an example of a screen display associated with the answer-acceptance sent by requester (prospect) after receiving the answer.

FIG. 45 shows an example of a screen display associated with a payment-affirmation.

### DETAILED DESCRIPTION OF THE INVENTION

The present invention is a rule-based system and method for querying scale-free social networks for solving problems. The system and method of the present invention may be facilitated with a computer-based system. As such, the communications among system participants is preferably via a global communication system, such as the Internet or World Wide Web (“WWW”). The entity desiring the solution to a problem will define the parameters of the problem and provide these parameters to an individual that is referred to as an “intermediary.” The actions of the intermediaries involve human-to-human interactions in a rule-based way that provides a method for using scale-free social networks to obtain solutions to the problem.

The intermediary that receives the question via the Internet may take one of three actions to respond to the question: answer the question, forward the question to another entity for answering, or reject the question. The intermediary may also do nothing, which will be treated as if the question was sent back.

If the intermediary answers the question, the answer will be provided to the original requester and the process will end after the requester accepts the answer. If the intermediary forwards the question to another entity to provide the solution, the system will track the question through the process. The entity to which the question was sent will have the same three choices. This process will continue to “branch” until the original requester is provided with the solution for acceptance or the question is returned unanswered. If it is returned unanswered, the original requester can send the question to another intermediary to restart the method of the present invention. As such, the system and method of the present invention is unbounded until the original requester terminates it, or the solution is found and accepted.

If the first intermediary rejects the question, the question will be sent back to the original requester and that process will end. At this point, the original requester can either quit or he/she can restart the method with another intermediary. If a subsequent intermediary rejects the question, it will be sent back to the intermediary that sent the question to that intermediary. When the question is returned to an intermediary in this way, that intermediary again has the same three choices of action. This process will continue until a solution is found or all intermediaries presented the question rejected it.

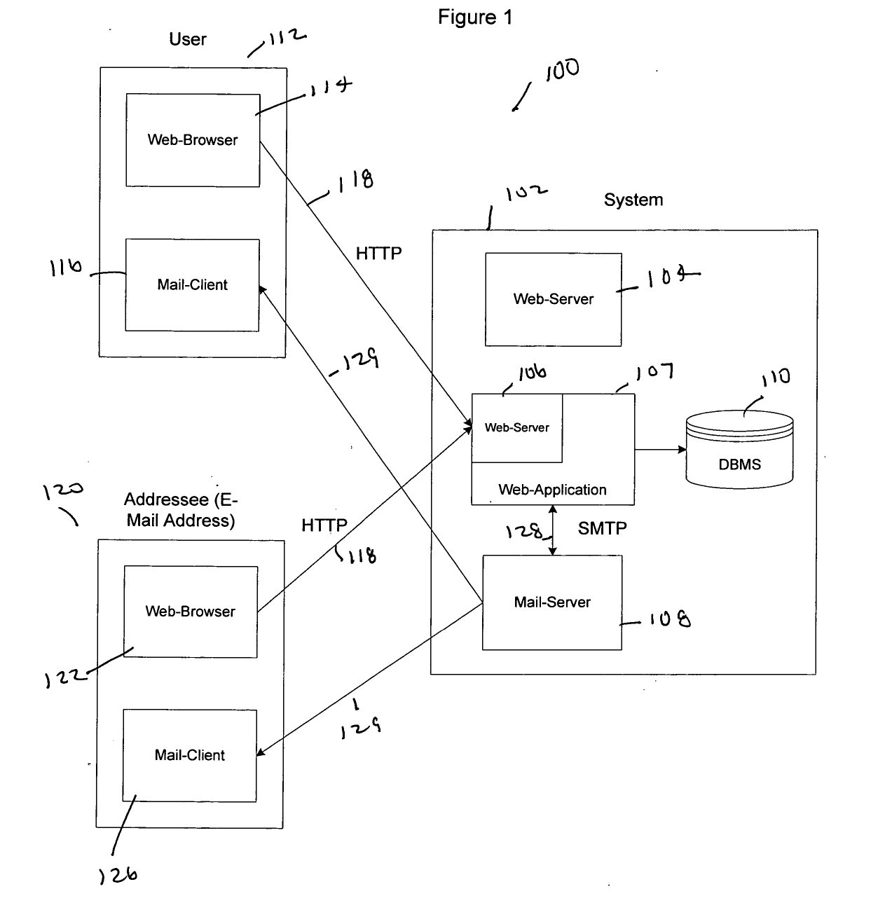

Referring to FIG. 1, generally at 100, an embodiment of the system of the present invention is shown that is facilitated through a computer-based system. As is shown, the computer-based system may use the Internet as the communications medium among system participants. The participants, according to the present inventions, are human individuals and the human-to-human interaction process system data in an effective and efficient manner. However, it is understood that other communication networks may be used and still be within the scope of the present invention. For example, the communication network may include, but not be limited to, an intranet, a Lotus Notes™ infrastructure, a Microsoft Exchange™ infrastructure, a cellular telephone network, a LAN, a MAN, a WAN, or the like.

The human requester will interact with user unit 112. The requester will use user unit 112 to formulate the initial query for a solution to a problem. This terminal also will be used by the requester to interact with the other process participants, the intermediaries and the service provider. The requester, intermediaries, and service provider includes humans, legal entities, and software agents. In the context of the present invention, a legal entity will include, but not be limited to, individuals, proprietorships, partnerships, corporations, associations or other organizations that have the capacity to make a contract or an agreement, and the ability to assume an obligation. A software agent in the context of the present invention includes, but is not limited to, software that will accomplish tasks on behalf of humans or legal entities such that the human or legal entity need only specify a goal, such as solving a problem, providing an answer, or transferring a problem to another entity, and the software agent will make the decisions for accomplishing the goal according to the method of the present invention.

The system of the present invention is facilitated by central system 102, user unit 112, and addressee unit 120. Preferably, there is a user unit 112 for each system requester, and an addressee unit for each intermediary. User unit 112 connects to the web server 106 and mail server 108, and addressee unit in a similar way connects to web and mail servers of central system 102. For the purposes of the present invention, the present invention may be configured to include more than one web server and more than one mail server, and still be within the scope of the present invention. Moreover, the web servers and mail servers may be implemented as personal, workstation, or mainframe computers and still be within the scope of the present invention. Although the system of the present invention has been described as using the central system 102, user unit 112, and addressee unit 120, it is to be understood that the system and method may be implemented without these elements for effecting human-to-human interactions in a scale-free social network.

The system and method of the present invention also may be facilitated with desktop computers, laptop computers, mobile devices such as mobile telephones, smart telephones, personal digital assistants (“PDAs”), or any combinations of these devices. However, if the Internet is used, these devices described may have a wireless or wired connection to the Internet and an e-mail account for sending and receiving system communications.

The system and method of the present invention may be implemented through the use of a web application that is running on one or more web servers. An example of a web application running on web server 106 is shown at 107. Web application 107 connects to database 110. Database 110 will store copies of the service requests that have been made and the results of the service requests. The database may also be used to store the paths that were used for reaching solutions to problems, information about the intermediaries that participated in the method of the present invention, information relating to the requesters, and authentication information for requesters and intermediaries.

Preferably, the requester will use web browser 114 of user unit 112 to communicate information to process participants. In such a situation, the information will be processed through web application 107. The requester will use this method to communicate the required information to web server 106 using, for example, the Internet 118 using hypertext transfer protocol (“HTTP”). Web server 106 will assist in generating the appropriate display screens for the requester for carrying out interactions in the system. The requester will receive communications processed through web application 107. As shown, web application 107 also includes web server 106. The communications are effected by an e-mail being sent through web application to mail server 108 via line 128 using the simple mail transport protocol (“SMTP”). Mail server 108 sends the e-mail via line 129 to client 116 of the user unit 112.

Web application 107 running on web server 106 also is in communications with the various participating intermediaries through addressee units, such as addressee unit 120. Web browser 122 of addressee unit 120 connects to web server 106 via the Internet 118. As such, web browser 122 connects to web application 107 through web server 106. This permits the addressee units to access the system for conducting interactions. The link between addressee unit web browser 122 and central system web server 106 also may communicate authentication information and addressee-based information to the web application for storage and use.

Web application 107 permits communications with addressee unit 120 through the use of mail server 108. Mail Server 108 sends an e-mail via line 129 to mail client 126 of the addressee unit 120.

FIG. 1 has been described as including user unit 112 and addressee unit 120 that each has a separate web browser and mail client. However, it is understood that other configurations of the user unit and addressee unit sites are possible and still be within the scope of the present invention. For example, web browser 114 may be configured to accomplish the tasks of both web browser 114 and mail client 116. Similarly, web browser 122 may be configured to accomplish the tasks of both the web browser and mail client.

Web application 107 will provide a user or addressee access to the system through links that were provided according to display screens for carrying out the method of the present invention. For example, when an intermediary (addressee) or requester (user) is presented with e-mail with links for performing system actions, these display screens may be used to: (1) create and send a new question or (2) show and process a received request. “Create and send a new question” is an action performed by a requester that has a problem that needs a solution. “Show and process a received request” is an action that is undertaken by an intermediary to respond to a question forwarded by the requester or from another intermediary.

Furthermore, the requester, via web browser 114 of user unit 112, may also view its personal data and the statistics of its past actions that are stored on database 110. The requester also via web browser 114, may edit information related to it that is stored in database 110.

When a requester “creates and sends a new question,” the requester will present certain information to the system. The result will be: (1) a new record set for the new process and (2) a record set for a new “question message.” If the intermediary to whom the question is directed has not used the system before, web application 107 will create a new record set for this intermediary in the database if the intermediary responds to the request and logs on to the system.

Once the record sets have been created in the database for the requester and the intermediary, web application 107 will send at least an electronic mail (“e-mail”) message, for example, to the intermediary identified as the addressee and the message will contain the specifics of the question for which a solution is sought. This message will be directed to the appropriate addressee unit 120. Typically, the intermediary is selected by the requester because the requester has a belief that such a proposed intermediary may have the particular expertise to render a solution.

It is contemplated that the e-mail that is sent will contain only the link for accessing the system. When the link is accessed, the potential intermediary will be apprised of the specific question for which a solution is sought.

If the requester at the start does not know of a particular person who could possibly provide a solution, then the requester may have to do additional research to identify particular entities, including experts that may have the ability to find a solution to the particular problem at hand. This may be accomplished by the requester in a number of different ways. A first would be for it to do the research itself or a second would send the question to a first intermediary with general knowledge of the area of interest who would then pass the question on through a series of intermediaries until the appropriate intermediary would receive it and provide the solution to the requester.

It is to be understood that the system and method of the present invention have been described as being facilitated by user unit 112, addressee unit 120 and central system 102. However, the rule-based system of the present invention may be implemented by using communications methods that do not use these elements and still be within the scope of the present invention as long as the method will permit the rule-based communication between the requester and intermediaries to continue the inquiry process to reach a solution to the problem.

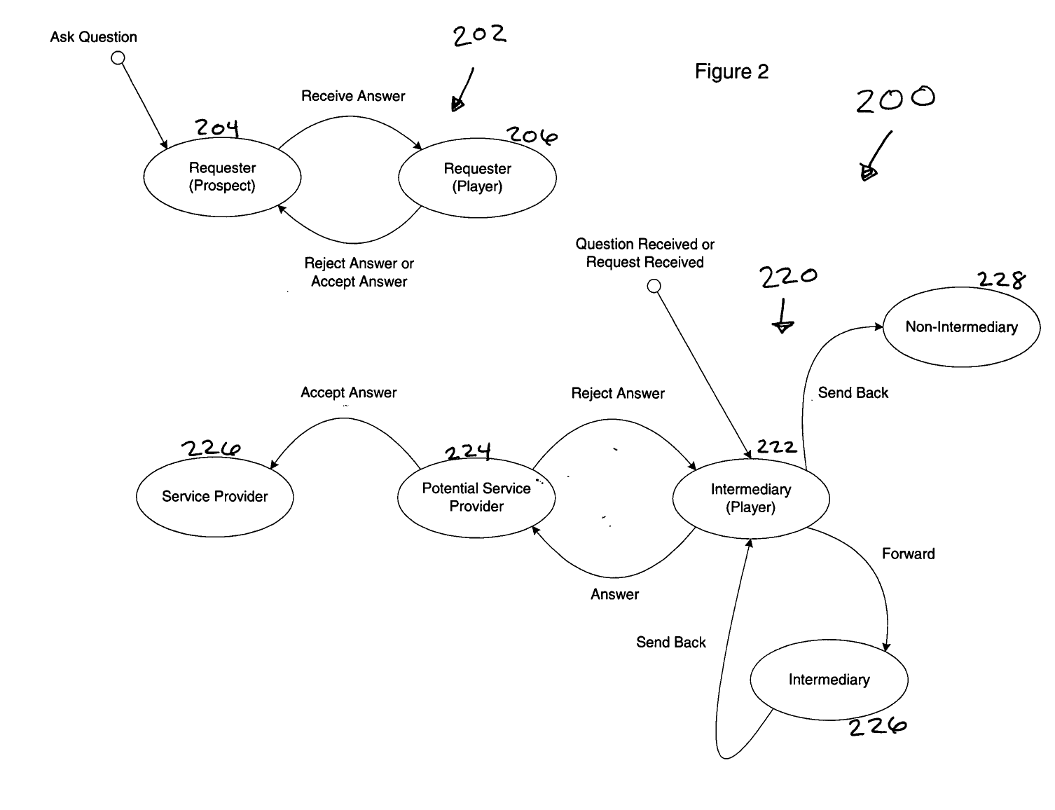

FIG. 2, generally at 200, shows the roles of the requesters and intermediaries in the rule-based system and method of the present invention. According to the present invention, requesters and intermediaries may have different roles in these capacities:

Prospect: a requester with a problem. For clarity in discussing the present invention, the entity will be referred to as the “Requester (Prospect).”

Service Provider: an intermediary that solves a problem.

Non-Intermediary: an intermediary that rejects a request and sends it back to the prior intermediary, if there is one, otherwise, it is sent back to the requester.

Player: a requester or an intermediary that receives a message and is expected to react to the message. This can be intermediary (player) and a requestor (prospect).

As would be understood by the definitions above, the requesters and intermediaries may have multiple roles in the process for identifying a solution to a problem.

Again referring to FIG. 2 and specifically to what is shown at 202, the role/actions associated with a requester will be described. At 204, the requester (prospect) with a problem (question) to be solved (answered) will ask a question. At 206, the requester (prospect) becomes a requester (player) when it receives a solution (answer) and has to take some action: either accept or reject the solution.

Now referring to 220 of FIG. 2, an intermediary that is presented with a problem (receives a question or request) becomes a player. The intermediary (player) at 222 is different from the requester (player) at 206. The intermediary (player) at 222 may forward the question to another intermediary. If that intermediary sends the question back, the intermediary at 222 is again an intermediary (player).

If the intermediary (player) at 222 rejects the question or request, and sends it back to the previous intermediary or the requester, it will become a non-intermediary as shown at 228. If, on the other hand, the intermediary (player) at 222 chooses to provide the solution (answer), it will become a potential service provider as shown at 224. If the solution (answer) is accepted, then the potential service provider at 224 will become the service provider as shown at 226. If the solution (answer) is rejected, the intermediary (player) that had become the potential service provider at 224 will again assume the role of an intermediary (player) as shown at 222 and may take one of the three choices it had before: answer the question (with a different answer), forward the question to a different intermediary than the one that previously rejected it, or reject the question.

Preferably, each system user has certain information that is stored about it in system database 110 (FIG. 1). This information makes it possible for each system user to log on to the system of the present invention, address messages, track accounting information, and administrate the statistics of the system of the present invention. Preferably, the following is the minimum information that the system stores for each requester or intermediary.

ID: unique identifier that identifies the requester or intermediary.

E-Mail: an e-mail address that will provide the requester or intermediary access to the system of the present invention and provide the system a means to send communications to the requester or intermediary.

Password: unique password for each requester or intermediary that, with the e-mail address, is needed to log on to the system of the present invention.

The system and method of the present invention also contemplate the following optional information, or any part thereof, may be stored in database 110 with regard to each requester or intermediary:

Account Balance: The amount of system clearing units owned by the requester or intermediary.

Forename: The forename of the requester or intermediary.

Surname: The surname of the requester or intermediary.

Country: The country of residence of the requester or intermediary.

City: The city of residence of the requester or intermediary.

Zip Code: The zip code of the city of residence of the requester or intermediary.

Asked Questions: The number of questions (problems) asked by the entity or intermediary requester.

Revoked Questions: The number of questions (problems) revoked by the entity as a requester before exceeding a predetermined due date.

Accepted Answers: The number of answers accepted by the entity as a requester.

Amount of Forwarded Requests: number of requests forwarded by the entity as an intermediary.

Amount of Accepted Answers: The number of answers prepared by the entity as an intermediary and accepted by a requester.

Total Amount of Paid Awards: The sum of all rewards paid by the requester up to a predetermined point in time in the currency of the requester.

Total Amount of Received Rewards: The sum of all rewards received by the entity as an intermediary in the currency of the requester.

Again, it is understood that the present invention may include all or any number of the optional information categories indicated above and still be within the scope of the present invention. There also may be information other than the optional information indicated above stored in the database for requesters and intermediaries, and it will still be within the scope of the present invention.

The rule-based method of the present invention is preferably carried out with a process that has six process states. These states are (1) sent, (2) answered, (3) accepted, (4) paid, (5) not paid, and (6) aborted. These process states will define the communications that are exchanged among the requester and intermediaries. The communications, typically in the form of e-mail messages, are exchanged according to the process states and will define a message chain that is later evaluated to determine the entities will be entitled to a share of the reward paid by the requester for the solution. The message chain will include all of the messages that were exchanged among the requester and intermediaries in their various roles as set forth in FIG. 2. Each message that is created will have a corresponding record that is stored in database 110. Once the record is created and stored, it will be available for the requester and any intermediaries to review when logged onto the system.

A message created and sent by a requester or intermediary will always have a consequence within the system of the present invention. At a minimum, every process will have at least one message to an intermediary. Under such circumstances, the solution would be provided by the first intermediary that received the question. However, it is anticipated that the system will support any number of messages of being sent between process participants to reach the desired goal of finding a solution to a problem.

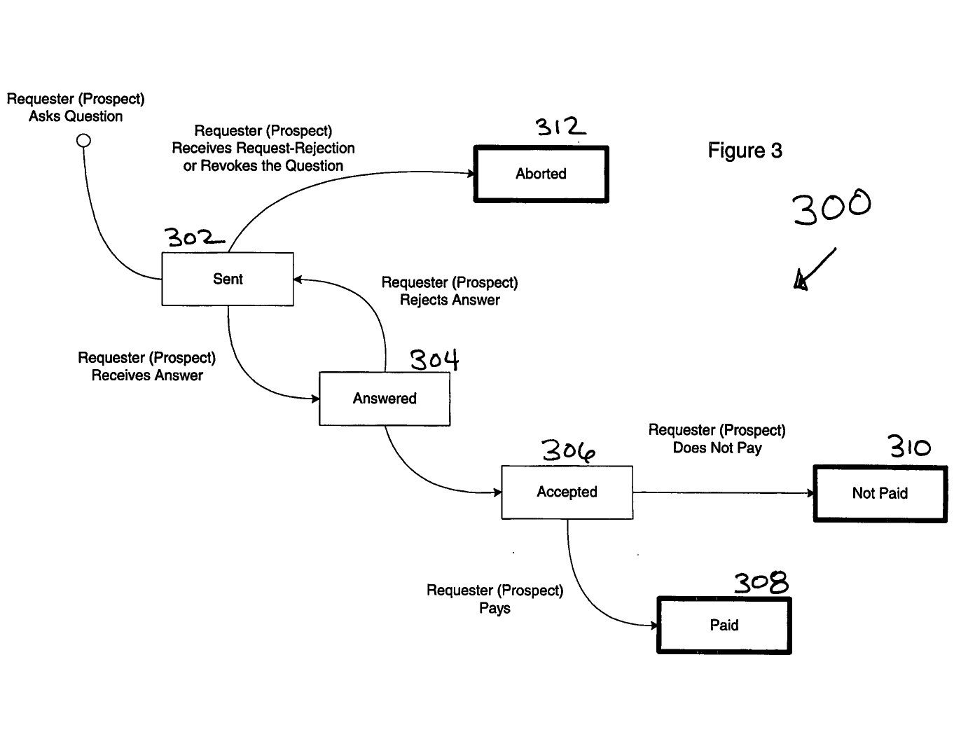

FIG. 3, generally at 300, shows the process states according to the present invention. A process is first created when a requester (prospect) sends a problem (question) to central system 102 for forwarding to an intermediary at the e-mail address provided to the central system. At this point, the process enters the “sent” state at 302. At this state, the intermediary that receives the question must take some action. The process will remain in the “sent” state until that action is taken. As long as the question is being forwarded to additional intermediaries, the process state will remain in the “sent” state.

If an intermediary provides the solution to the requester (prospect), the process moves to the “answered” state at 304. The process will remain in the “answered” state until some action is taken by the requester (prospect) to either accept or reject the answer. If the answer is rejected by the requester (prospect), then the process will return to the “sent” state at 302. If, on the other hand, the requester (prospect) accepts the answer that was provided by an intermediary, then the process will enter the “accepted” state at 306. In certain circumstances, once the process has entered the “accepted” state, the process will end.

The system and method of the present invention may be configured as a for-payment or not-for-payment system. The for-payment system, which involves a reward, will require the requester (prospect) to pay the service provider and intermediary (ies) for providing the solution to the problem. The not-for-payment system will mean that the service provider and intermediary (ies) are not to be paid for providing the solution. In a not-for-payment system, once the process reaches the “accepted” state at 306, the process will end.

Under circumstances in which the service provider and intermediary (ies) providing the solution are to be paid for their work in obtaining the solution, the process will enter the “paid” state at 308, when the requester (prospect) makes the appropriate payment to them. If the requester (prospect) does not pay when obligated to do so, the process will enter the “not paid” state at 310. In entering the “not paid” state (when there is an obligation to pay), the service provider and intermediary (ies) that were to receive payment for the work performed may be able to take some type of action against the requester (prospect), legal or otherwise, to exact payment for the accepted solution to the problem.

If the requester (prospect) receives a request-rejection to indicate that all of the intermediaries that were presented the question have chosen not answer it, the system will enter the “aborted” state at 312. The process also will enter the “aborted” state if the requester (prospect) does not accept an answer (and does not send the question to another intermediary) or revokes the question at sometime during the process. Upon entering the “aborted,” “paid,” or “not paid” state, the rule-based method of the present invention will end.

A process that is run according to the system and method of the present invention has the following attributes and definitions:

ID: unique identifier for identifying the particular process. IDs are used by the system database for process identification but are not displayed on the screen display. However, it is contemplated that an ID maybe displayed if desired.

prospectID: identifies the system user with the role of the requester (prospect).

begin: timestamp of the creation of the particular process.

reward: the number of clearing units that will be distributed among participating entities according to a “rewarding algorithm.”

reward algorithm: a series of expressions that determine the reward entitlements for the service provider and any value-generating intermediaries.

Currency: a type of clearing unit, e.g., it could be a common currency, such as the “Euro” or U.S. dollar, or system clearing unit or any other kind of clearing unit.

Intermediation Factor: a floating-point number that is a parameter of the “rewarding algorithm.”

Range: the limits to the number of intermediaries allowed between the Service Provider and the requester (prospect).

Response Time: the limits to the time each player has to react to a received message by creating the response message. The system will take over the process if the response is not provided in this time and provide a message in order to keep alive the process.

Due Date: the date when the requester (prospect) requires the solution to the problem. If the due date passes without a solution, the requester (prospect) has to set a new due date or the process will terminate without a solution. There will be a warning by the system a predetermined period before the due date arrives.

State: the state of the process at a particular time. The state is dependent on the last user activity. The states are “sent,” “answered,” “accepted,” “paid,” “not paid,” and “aborted.”

Process Participants: this includes the entities that participate in a particular process of the system of the present invention. The process participants for a particular process form a subset of the total system participants.

The definition and attributes of a process are entered into the system of the present invention in two ways. The requester (prospect) will enter the “reward,” “currency,” “intermediation factor,” “range,” “response time,” and “due date.” The system will assign the parameters “ID,” “prospectID,” and “begin” to the process, and the process elements that are being run by the system and method of the present invention.

The rule-based system and message of the present invention use a number of different message types for communications between the requester, intermediaries, and the central system. There are eleven message types. Each of the eleven message types has certain common features. These common features will be described first, and then the particular features of the each of the message types will be described along with the definition of the message type.

ID: the unique identifier for the particular message type. IDs are used by the system database to identify particular message types but they are not displayed on the screen display. However, it is contemplated that such IDs may be displayed on the screen display if desired.

Type: defines the actions from which a requester (prospect) or intermediary (player) may choose. senderID: identifies the entity that created the message. The senderID is used by the system database to identify the message sender and is not displayed on the screen display, but it may be displayed on the screen display if desired.

recipientID: identifies the entity that received the message. The recipientID is used by the system database to identify the particular message recipient and is not displayed on the screen display; however, it may be displayed if desired.

precederID: identifies the message that precedes the current message in the process. The precederId is used by the system database to identify the immediate preceding message but is not displayed on the screen display. However, it is contemplated that it may be displayed on the screen display.

followerID: identifies the message that follows the current message in the process. The followerID is used by the system database to identify the immediate following message, but is not displayed on the screen display. The followerID may be displayed if desired.

creation: the timestamp created when the message was created.

text: the message field that contains the text that the sender is sending to the recipient for action.

reward: the amount of clearing units the service provider and value-generating intermediaries will receive if the solution is delivered by that service provider and accepted by the requester (prospect).

The following are the definitions and attributes of the eleven message types:

Question: this is the message that a requester creates to present a problem to an intermediary.

The “question” message type has the attribute of a “subject.” The subject will describe the problem of the requester (prospect) in one sentence. Preferably, the text of the question also will describe the conditions under which the solution will be accepted.

Request: this is a message that an intermediary (player) can create to forward a “question” to another intermediary.

The “request” message has the attributes of the e-mail address of the recipient of the “request” message and “text” that instructs the recipient why the sending intermediary (player) considers the intermediary that is sent the “request” message qualified to provide the solution as a potential service provider.

Request-Rejection: this is a message that indicates that the recipient cannot or does not want to answer or intermediate the question.

The “request-rejection” message may have the attributes of “text” explaining to the recipient why the intermediary (player) cannot provide the service.

Answer: this is a message that an intermediary (player) sends when assuming the role as the potential service provider.

The “answer” message will have the attributes of “text” that provides the information to solve the problem or if the solution to the problem requires additional things or time, the intermediary (player) will provide what it is capable or willing to provide as the potential service provider.

Answer-Rejection: this is a message that a requester (prospect) sends back to a potential service provider rejecting the answer (solution) that has been provided.

The “answer-rejection” message will have the attributes of “text” that will specify why the requester (prospect) has rejected the answer (solution).

Answer-Acceptance: this is a message that is sent by a requester (prospect) to a potential service provider to accept the service that was provided.

The “answer-acceptance” message has the attributes of “text” that will accept the service that has been provided and may commit the requester (prospect) to paying the “reward” to those providing the service (service provider and value generating intermediaries).

Payment-Request: this is a message that is generated by the system after a requester (prospect) sends an “answer-acceptance” to potential service provider and the system cannot immediately transfer the reward.

The “payment-request” message is sent from the system to the requester (prospect) and the attributes of the message are that the “text” tells the requester (prospect) how to proceed to effect payment of the reward.

Payment-Affirmation: this is a message that is generated by the system if it detects that a reward has been paid according to a “reward algorithm.”

The “payment-affirmation” message may be detected in a variety of ways depending on the actual implementation of the payment process.

Payment-Refusal: this is a message that is generated by the system if it has detected a “payment-request” but no corresponding “payment-affirmation” has been detected after predetermined period of time.

The “payment-refusal” message has the attributes of informing all system users who have not received a reward that they should not expect to receive one or the system will not consider payment of the reward anymore.

Question-Revocation: this is a message that is sent by the requester (prospect) after a process is started to indicate the requester (prospect) is no longer interested in the solution to the problem.

The “question-revocation” message is sent to all who are participating in the process. It can be created by the requester (prospect) but also by the system if the due date defined by process is exceeded.

The recipient of a message, no matter what type, always has access to the problem description in the question message.

The minimum number of intermediaries that can participate in the process is one with no maximum except as controlled by a parameter set by the requester. As the process continues to the point where the service provider provides the solution, the expertise that is applied to the problem at the various intermediary levels increases. As such, the reward that is paid by the requester (prospect) is distributed among the participating intermediaries and the service provider, or service provider and some subset of the intermediaries. The reward may depend on the service that is provided, the type of problem, and the different ways of providing the service. These and other factors are taken into consideration in determining how and to whom the reward will be distributed.

Each intermediary in the process and the service provider may generate an “entitlement” against the reward offered by the requester (prospect). An entitlement is generated by intermediaries that forward requests that are not later rejected or answer a question that is not rejected by the requester.

Preferably, the system uses “clearing units” to satisfy entitlements of the intermediaries and the service provider. The clearing units may be common currencies or virtual currencies and still be within the scope of the present invention. In this context, virtual currency may have symbolic value only in the context of the system of the invention, e.g., in the form of credits that the entitlement recipient may use for varied purposes.

The “reward algorithm” is a series of expressions that are used for the distribution of entitlements. The reward algorithm may be structured to distribute rewards equitably, according to weighting, or some other method and still be within the scope of the present invention. Preferably, the reward amount will be determined before the process is started so that each of the participants will know what to expect as a reward. As such, when the request is entered into the rule-based system and method of the present invention, each intermediary (player) will be able to see the entitlement for the whole process and entitlement available to value-generating intermediaries. The reward algorithm may also be configured to charge a system fee for performing the system activities.

According to the present invention, a preferred method by which the reward algorithm will distribute the reward among the value-generating intermediaries is based on the upstream position of an intermediary from the service provider. Therefore, the intermediary that sent the request to the service provider would receive a larger share of the reward than the intermediary that sent the request to that intermediary. This method of reward distribution would apply the other upstream value-generating intermediaries. The intermediary that is next to the requester (prospect) will receive the smallest portion of the reward distribution.

An example of a reward algorithm for distribution of the reward may be the according to the expressions (1)-(6):

$$\begin{matrix}B = X * ( 1 - Y ) & ( 1 ) \\ IS = B * {( Y )}^{P} & ( 2 ) \\ R = {( Y )}^{PT} & ( 3 ) \\ IE = IS / 1 - R & ( 4 ) \\ F = \frac{IE}{SF} & ( 5 ) \\ E = IE - F & ( 6 )\end{matrix}$$

Where,

E=entitlement.

B=basic value for reward.

X=the reward amount.

IS=interim share.

P=intermediary's position from the service provider.

Y=intermediation factor that is determined by the requester (prospect).

IE=interim entitlement.

R=calculated constant for the numbers of participants.

PT=total number of participants.

F=calculated fee amount.

SF=system fee percentage.

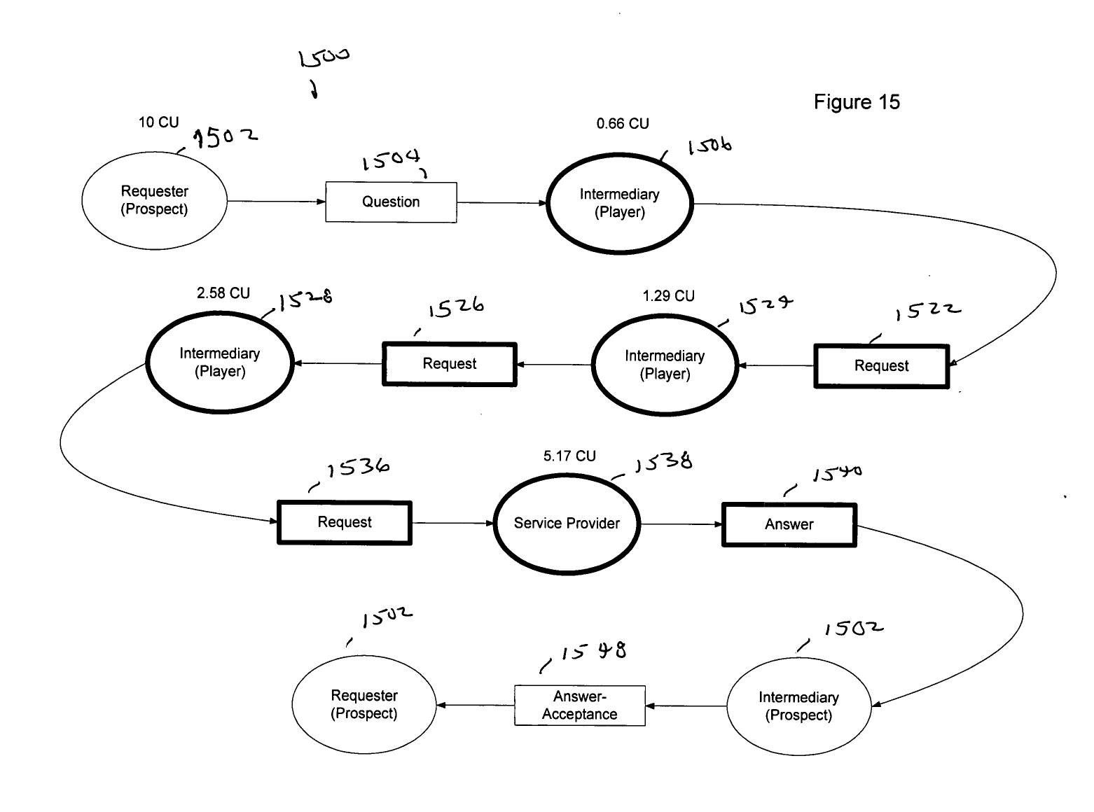

The application of expressions (1)-(6) will be discussed in view of FIG. 15 in which there is a service provider and three value-generating intermediaries.

The system of the present invention also provides for methods for the service provider and value-generating intermediaries to liquidate their entitlements. A first method for the service provider or value-generating intermediaries to receive entitlements would be for the appropriate amount of clearing credits to be automatically transferred to that entity's account balance and deducted from the requester's (prospect's) account balance. These accounts are maintained in the database. The requester (prospect) can buy clearing credits from the system owner that may be used as currency within the system. These clearing credits may also be sold back to the system owner to liquidate entitlements.

Since clearing credits are generally based on a common currency, such as the Euro or U.S. dollars, preferably, the buying and selling of clearing credits will be associated with a financial institution, such as a bank. The system owner may establish an escrow account with a financial institution to handle the clearing credit transactions for the system participants. The buying and selling of clearing credits may be affected by transfers to and from the escrow account. Examples of financial institutions that would support on-line transactions of the type contemplated by the present invention are PayPal, (www.paypal.com), Moneybookers.com (www.moneybookers.com), banks supporting HBCI (Home Banking Computer Interface), or other on-line application programming interfaces.

The requester (prospect) account balance is a critical factor in the liquidation of entitlements. If, at the time, the requester (prospect) transmits an answer-acceptance message to accept the solution sent by the potential service provider, its account balance is sufficient to meet the posted reward, then the reward will be automatically distributed by the system according to the reward algorithm to the service provider and value-generating intermediaries. The service provider and each of the value-generating intermediaries will be notified of the additions to their respective account balances. The system also will generate a payment-affirmation message to that effect.

If, on the other hand, the requester (prospect) does not have sufficient clearing credits in its account at the time the answer-acceptance message is sent, the system will not distribute the reward immediately. The system will generate a payment-request message to the requester (prospect) that instructs the requester (prospect) how to pay in the appropriate amount of clearing units to raise its account balance to at least the amount of the posted reward. The requester (prospect) will have a specified period of time to do this, and if this period is exceeded, the system will generate a payment-rejection message that will be sent to the service provider and the value-generating intermediaries to indicate that payment will not be coming. The service provider and these intermediaries may take appropriate actions against the requester (prospect) according to the system rules or otherwise to compensate for the requester's (prospect's) inappropriate actions in not honoring its agreement to pay a particular reward for a solution to its problem.

Noting the above, a second method for effecting liquidation of entitlements involves the direct transfer of the reward to the service provider and value-generating intermediaries. According to this method, the requester (prospect) will pay in the reward after the system had generated a payment-request message. This payment into the requester's (prospect's) account balance will make reference to the payment-request message that was sent by the system. The system will then distribute the reward according to the reward algorithm to the service provider and the value-generating intermediaries. The system also will notify the service provider and the value-generating intermediaries that each had been paid and it will generate a payment-affirmation message to indicate that payment was effected.

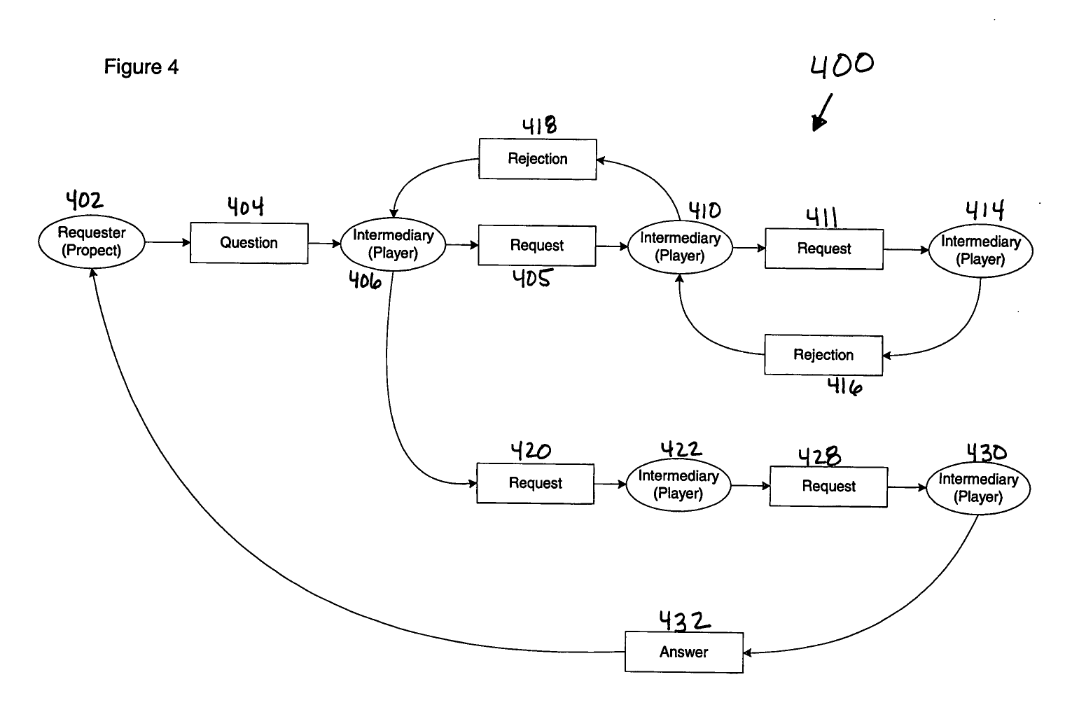

Referring to FIG. 4, generally at 400, an example of user roles and message types generated will be described. It is to be understood that a copy of each message that is transmitted between process participants may be saved in system database 110.

Requester (prospect) 402 will generate question message 404 that sets forth the problem for which a solution is sought. Question message 404 will be communicated to intermediary (player) 406. Intermediary (player) 406 is believed to have expertise in the subject matter of the question. If the intermediary (player) does not reject the question but cannot provide the solution, it can forward the question. In the example in FIG. 4, intermediary (player) 406 forwarded the question in request message 405 to intermediary (player) 410, believed to have expertise in the subject matter of the question.

Intermediary (player) 410 had the same three choices as intermediary (player) 406 but decided to forward question in request message 411 because it could not provide the solution to the problem. Request message 411 is forwarded to intermediary (player) 414 believed by intermediary (player) 410 to have expertise in the subject matter of the question. Intermediary (player) 414 for some reason rejected the question in request message 411, which may be because the question actually was not within its expertise. By rejecting the question intermediary (player) 414 becomes a “non-intermediar” (FIG. 2). Intermediary (player) 414 also sent rejection message 416 to intermediary (player) 410 that was the last intermediary to not reject the question that was sent in request message 411. Intermediary (player) 410, upon the return of the question, rejected it and sent rejection message 418 to send the question back to intermediary (player) 406, the last intermediary not to reject the question before intermediary (player) 410. At this point, Intermediary (player) 410 also becomes a “non-intermediary.”

Intermediary (player) 406 can answer, forward, or reject the returned question. As shown in FIG. 4, intermediary (player) 406 decided to forward the question in request message 420 to intermediary (player) 422 that is believed to have expertise in the subject matter of the question. Intermediary (player) 422, as shown, did not provide the solution to the problem but forwarded the question on to intermediary (player) 430 in request message 428, another intermediary that is believed to have expertise in the subject matter of the question. Intermediary (player) 430 was able to provide the solution to the problem and provided answer message 432 to requester (prospect) 402. If requester (prospect) 402 accepts the answer in answer message 432, intermediary (player) will become the service provider and the process will end, if it is a non-pay solution.

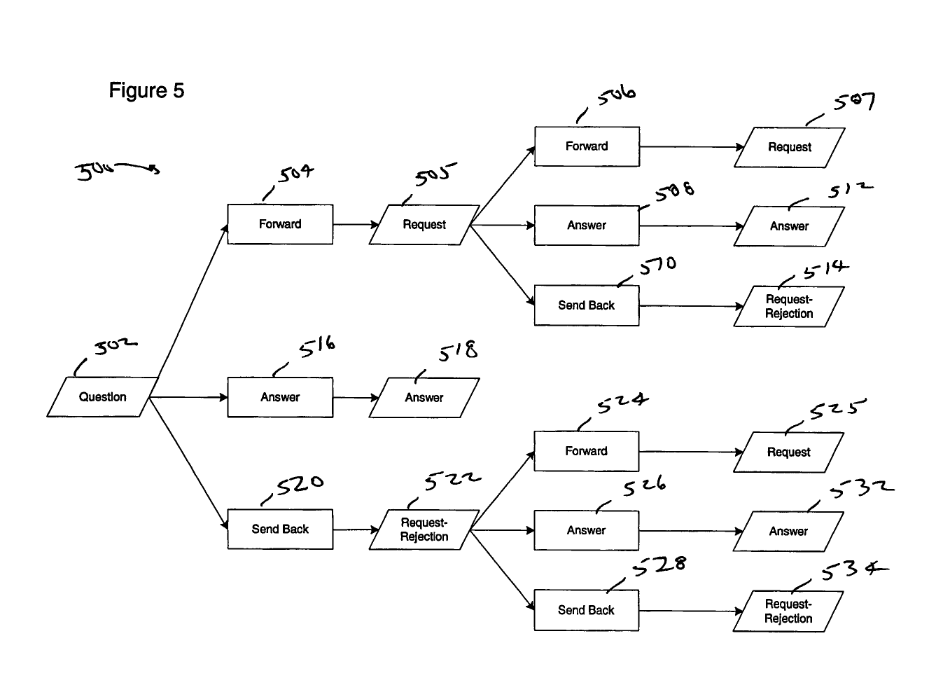

Referring to FIG. 5, generally at 500, the message types and associated actions will be described. When an intermediary (player) is presented with question message 502 either from the requester (prospect) or another intermediary (player), it will have three choices of action. These actions are forward action 504, answer action 516, and send back (rejection) action 520.

If the intermediary (player) takes forward action 504, it will transmit request message 505 that contains the question to another intermediary (player) that is believed to have expertise in the subject matter of the question. The intermediary (player) that receives request message 505 will have the same three choices of action as the intermediary (player) that transmitted request message 505 to it. This new intermediary (player) can take forward action 506, answer action 508, or send back action 510. If request message 505 is forwarded, it may be sent to yet another intermediary (player). The forwarding action can continue to an ever-increasing number of intermediaries (players) until one of the other two actions is taken: the question is answered or it is sent back.

If the intermediary (player) selects answer action 508, answer message 512 will be generated and sent to the requester (prospect) for action: either accept or reject the answer. If send back (rejection) action 510 is selected, request-rejection message 514 will be generated and sent back to the intermediary (player) that sent it.

If the first intermediary (player) selects answer action 516 instead of forward action 504, or send back action 520, answer message 518 that contains the answer will be transmitted to the requester (prospect). If the requester (prospect) accepts the answer, the process will end.

If the intermediary (player) selects send back (rejection) action 520, request-rejection message 522 will be generated and sent back to the last intermediary that accepted question 502 or back to the requester (prospect) if the intermediary (player) is the first intermediary (player). If it is the first intermediary that sent back the question to the requester, the process will end.

If the recipient of request-rejection message 522 is an intermediary, it will have three choices of action: forward action 524, answer action 526, or send back action 528. If the recipient chooses forward action 524, request message 525 will be generated and transmitted to another intermediary (player). The forwarding action can continue until one of the other two actions is taken: the answer action or the send back action. If answer action 526 is taken after request-rejection message 522, answer message 532 containing the answer will be transmitted to the requester (prospect). However, if send back action 528 is selected, request-rejection message 534 is generated and the send back procedure just described will take place.

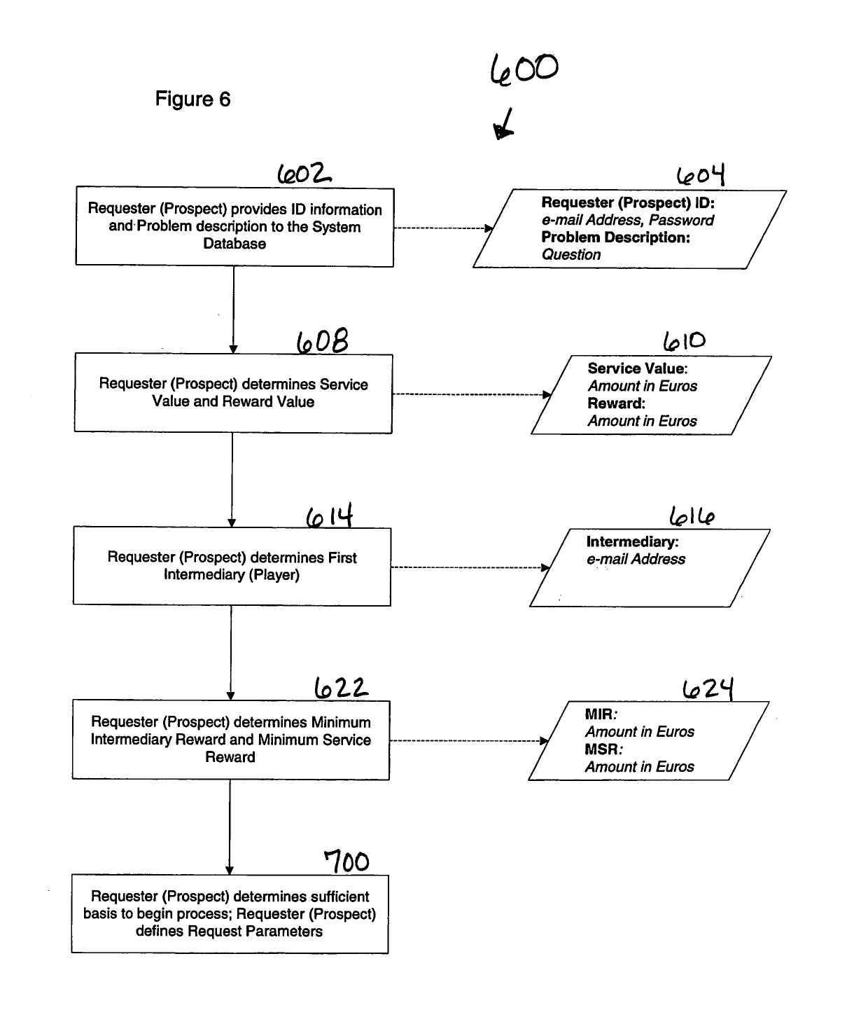

Generally at 600, FIG. 6 shows the preprocess steps that are carried out according to the present invention. At 602, the requester (prospect) that has a problem for which a solution is being sought may provide identification and problem data to the system that will be stored in database 110 or the information may be recorded at this time and stored in the database at another step later in the process. Recording the information at this step includes, for example, recording the information in a spreadsheet or other medium for later storage in the system database. The relevant data that is provided and stored in the database is shown at 604. This data is the requester (prospect) identification that may include an e-mail address and a password. The data also may include the problem description that will become the question in the process. An example of the requester (prospect) identification and problem description that are provided and stored by the requester (prospect) may be the following:
Requester (Prospect) Identification
   E-mail: Karl.mayer@web.de
   Password: goedherk
Problem Description
   I am searching for a 3-room flat in the center of Munich, Germany. My problem will be solved when I sign a tenancy agreement.

It is to be understood that the information that is stored in the database is taken from the information in messages sent between process participants, except for the ID number that will be generated by the system and the password that will be requested from the system.

At 608, the requester (prospect) will determine the service value and the reward value for the service to be provided to solve the problem. The service value is the value of the service to the requester (prospect). The reward value is the amount that the requester (prospect) will pay for the service. Typically, the reward value will be less than the service value. The relevant data that is provided and stored is shown at 610. The service value is provided in the currency in which it is valued. The reward value is also provided in the currency in which it is valued. An example of the service value and reward value that are provided may be the following:
Service Value
   1500 Euro
Reward Value
   1200 Euro (Reward Value is less than Service Value)

The “Service Value” and “Reward Value” may be stored in the system database if desired. The potential requestor may use another method to retain these values for later use in determining whether it is viable to use the system of the present invention, e.g., retain the values on a paper pad.

At 614, the requester (prospect) will determine the entity that will be the first intermediary (player). This entity will be believed by the requester (prospect) to have expertise in the subject matter of the problem and can either provide the solution or be able to forward the question to another entity that could become the service provider. The requester (prospect) will provide the relevant data regarding the first intermediary (player) as shown at 616. This will be the intermediary's (player's) e-mail address. An example of the intermediary data that is stored may be the following:
Intermediary
   Petra Schlauch, schoolmate of Karl Mayer living in Munich, Germany.
   E-mail address: petra.schlauch@yahoo.com

At 622, the requester (prospect) will determine the amount of the reward that will be provided to the intermediaries (player) and the amount of the reward that will be provided to the service provider for delivering the service. The intermediary (player) reward will be in terms of the minimum-intermediary-reward (“MIR”) believed by the requester (prospect) and it will be in the relevant currency. Similarly, the service provider reward will be in terms of the minimum-service-reward (“MSR”) believed by the requester (prospect) that also will be in the relevant currency. The relevant data for the MIR and MSR input and stored may be what is shown at 624:
Minimum-Intermediary-Reward (MIR)
   0 Euro
Minimum-Service Provider-Reward (MSR)
   200 Euro

The “MIR” and “MSR” may be stored in the system database if desired. The potential requester may use another method to retain these values for later use in determining whether it is viable to use the system of the present invention, e.g., retaining the values on a paper pad.

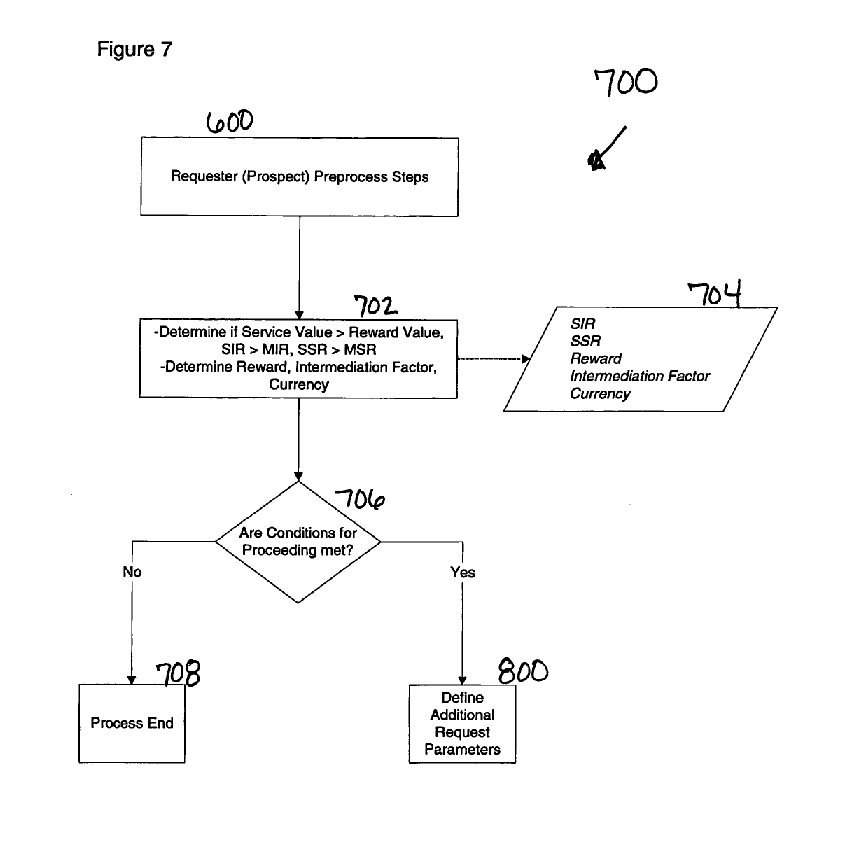

At 700, the requester (prospect) moves to the step that defines the request parameters for the process. The steps of this process will be described in detail referring to FIG. 7.

Referring to FIG. 7, at 702, before the requester (prospect) can begin the process, there are a number of determinations that have to be made, and parameters set for system operation. These parameter values may be stored in the system database. Unless these determinations result in an appropriate relationship of certain parameters, the requester (prospect) typically would not find it beneficial to submit the problem to the system for finding a solution.

The first determination is whether the service value is greater than the reward value, which has been discussed. The second is whether system-intermediary-reward (“SIR”) is greater than the MIR. And the third is whether the system-service-reward (“SSR”) is greater than the MSR. The SSR has the same value as the basic value in expression (1). The SSR and SIR are determined by the following expressions:
SSR=X*(1−Y) (7)
SIR=SSR*(Y) (8)
Where,

X=the reward amount.

Y=the intermediary factor.

If the requester (prospect) does find service value>reward value, SIR>MIR, and SSR>MSR, then the requester (prospect) should define the system parameters because it appears that the rule-based system of the present invention will be beneficial to the requester (prospect).

The first parameter to be set is the reward as shown at 704. This may be set by the requester (prospect) as desired, but preferably it will be set according to the MIR and MSR. The second parameter to be set is the currency for the reward. The final parameter to be set at this step is intermediation factor. This value will between “0” and “1.” The relevant data that the requester (prospect) will determine for proceeding with the system are SIR, SSR, the reward value, the intermediation factor, and the currency. Those values may be stored in the database. An example of the determinations, and data generated and stored according to step 702 may be the following with the constraint that the requester (prospect) wants to spend only up to 500 Euros for the service:

The following currency, service value, MIR, and MSR from previous examples will be used in this example. Therefore,
Currency=Euros
Service Value=1500 Euros
MIR=0 Euros
MSR=200 Euros
Intermediation Factor=0.5
Calculations:
   SSR=X*(1−Y)=500*(1-0.5)=500*0.5=250 Euros
   SIR=SSR*(Y)=250*0.5=125 Euros
Determinations:
   Service Value>Reward
      1500 Euros>500 Euros
   SSR>MSR
      250 Euros>200 Euros
   SIR>MIR
      125 Euros>0 Euros

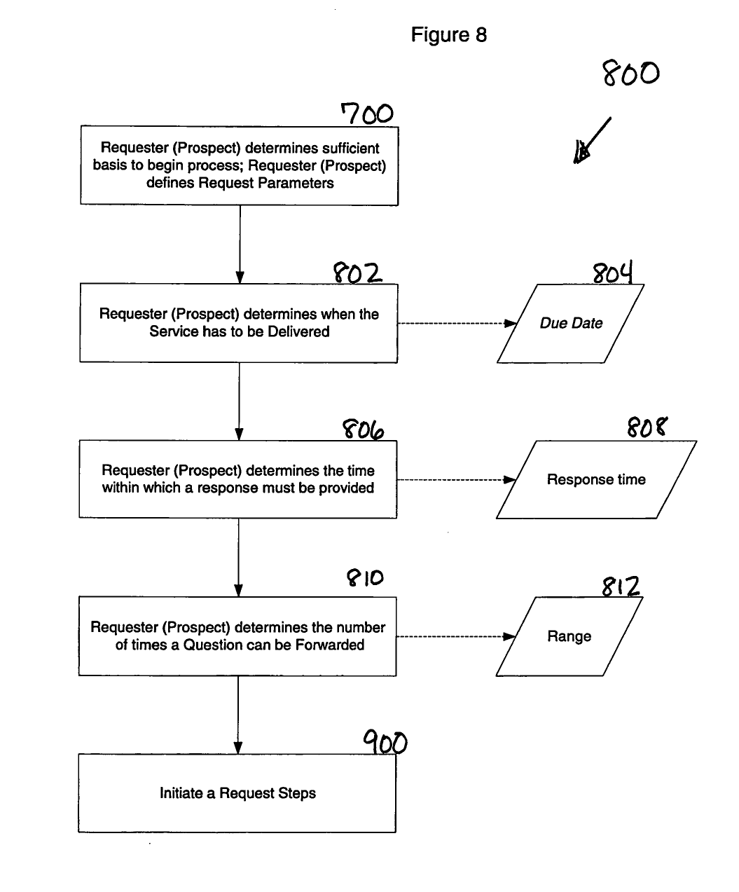

Given the example immediately above, the rule-based system and method of the present invention will move to decision step 706. At step 706, the query is whether the determinations were sufficient to enter the active portion of the process. If the determinations are deemed insufficient, the system will go to step 708 where the process will end and the requester (prospect) will seek another method to find a service provider. If, as in the example, the determinations are sufficient to enter the active portion of the process, the requester (prospect) will proceed to step 800 where it will define additional parameters, as will be discussed in detail referring to FIG. 8.

FIG. 8, generally at 800, shows the method steps that are used for determining additional parameters. These additional parameters will be used in carrying out the process of finding a solution to the problem posed by the requester (prospect). At step 802, the requester (prospect) sets the date when the service is to be delivered. Unless the service is delivered on or before that date, or there is an extension of time granted by the requester (prospect), the process will end without any entitlement to the reward. At 804, the relevant data that is stored in the system database is the “due date.” An example of what is stored will be the following under the conditions in which the requester (prospect) needs the flat by Dec. 20, 2005, the due date would be sometime before that date in case the process is not successful so the requester (prospect) will have time to use alternative methods to try to secure a flat by Dec. 20, 2005:
Due Date: Nov. 20, 2005

The next process step is at 806 where the requester (prospect) sets the response time within which every intermediary and the requester must respond when presented with a message for action. During this response time, typically, an intermediary will have to take one of the three actions discussed previously: the forward, answer, or send back action. During the response time, a requester (prospect) will have to accept or reject an answer or effect payment of the reward. The response time will be tracked and if the intermediary or requester (prospect) does not respond within the response time, each would be notified by the system of this fact. If an intermediary does not respond, it will be interpreted as the intermediary taking the send back action to send the question back to the requester (prospect) or the intermediary (player) that sent it to that intermediary. If the requester (prospect) does not respond to an answer, it will be interpreted as the requester's (prospect's) acceptance of the answer. At 808, the relevant data that is stored in the system database is the response time. An example of the data that is stored locally may be the following:
Response Time: 5 days

The next process step at 810 sets the range for seeking a solution for the problem. The range is the maximum number of intermediary nodes in the process. Typically, the higher the range, the greater the probability a solution to the problem will be found, but the higher the range the longer the process time. The remaining range will be part of any message that an intermediary (player) receives that provides the question. As the question is forwarded to the next intermediary (player), the remaining range will be decremented. Each intermediary (player) that receives a message will see the remaining range. If an intermediary (player) receives the question and it is the last in the range, it must either answer the question to provide the solution or send the question back to the intermediary (player) that sent the question. As the question moves back through the chain of intermediaries (player), each intermediary will have the same choice as it had the first time the request reached it. When a question is sent back, the remaining range will be incremented by one. This will continue until either the question is answered or the requester (prospect) receives the question back. The relevant data at 812 that is stored locally is the range, and an example of it may be the following:
Range: 8

After the additional system parameters are set according to FIG. 8, the requester (prospect) will initiate the request for obtaining a solution to the problem according to

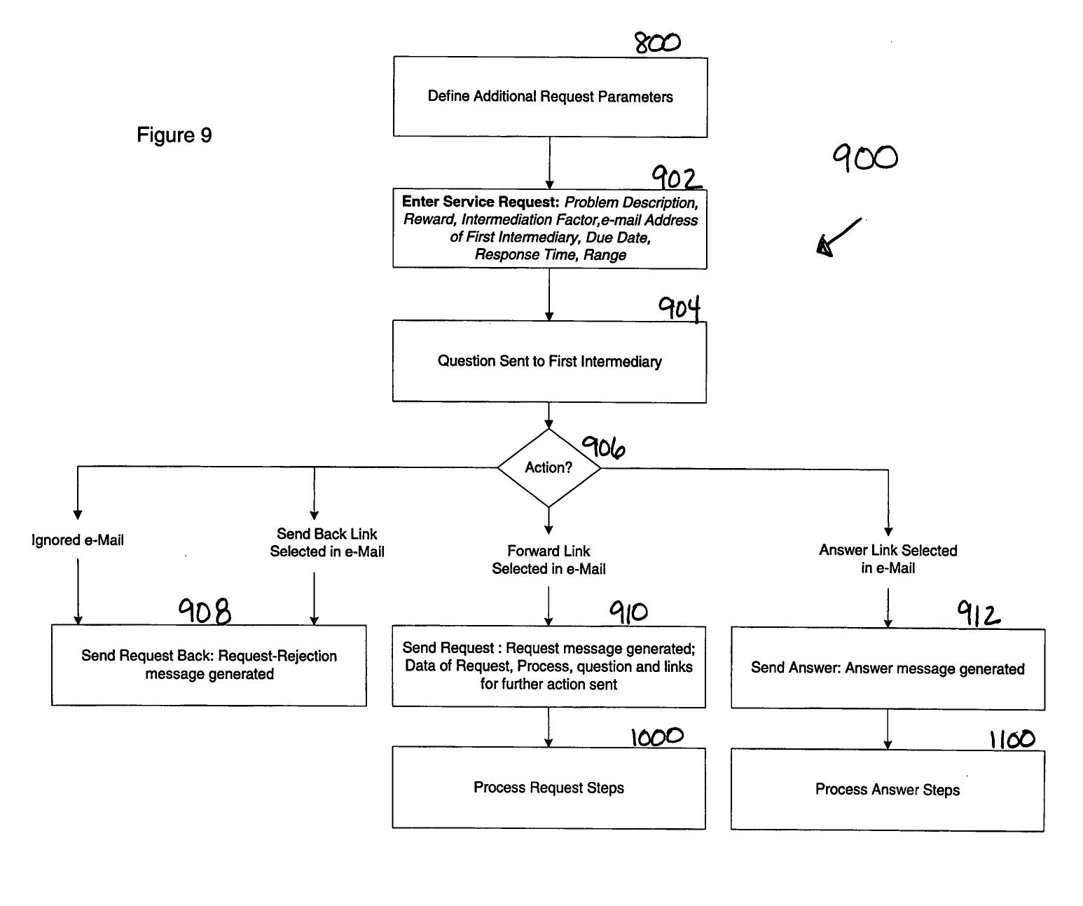

FIG. 9 at 900. Referring to FIG. 9, at 902, the requester (prospect) will enter the service request information into the system database, if it has not been already entered in the preprocessing step, so that a question may be sent to the first intermediary to provide a solution to the problem. However, before the requester (prospect) can enter the data, it must have already established itself as a system user. This includes contacting the system so it will be issued an ID, registering its e-mail address and establishing a password so it will be permitted to log on to the system, establishing an account balance of clearing units that is equal to or greater than the reward that will be posted, providing the necessary personal data for storage in system database 110, such as forename, surname, country, and residence (country, city, zip code). If the requester has used the system before as a requester or intermediary, the system database already may have information stored relating to the asked questions, rejected questions, accepted answers, number of forwarded requests, number of accepted answers, total amount of paid awards, and total amount of received rewards.

After the requester (prospect) has done the preliminary tasks just discussed, it is prepared to submit its request to the system to obtain a solution to the problem. The requester (prospect) will send the following parameters to the system as a service request. Preferably, the service request will contain at least the following data:
Requester ID
Service Description
Reward
Intermediation Factor
Address of the first Intermediary (e-mail address)
Due Date
Response Time
Range

The service request will be sent to the system for distribution according to its content. Once the system receives the service request, the data it contains is stored in the system database. At step 904, the system will take the information stored in the database to formulate the question message to send to the identified intermediary (player).

Preferably, the question message that is sent will be in the form of an e-mail to the first intermediary (player) and it will contain the link for accessing the system. When the link is accessed by the first intermediary (player), that intermediary (player) will be provided with all of the request data and the question. The intermediary (player) will have three links (choices) available to it. These links are the forward, answer, and send back links.

If the intermediary (player) has not used the system in the past as an intermediary or a requester, an account must be established for the intermediary (prospect). The intermediary will be issued an ID and it will establish a password so that it can log on to the system. The system also will automatically establish an account for the intermediary. Other information that may be stored on the system for the intermediary (player) will be the country, city, and zip code of the residence of the intermediary (player).

Since the process just initiated by the requester (prospect) is a new process, the system will issue a process ID that will be stored in the database. The question message will also be given a unique ID. The system also will store the question message information that was sent to the first intermediary (player), which will include the senderID, recipientID, precederID (if there is one other than the requester (prospect)), followerID (if there is one), creation, text, and reward.

Referring to FIG. 9 at 908, if the intermediary (player) ignores the question message and the response time is exceeded the intermediary (player) will be sent a message by the system as to this fact. It will be treated as if the intermediary (player) had selected the send back link. In this case, a request-rejection message will be generated that includes the request-rejection attributes to send the question back to the requester (prospect). When this happens, the process will end given that the question is returned to the requester (prospect).

If the intermediary (player) does see the question message but decides to send it back to the requester (prospect), it would activate the send back link in the e-mail. This will cause the system to generate the request-rejection message with the appropriate attributes that will be sent to the requester (prospect) as shown at 908. As before, the process will end at this point.

If the intermediary (player) activated the answer link, the process will proceed to step 912. The intermediary (player) will prepare an answer message with text that provides the solution to the problem. This message will be sent to the requester (prospect) through the system. The system will save a copy of the message. The system will provide the requester (prospect) with an e-mail message with a link to the solution. The process will then move to step 1100 for processing the answer. Process step 1100 and its substeps will be discussed subsequently.

If the intermediary (player) activated the forward link, the process will proceed to step 910. The intermediate (player) will provide the e-mail address of the next intermediary that may become the service provider. The intermediary (player) that is forwarding the question also may provide a message along with the question. The message that is sent is a request message. The request message is prepared by the intermediary (player) and routed through the system to the new intermediary. As before, if the new intermediary has not been a participant in the system before, it must have an account and other information created for it. The request message will be processed according to step 1000 and its substeps that will be described subsequently.

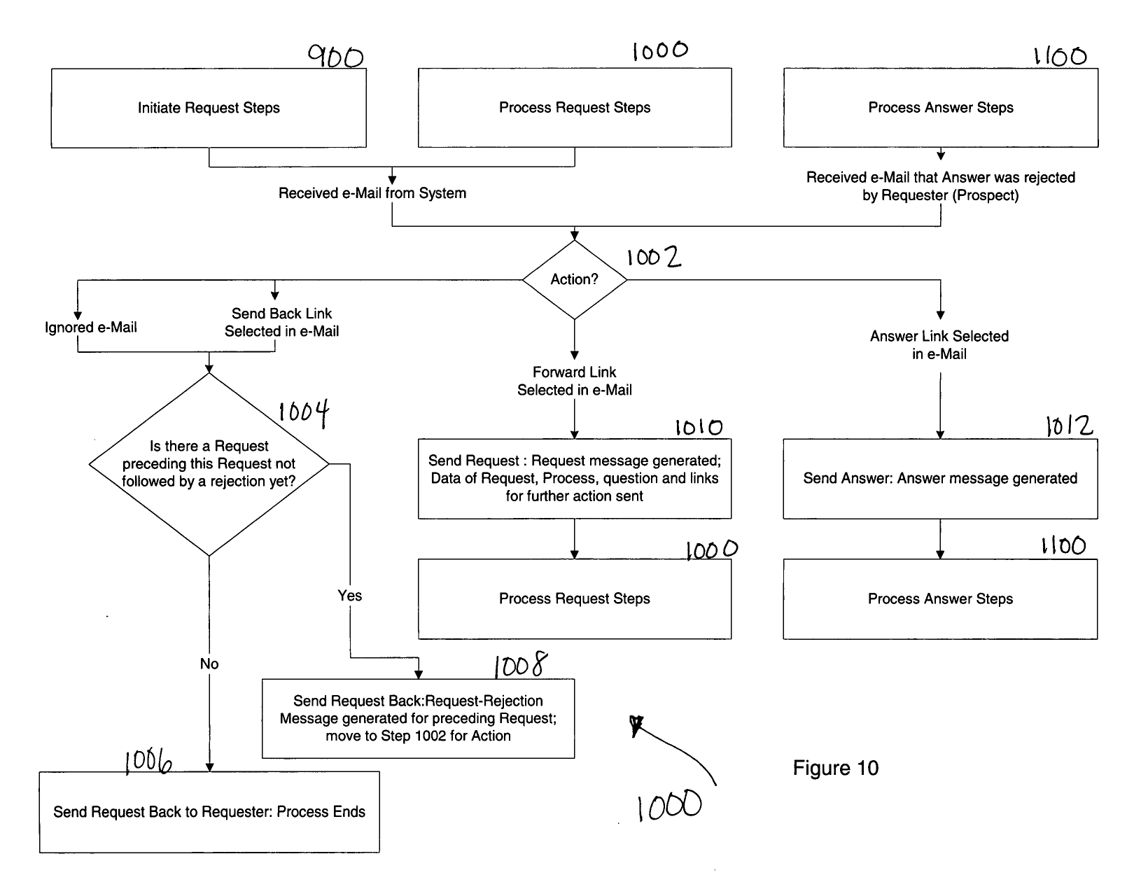

Referring to FIG. 10, generally at 1000, the steps for processing a request message will be described. The request message that is received by the new intermediary (player) is received at 1002. The intermediary (player) will have the same three options as the previous intermediary (player). The new intermediary (player) can send back, forward, or answer the question.

If the new intermediary (player) ignored the e-mail and the response time parameter is exceeded, the system will treat this situation as if the intermediary (player) activated the send back link and the process will proceed to step 1004. Further, if the intermediary was cognizant of the e-mail but decided that it did not feel it could provide the solution to the question and wanted to reject it, the new intermediary (player) would activate the send back link on the interface and the process also will proceed to step 1004.

At step 1004, the system must determine how to process the request message. At this step, the determination is made whether the intermediary (player) is the first intermediary or some subsequent intermediary. If it is the first intermediary (player), the process will move to step 1006. At step 1006, the process will end because the question will have been sent back to the requester. If the intermediary is other than the first intermediary (player), the process will proceed to 1008. At 1008, the system will proceed back to step 1002.

If, at step 1002, the new intermediary (player) selected to activate the forward link, the intermediary will provide the e-mail address of another new intermediary (player) that is believed may become the service provider. The intermediary that is forwarding the question may also provide a message to the potentially new intermediary (player) about the question that it desired to be passed on. The system saves the request message that has been sent to the potentially new intermediary (player). The system will send an e-mail to the potential new intermediary (player) with the information relating to the request, the process, the question, and the three links for further action by the potentially new intermediary (player). As before, if the potential new intermediary (player) has not been part of the system before, an account must be created and other information about this new entity must be saved on the system.

The intermediary (player) at 1002 may select and activate the answer link. The intermediary (player) will send an answer message through the system to the requester (prospect) that includes text to notify the requester (prospect) that there is a solution to the problem. The system saves a copy of the answer message and sends answer message in the form of an e-mail to the requester (prospect) containing the message link to process the answer message. The process will now proceed to step 1100 and its substeps to process the answer.

If after the answer message is sent to requester (prospect) the requester (prospect) rejects it, this rejection is sent to the intermediary (player) as an answer-rejection message. This is sent through the system and the system saves a copy of the message as an answer-rejection message. The system will send an e-mail to the intermediary (player) and the returned question will be processed according to FIG. 10.

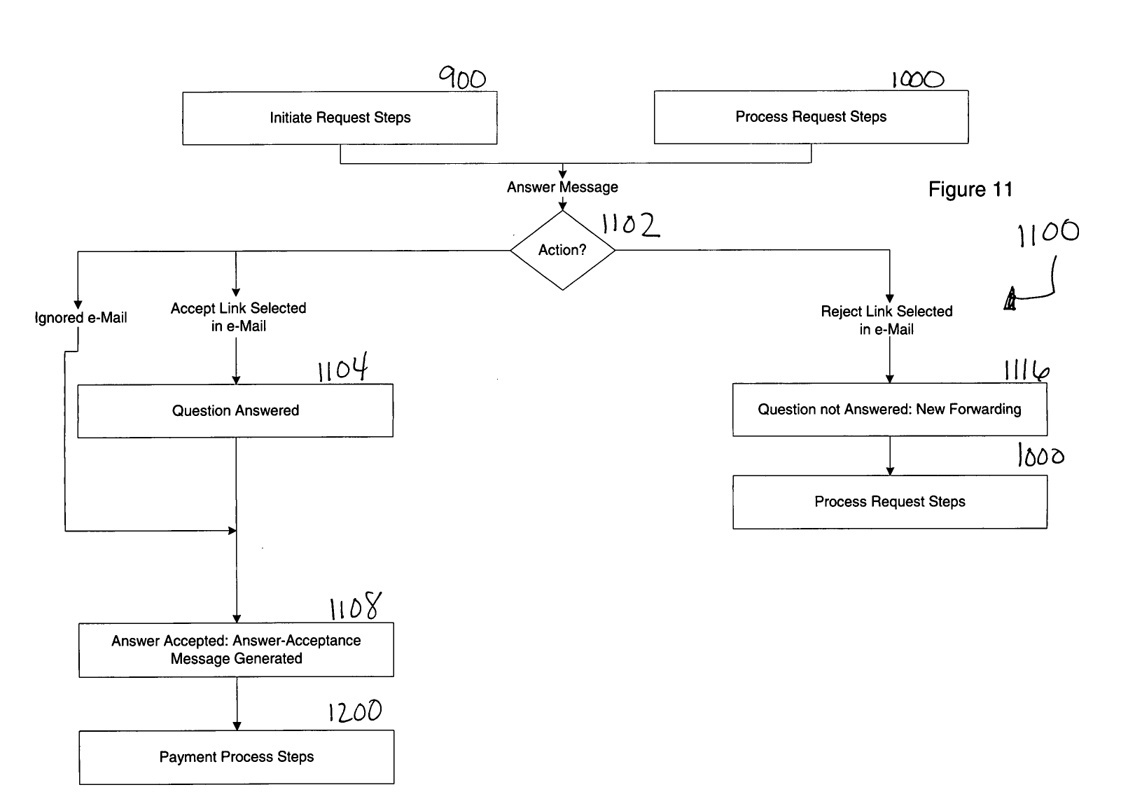

Referring to FIG. 11, generally at 1100, the answer process and its steps will be described in detail. The answer process will be performed by the requester (prospect) upon receipt of an answer message from one of two sources. The first would be from the first intermediary (player) and the second would be from a downstream intermediary (player).

At 1102, if the requester (prospect) ignored the answer message that was sent to it and the response time is exceeded, the process will proceed to step 1108. If, at step 1102, the requester (prospect) upon notification that the answer is provided indicates that the service has been delivered, the process also will proceed to step 1104 and then to step 1108.

At step 1108, the system saves a copy of the answer-acceptance message from the requester (prospect). The system will send a message to all intermediaries and the intermediary that provided the solution that the solution has been accepted. The latter intermediary that was a potential service provider is now the service provider. This message will also contain the information about the shares of the reward that will be given to the service provider and the value-generating intermediaries. The process will now proceed to the payment process step at 1200.

At step 1102, the requester (prospect) could activate the reject link and proceed to step 1116. The requester (prospect) will indicate to the system that the service was not delivered. The requester (prospect) also will provide text why the service was insufficient. This text may be seen by the potential service provider and any participating intermediaries. The system saves the information in an answer-rejection message and the potential service provider will receive the message. The process will return to the process request step 1000 for further action with regard to the question now in the hands of potential service provider.

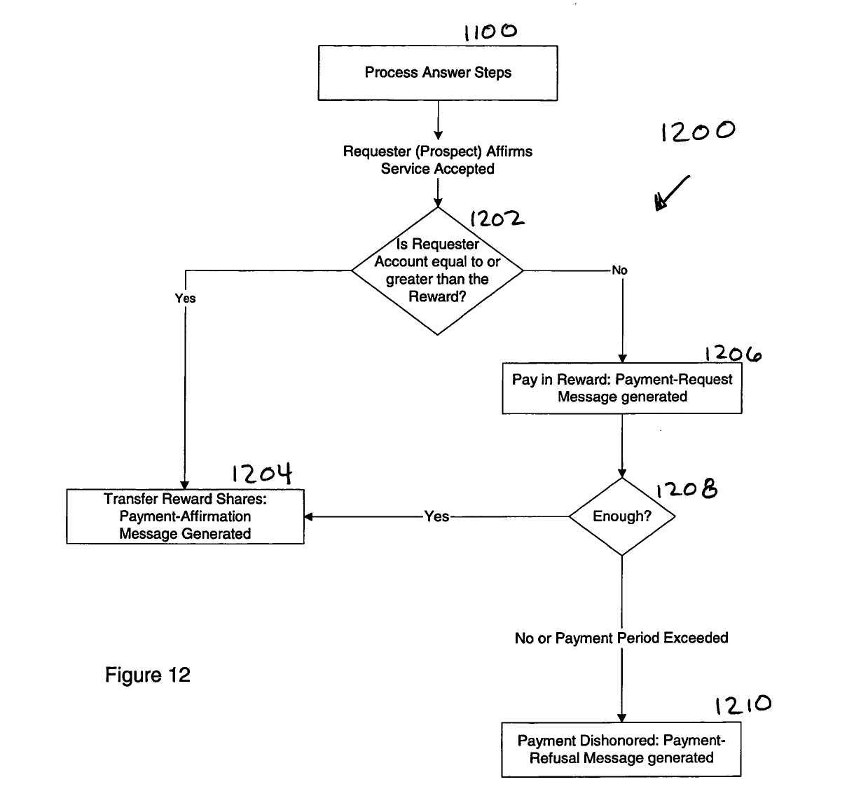

FIG. 12, at 1200, shows the payment process steps according to the present invention. After the service provider receives the e-mail notification that affirms the service was accepted, the process moves to step 1202. At step 1202, there is a determination whether the requester (prospect) has paid enough clearing units into its account that is equal to or exceeds the amount of the reward that has been posted. If it has, the process goes to step 1204. At this step, the system will transfer the shares of the reward to the accounts of the service provider and the value-generating intermediaries (players) according to the reward algorithm. The system service provider and the value-generating intermediaries (players) will be notified of this by the system by e-mail. The system will save a payment-affirmation message type and the process will be terminated.

If, at step 1202, the requester (prospect) does not have the requisite amount of clearing units in its account, the process will proceed to step 1206. At step 1206, the requester (prospect) will receive an e-mail from the system instructing it how to pay the posted reward into its account balance. The system will create a payment request message that is sent to the service provider and value-generating intermediaries.

If the requester (prospect) pays the clearing units into its account balance within the prescribed period of time, then, at step 1208, the process will proceed to step 1204. If the requester (prospect) does not add sufficient clearing units to its account balance by the end of the payment period, the system will proceed to step 1210 and it will consider that the payment is not being honored and it will save a payment-refusal message. The system will notify the service provider and value-generating intermediaries of this by e-mail and the process will terminate.

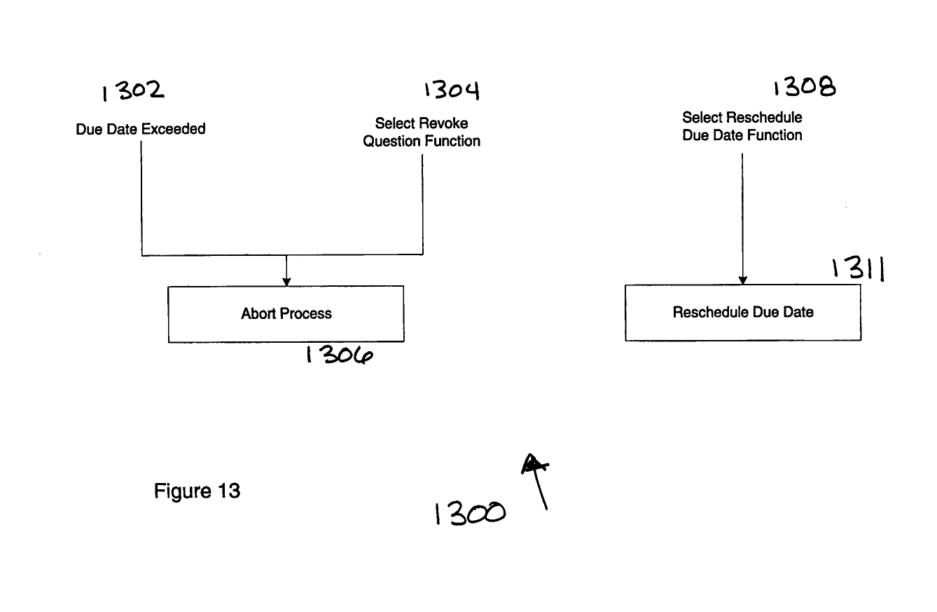

Referring to FIG. 13, generally at 1300, the process steps are shown for the requester (prospect) aborting a process it initiated and for rescheduling the due date. As described previously, the due date is the date that the requester (prospect) initially indicated by which the solution to the problem was needed. If a process under a unique ID is running and it passes the due date as shown at 1302, the system will move to step 1306 where the process is aborted. Further, if during the time the process is legitimately running and the requester (prospect) decides it no longer desires the solution to the problem, as shown at 1304, it may select the revoke question link. This will cause the process to proceed to step 1306 and also be aborted.

At step 1306, the system will generate a question-revocation message. This message will be sent by e-mail to all system users and the process will be terminated.

The requester (prospect), as shown at 1308, may for some reason need to reschedule the due date. If this is the case, the system will proceed to step 1310. At step 1310, the requester (prospect) will save a new due date. This will be the due date for all future transactions of the system.

Typically, the communications that will take place between the requester, intermediaries, and the system will be via e-mail for purposes of notification to log on to the system to take some action. An alternative method would be for the e-mail to be only for notification except for new intermediaries that would also get same question data. According to this alternative method, after receiving an e-mail notification, the system participant would log on and be provided display screens that would permit it to take the appropriate action for the circumstance. Each type of communication message between the requester and intermediaries, and the system and the requester or intermediaries would have a different display screen. Therefore, if the requester started the process by loading certain information on the system, the system will generate an e-mail to the intermediary to indicate it is being asked to answer a question and some question data would be provided. The e-mail will provide a link to the system for the intermediary to log on and be provided with the complete set of information about the question and parameters associated with the question. Upon logging on, the intermediary would be presented with this information and activation buttons to select the action it desires to take. This method would provide a level of security for the system.

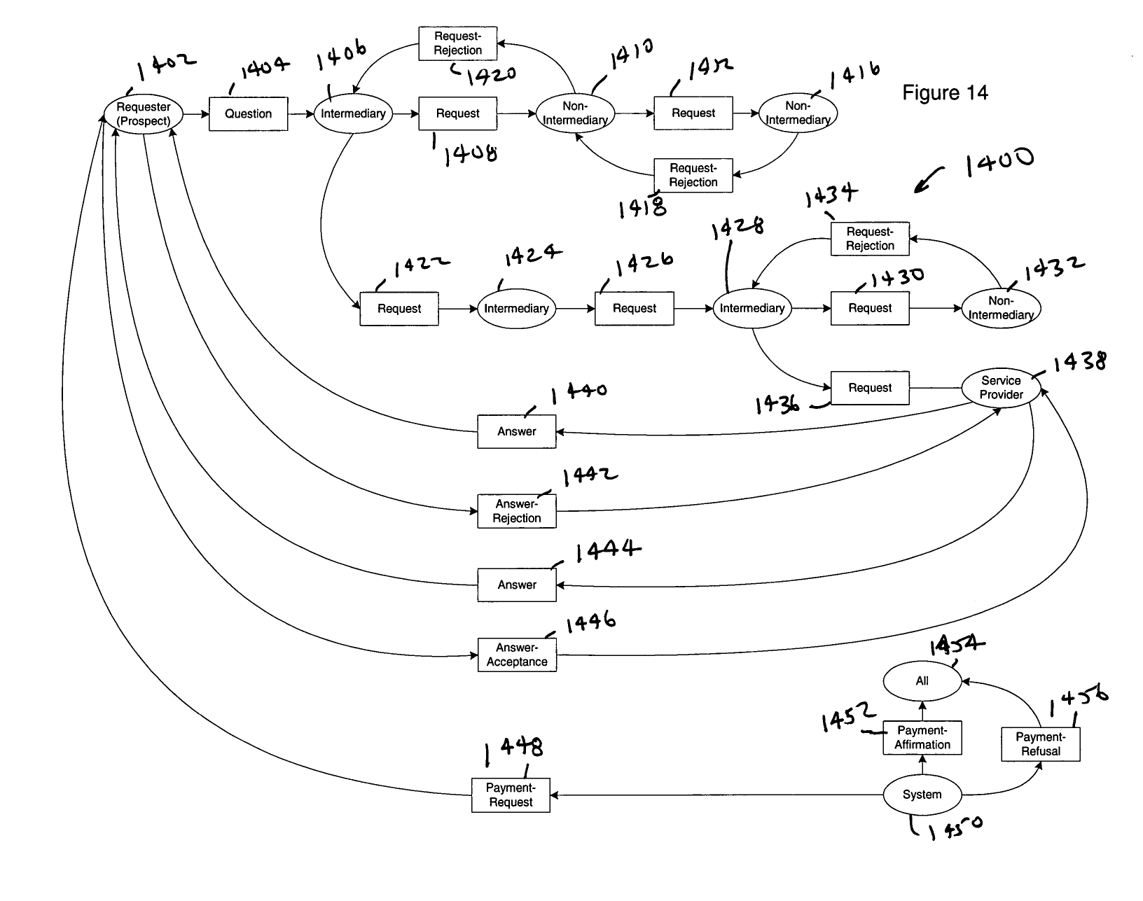

FIG. 14, generally at 1400, shows the roles and messages that may be communicated in the course of a process to obtain a solution to a problem. The requester (prospect) at 1402, after performing the preliminary considerations according to FIG. 6 and defining the parameters according to FIGS. 7 and 8, will initiate a service request according to FIG. 9. The requester (prospect) through the system generates a question message at 1404. The content of the question message will be based on the information entered by the requester (prospect). The requester (prospect) will enter the e-mail address of the first intermediary (player).

The intermediary (player) at 1406 will be sent the request information, the question, and the links for taking action in response to the question. The e-mail also will contain a hyperlink for the intermediary (player) to be able to access the system. If the intermediary (player) accesses the system using the hyperlink and this intermediary (player) has not used the system before, the system will automatically generate an account for it and send it the appropriate data for system access. The system will also provide a recipient ID for this intermediary (player).

At this point, the intermediary (player) may log on to the system with the access data it was provided and read all information about the question. The intermediary (player) will have four choices: (1) activate the answer link, (2) activate the forward link, (3) activate the send back link, or (4) do nothing that results in the system generating a request-rejection message. As shown in FIG. 14, the intermediary at 1406 selected the forward link, which caused the request message at 1408 to be generated to forward the question to another intermediary (player) shown at 1410.

Once the link is activated, at the appropriate place, the intermediary (player) will enter the e-mail address of the intermediary (player) at 1410 and also provide text informing the intermediary (player) at 1410 why it considered that intermediary (player) capable of being the next intermediary or potential service provider.

The intermediary (player) at 1410 will have an account automatically generated for it and the system will send it the appropriate data for system access. The intermediary (player) at 1410 will have the same four choices as its predecessor intermediary: (1) activate the answer link, (2) activate the forward link, (3) activate the send back link, or (4) do nothing that results in the system generating a request-rejection message. As shown in FIG. 14, the intermediary (player) at 1410 selected the forward to forward the request message at 1412 to intermediary (player) 1416.

Intermediary (player) 1416 has the same four choices as its predecessor, however, as shown, it selected the send back link which generates request-rejection message at 1418. In the text of the e-mail message that is generated, the intermediary (player) may explain why it cannot provide the solution. By rejecting the request, for value-generating purposes, the intermediary (player) becomes a non-intermediary.

The question is then forwarded back to intermediary (player) 1410. The intermediary (player) has the same four choices as before. The intermediary (player) at 1410 selected the send back link to generate the request-rejection message at 1420 to send the question back to the intermediary (player) at 1406. This makes the intermediary (player) at 1410 a non-intermediary for value-generating purposes.

The question is forwarded back to the intermediary (player) at 1406. This intermediary has the same four choices as the other intermediaries: (1) answer the question, (2) forward the question, (3) send back the question, or (4) do nothing that results in the system generating a request-rejection message. The intermediary (player) at 1406 selected the forward link that caused the request message at 1422 to be generated that forwarded the question to the intermediary (player) at 1424. This intermediary (player) has the same four choices and selected the forward link to generate the request message at 1426. The request forwarded the question to the intermediary (player) at 1428.

The intermediary (player) at 1428 has the same four choices as the other intermediaries and it selected the forward link to generate the request message at 1430 to forward the question to intermediary (player) 1432. The intermediary (player) at 1432, with the same four choices before it, selected the send back link. This will be handled as previously described. The question will be returned to intermediary (player) at 1428. Because the intermediary (player) at 1432 selected the send back link, a request-rejection message was generated, and it will now be considered a non-intermediary for value-generating purposes.

The intermediary (player) at 1428, with the four choices before it, selected the forward link and the request message at 1436 was generated. This will result in the question being forwarded to the intermediary (player) 1438. Of the four options available to it, the intermediary (player) at 1438 selected the answer link to generate the answer message at 1440. The solution to the problem may be provided in the message text or delivered outside the system. The answer message will be shown to all system users.

The requester (prospect) at 1402 will receive the answer message and take one of four actions. It could (1) select the reject link to generate an answer-rejection message, (2) select the extend time link to generate an answer-response-time-extension message, (3) select the accept link to generate an answer-acceptance message, or (4) do nothing and the system will automatically generate an answer-acceptance message when the response time is exceeded. At this time, the intermediary (player) at 1438 is a potential service provider. As shown at 1442, the requester (prospect) selected the reject link, which generates the e-mail answer-rejection message to send to the potential service provider. The requester (prospect) will include text why the answer was not acceptable. The answer-rejection message is available to all system users. The intermediary (player) again will have the same four choices previously discussed.

At 1444, the intermediary (player) at 1438 selected the answer link and provided another answer to the requester (prospect) at 1402, and again it becomes a potential service provider. The answer that is provided in this e-mail answer message must address the insufficiency that the requester (prospect) had previously indicated in the answer-rejection message. In this case, the requester (prospect) selected the accept link and the system generated an answer-acceptance message at 1446. This message is available to all system users. The potential service provider will now become the service provider.

At this time, the system will automatically transfer the clearing units in the defined currency from the requester's (prospect's) account to the accounts of the service provider and the value-generating intermediaries. In the case just described, the value-generating intermediaries were the intermediaries at 1406, 1424, and 1428. When the system has done this, the system at 1450 will generate a payment-affirmation message as shown at 1452 for all system users receiving a share of the reward as shown at 1454. Following this, the process will end.

The entitlements are determined by the reward algorithm. However, if, as in FIG. 14, the system was not able to do the transfer of clearing units because that requester (prospect) did not have enough clearing units in its account, then the system at 1450 will generate the payment-request message at 1448. This message will tell the requester (prospect) at 1402 how to proceed to pay the reward. If the requester (prospect) provides a sufficient amount of clearing units, the system will make the transfers and the system will generate the payment-affirmation message at 1452. If the requester (prospect) does not provide the clearing units in the prescribed period of time, the system at 1450 will generate the payment-refusal message at 1456. This will be sent to all system users and the system as shown at 1454.

FIG. 15, generally at 1500, shows an example of the distribution of shares according the process shown in FIG. 14. The number of clearing units posted as the reward is 100 clearing units. The distribution will be according to the reward algorithm previously discussed, which includes the following expressions:
B=X*(1−Y) (1)
IS=B*(Y)^{P} (2)
R=(Y)^{PT} (3)
IE=IS/(1−R) (4)
F=IE*SF (5)
E=IE−F (6)
Where,

E=entitlement.

B=basic value for reward.

X=the reward amount.

IS=interim shares.

P=intermediaries position from the service provider.

Y=intermediation factor that is determined by the requester (prospect).

IE=the entitlement before the removal of system fees.

R=calculated constant for the number of participants.

PT=the total number of participants.

F=calculated fee amount.

SF=system fee percentage.

The entitlements may be allocated so that the service provider will be given the largest amount of the reward and the remainder would be divided among the value-generating intermediaries. The allocation of entitlements among the intermediaries will be that each value-generating intermediary will receive 50% of the share of the one that preceded it. The entitlements will follow this allocation scheme according to where the value-generating intermediaries are positioned upstream of the service provider.

Referring to FIG. 15, the entitlement will be distributed based on the following: the reward is 10 clearing units, the intermediation factor is 0.5, there is a system fee of 3%, and 4 process participants. The service provider at 1538 received 5.17 clearing units. The next value-generating intermediary is intermediary 1528 that received 2.58 clearing units, which is 50% of the service provider. Value-generating intermediary 1524 is next and receives 1.29 clearing units, which is 50% of the receiving units of intermediary 1528. Last, value-generating intermediary 1506 receives 0.66. The total of units distributed is 10 clearing units less the system fee of 0.3 clearing units. The value-generating intermediary next to the requester(prospect) pays no fee. As such, the system fee is shared by each participant except the last which is this case is the value-generating intermediary at 1506.

The following table shows the rewards that will be paid for different intermediation factors and different number of participants according to the reward algorithm if the reward is 10 clearing units.

| | | | Service | 1^{st} Int. | 2^{nd} Int. | 3^{rd} Int. | SUM | |
|---|---|---|---|---|---|---|---|---|
| | Int. | Syst. Part. | Provider | from | from | from | of all | Fee |
| Reward | Factor | (w/o Requester) | (SP) | SP | SP | SP | Ent'ls | (3%) |
| 10 | 0.5 | 2 | 6.46 | 3.33 | — | — | 9.79 | 0.21 |
| 10 | 0.5 | 4 | 5.17 | 2.58 | 1.29 | 0.66 | 9.7 | 0.3 |
| 10 | 0.2 | 3 | 7.82 | 1.56 | 0.32 | — | 9.7 | 0.3 |
| 10 | 0.8 | 3 | 3.97 | 3.18 | 2.62 | — | 9.77 | 0.23 |

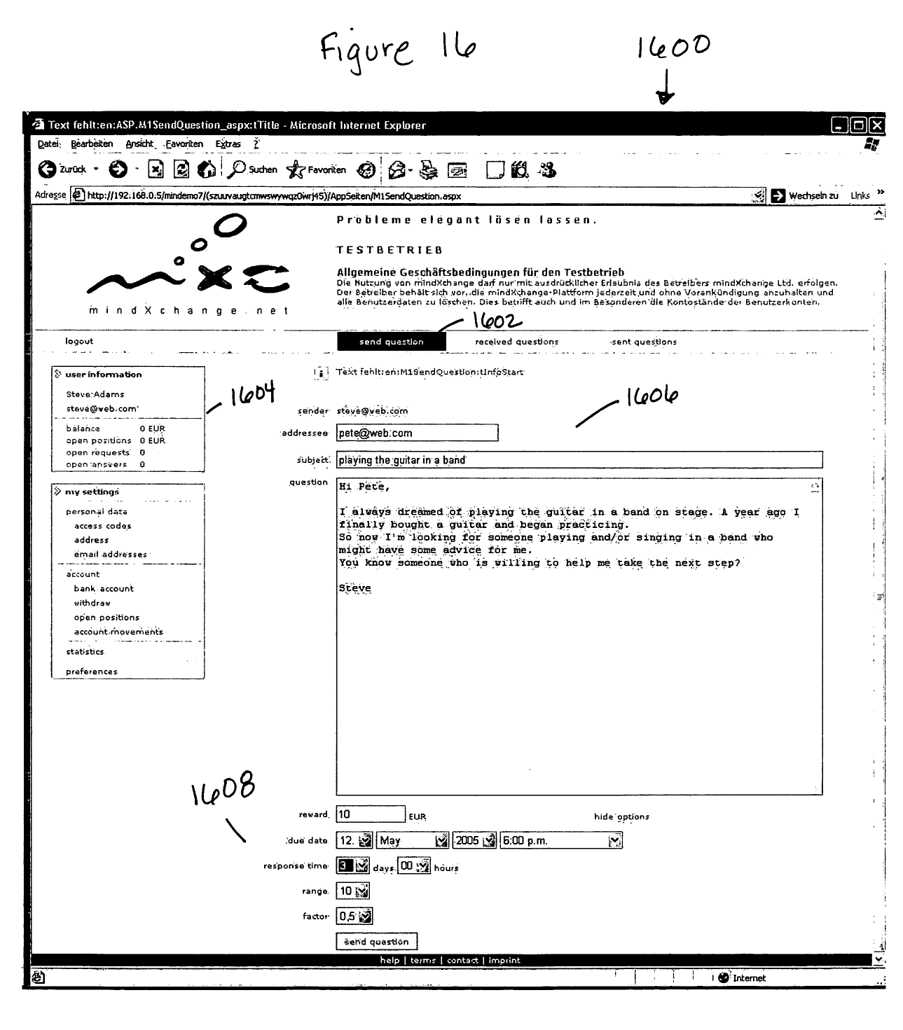

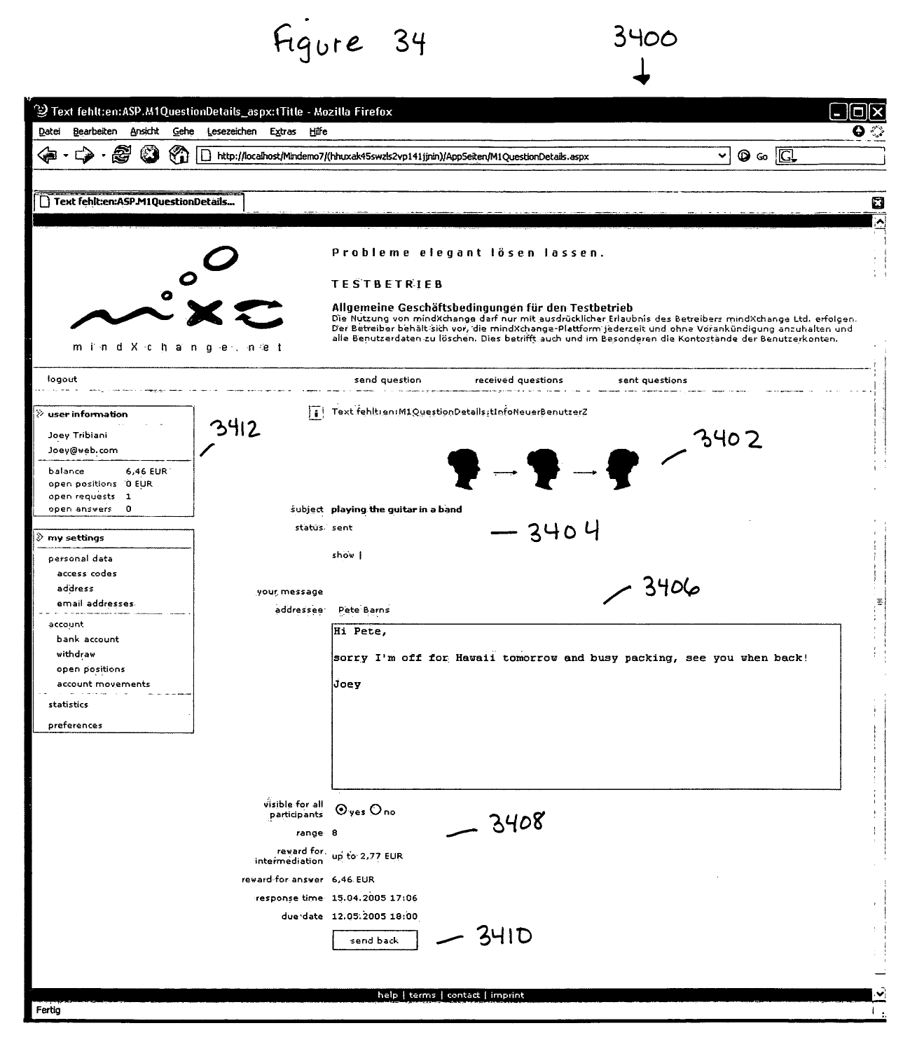

FIGS. 16-45 will now be referred to in describing Examples I and II, two intermediated transactions that are carried out using the rule-based system and method of the present invention. FIGS. 16-33 will be referred to with regard to the Example I and FIGS. 34-45 with regard to Example II.

### EXAMPLE I

FIG. 16, generally at 1600, shows a screen display according to the system and method of the present invention associated with a question sent by the requester (prospect) to an intermediary (player). As shown at 1602, the message relates to a question sent by “Steve Adams.” User information regarding the sent question is found at 1604. As stated, the entity sending the question is “Steve Adams.” Mr. Adams' e-mail address, and account information are also shown. At 1606, the sender and addressee e-mail addresses are shown along with the subject of the question. Also shown at 1606 is the question for which a solution is sought.

At 1608, information is provided that relates to the parameters for providing the solution. As shown, the reward amount is 10 Euros, the due date for the solution is by 6:00 p.m. on May 12, 2005, the response time for each intermediary is 3 days, the range is 10, and intermediation factor is 0.5.

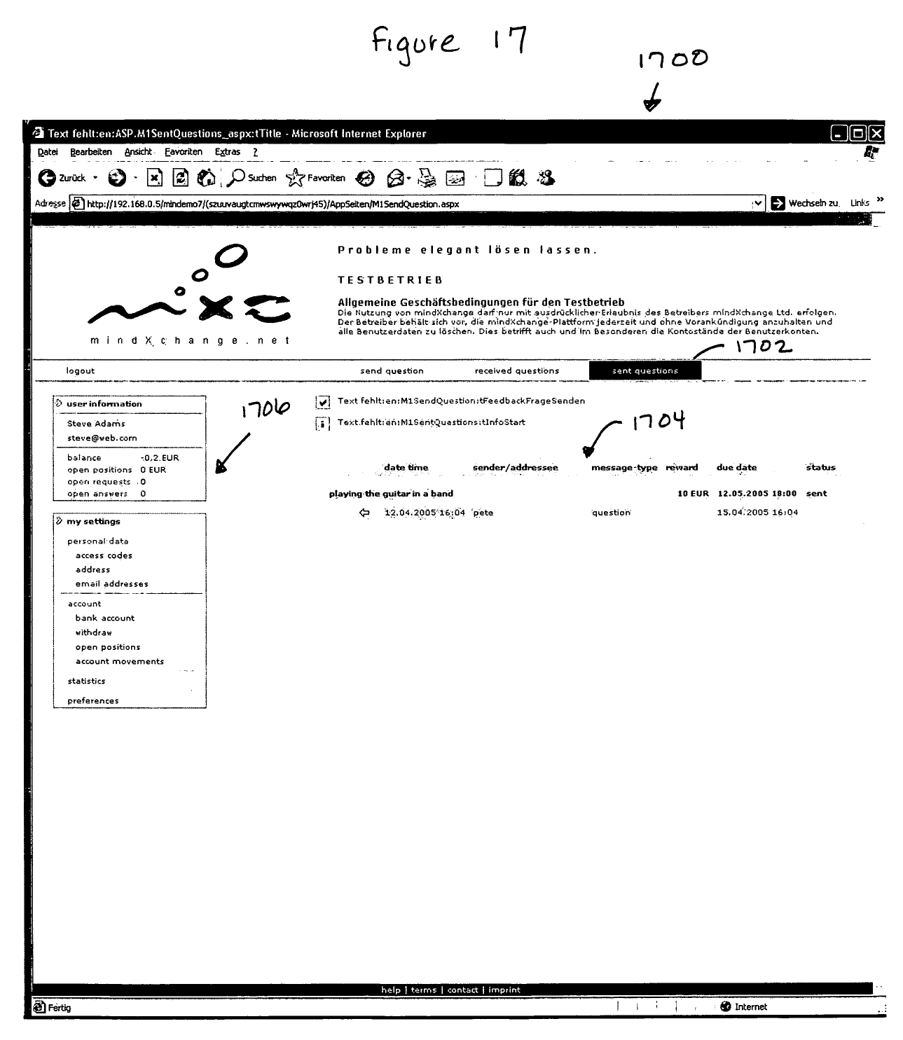

FIG. 17, generally at 1700, shows a display screen that would be generated by the system to show the information that was stored regarding Mr. Adams' activities at this stage in the process. At 1702, the screen display shows that the information below is directed to questions sent by Mr. Adams.

At 1704, on the first line, the subject of the question is shown: “playing the guitar in a band.” This line also shows the reward as 10 Euros, along with the due date for the answer to be provided, and the status of the question as being “sent” to the addressee. The second line shows the time the question was sent to the addressee along with the addressee, message type: “question,” and the due date for the response to the question message which is 3 days after the date the question message was sent. The arrow at the beginning of the line indicates the message was sent to Pete Barns.

The user information section of the screen display at 1706 again has information about Mr. Adams, but it shows that Mr. Adams now has a negative account balance of −0.2 Euros.

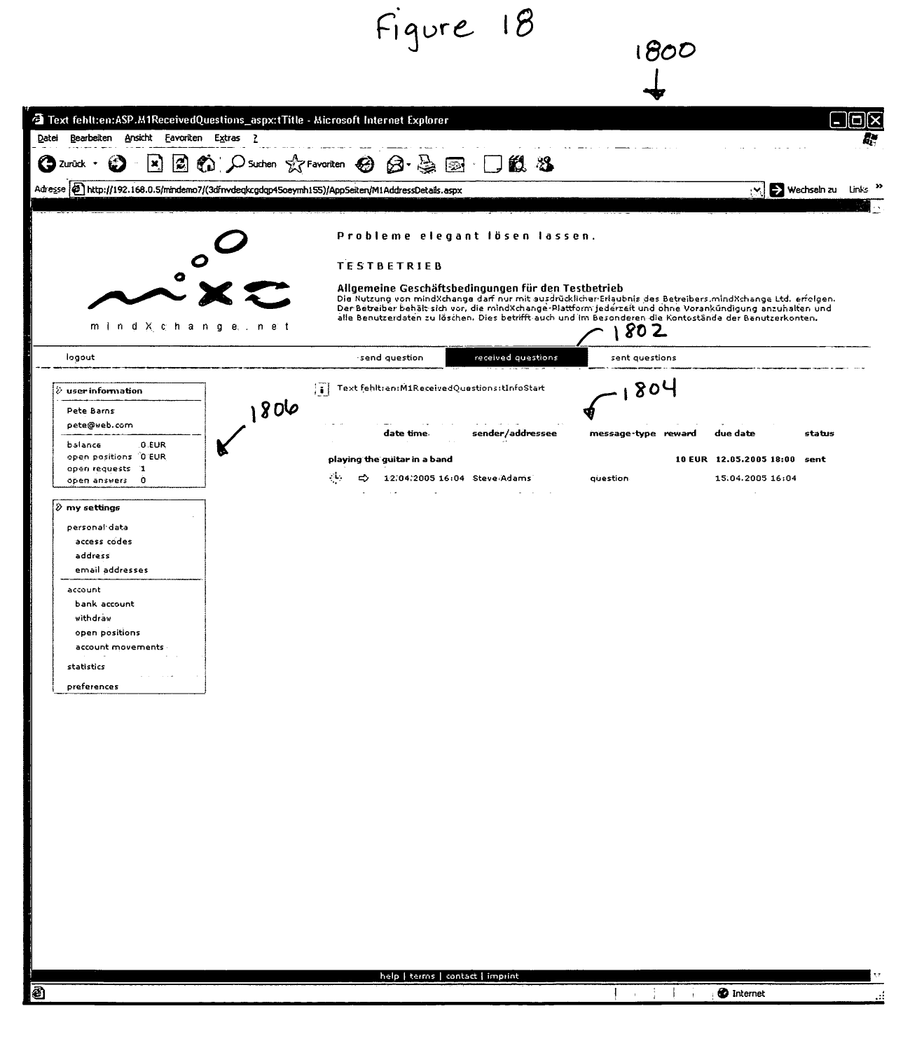

FIG. 18, generally at 1800, shows a display screen that would be generated by the system to show the information regarding Pete Barns activities at this point in the process as the recipient of the question. At 1802, the screen display indicates that the information below is directed to the question, received by Mr. Barns. At 1804, the information about the question received is shown. The first line shows the subject, the question, the reward, the due date for the answer to be provided, and the status of the question as being “sent” to the addressee. The second line includes the time the question was sent to the addressee, the entity that sent the message, message type: “question,” and the due date for a response to the question message. The arrow at the beginning of the line indicates that the question was sent from Mr. Adams.

The user information section of the display screen at 1806 contains information about Mr. Barns. It shows that there is one open request to Mr. Barns, which is the question he just received from Mr. Adams.

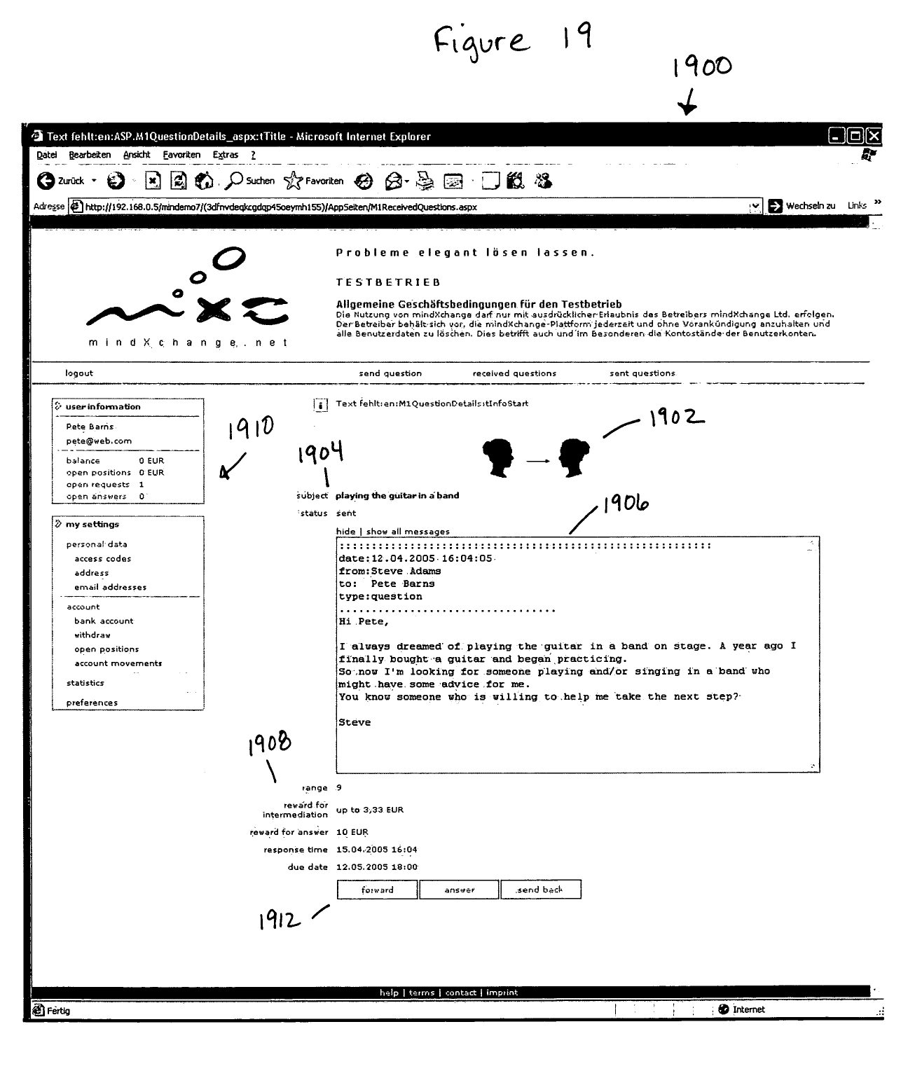

FIG. 19, generally at 1900, shows screen display that Mr. Barns will see when he connects to the link provided in the notification e-mail and then logs on to the system after performing the preliminary actions previously discussed to able to log on.

At 1902, the display screen shows graphically that Mr. Barns is the first intermediary in the process. The subject and status are provided at 1904. At 1906, the question is provided to Mr. Barns. The question will include the time the question was sent, the entity that sent the “question,” the recipient of the question, and the message type: “question.” Following this, the actual question is provided.

At 1908, information about the parameters for receiving the reward is shown. Since there was one forward of the question (to Mr. Barns), the range is reduced by 1 to 9. The reward for intermediation at this level would be up to 3.33 Euros for Mr. Barns if he sent the question to another entity that answered it with no further forwarding. However, the reward for Mr. Barns if he answered the question would be 10 Euros. The next two items, response time and due date for the answer, are the same as previously described.

At 1910, the user information for Mr. Barns is shown. Again, it shows that there is one open request before Mr. Barns.

At 1912, the possible actions that Mr. Barns can take are shown. He can forward the request to another intermediary, answer the question, or send the question back to the entity that sent it to him. There is actually a fourth action which is do nothing and let the response time run out and it will be treated as if Mr. Barns decided to send back the question.

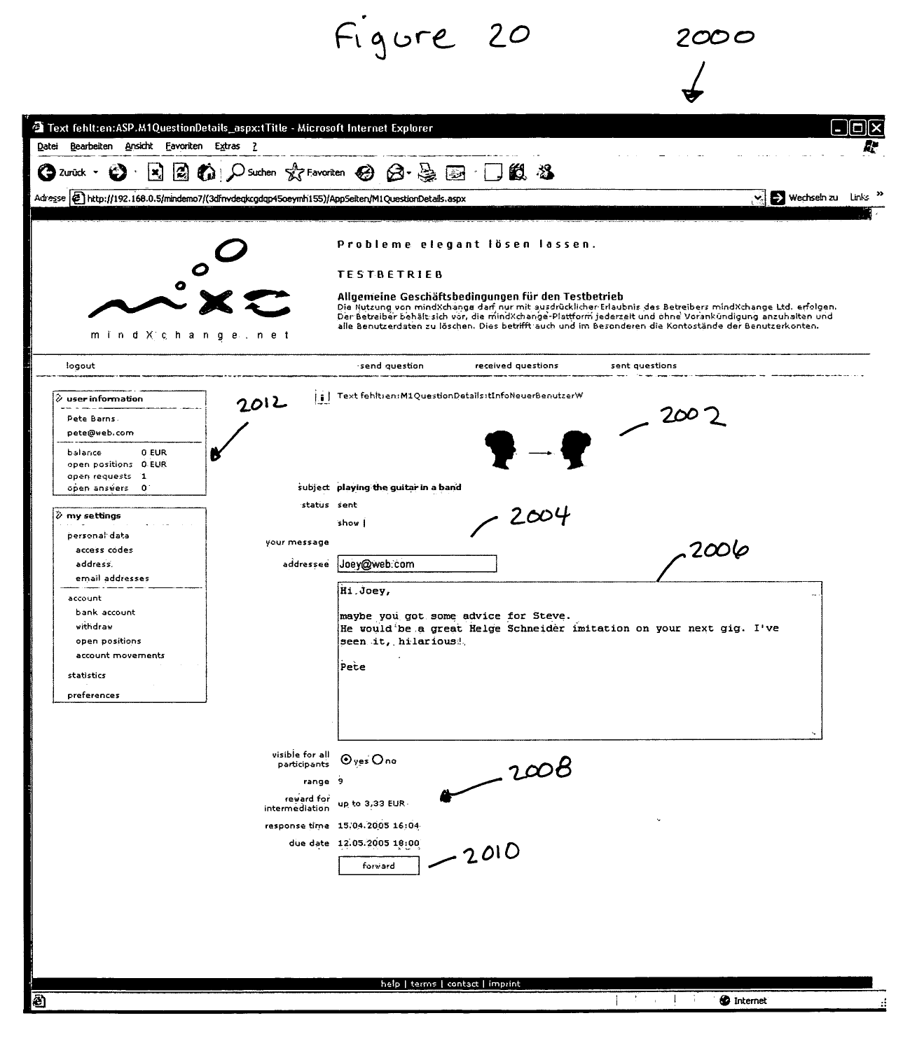

FIG. 20, generally at 2000, shows the screen display for Mr. Barns when he decided to forward the question to Joey Tribiani to hopefully provide the answer. At 2002, there has only been one forward of the question so that is graphically depicted here. At 2004, the subject of the question is shown, along with its status as “sent.” Next, there is Mr. Tribiani's e-mail address since he is to receive the forwarded request. Following this, Mr. Barns' message to Mr. Tribiani is shown at 2006.

At 2008, information about the reward is shown along with Mr. Barns' desire to have his message seen by all process participants. Also at 2008, the range, response time and due date are shown. Further, at 2008, the maximum amount for intermediation is shown for Mr. Barnes if Mr. Tribiani chooses to answer the question without any additional forwarding.

At 2010, the screen display indicates that the action taken by Mr. Barns is forwarding the question.

At 2012, the user information at this stage in the process has not changed for Mr. Barns and is the same as it was in FIG. 19.

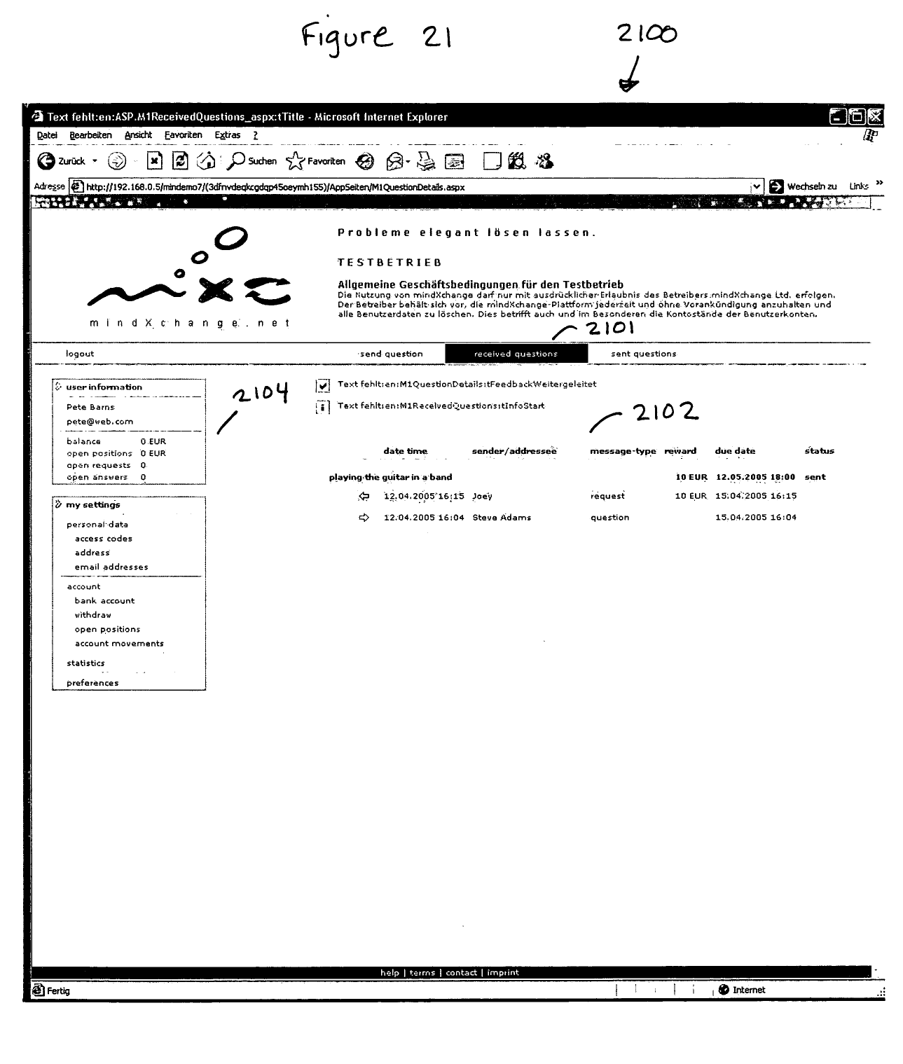

FIG. 21, generally at 2100, shows a screen display that would be generated by the system with regard to Mr. Barns' activity up to this point in the process. At 2101, it indicates that the information below is directed the questions received by Mr. Barns. At 2102, the first line shows the subject of the question: “playing the guitar in a band,” the reward, the due date for the answer, and the status of the question as “sent.”

The second line shows the time the request was forwarded, that the request was sent to Mr. Tribiani, the message type: “request,” and the due date for the response to the request message. The arrow at the beginning of the line indicates that request was sent by Mr. Barns to Mr. Tribiani.

The third line shows the time the question was sent to Mr. Barns and that it was sent by Mr. Adams. Next, the message type: “question” and due date for the response to the request message are shown. The arrow at the beginning of the line indicates the message was sent by Mr. Adams to Mr. Barns.

The user information for Mr. Barns is shown at 2104. This information has changed because once Mr. Barns forwarded the question to Mr. Tribiani, Mr. Barns no longer had an open request before him. This is reflected in the open requests being “0.”

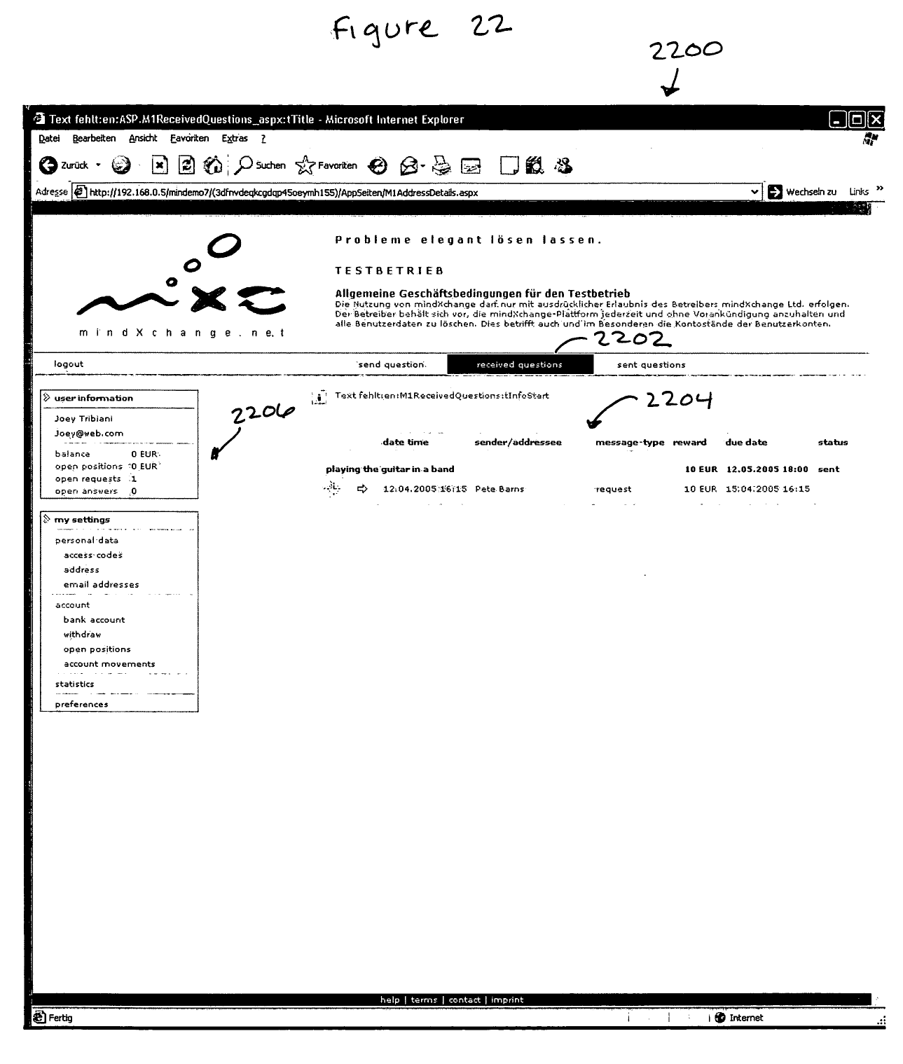

FIG. 22, generally at 2200, shows a display screen that would be generated by the system of the present invention to show the information relating to Mr. Tribiani once the request had been forwarded to him. At 2202, the screen display indicates that the information below is directed to questions received by Mr. Tribiani. At 2204, the information about the request received by Mr. Tribiani is shown. On the first line, the subject of the question, the reward amount, the due date for the answer, and the status of the question as being “sent” are shown. The next line shows the time the request was sent to Mr. Tribiani, that Mr. Barns sent the request to Mr. Tribiani, the message type: “request,” the reward amount, and the due date for the response to request message to be sent. The arrow at the beginning of the line indicates that the request was sent from Mr. Barns.

The user information section of the display screen at 2206 contains information about Mr. Tribiani. It shows that there is one open request to Mr. Tribiani, which is the request that he just received from Mr. Barns.

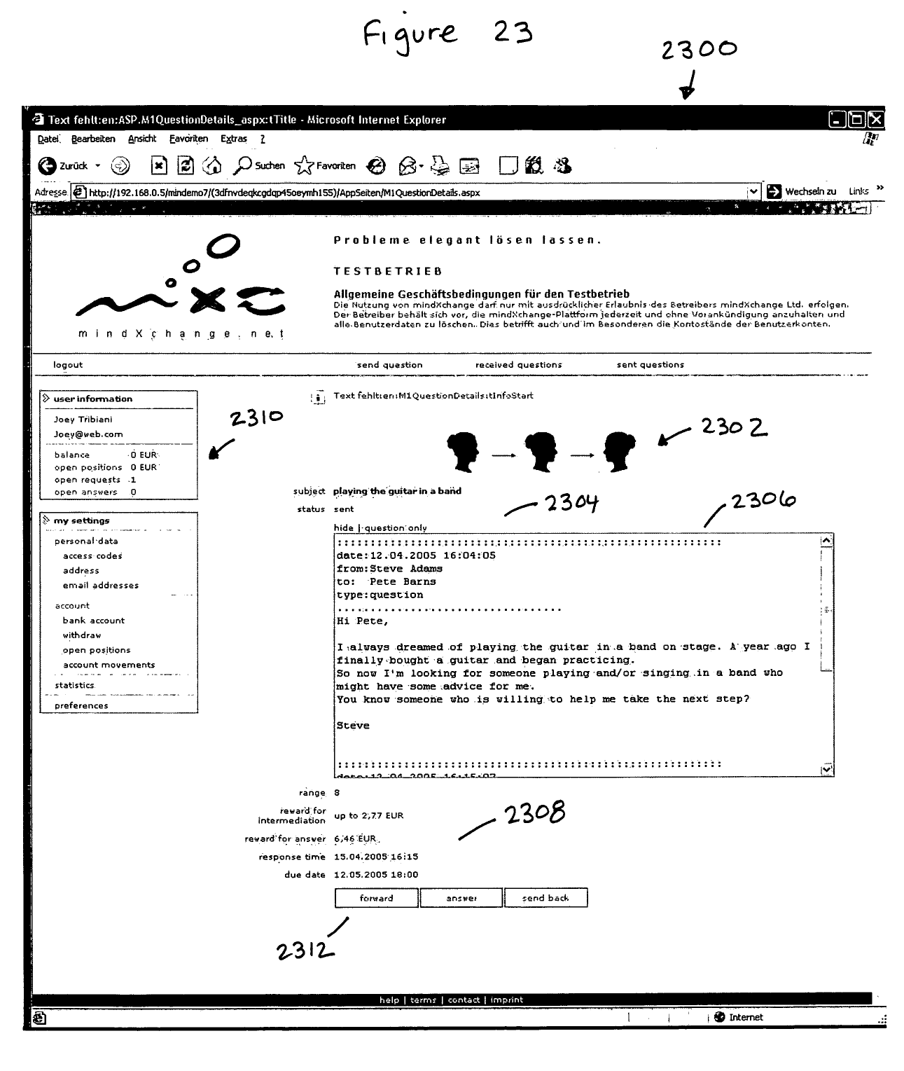

FIG. 23, generally at 2300, shows the screen display that Mr. Tribiani will see when he connects to the link provided in the notification e-mail and then logs on to the system of the present invention after performing the preliminary action previously discussed to able to log on. At 2302, the display screen shows graphically that Mr. Tribiani is the second intermediary in the process of the present invention. The subject and status are provided at 2304. At 2306, the original question from Mr. Adams is provided to Mr. Tribiani. The question will include the time the question was sent, the entity that sent the question, the recipient of the question, and the message type: “question.” Following this, the actual question is presented.

At 2308, information about the parameters for receiving the reward is shown. Since this is the second forward of the question (Mr. Adams to Mr. Barns was the first), the range is reduced to 8. The reward for intermediation at this level would be up to 2.77 Euros for Mr. Tribiani if he sends the question to another entity that answered it with no further forwarding. However, the reward for Mr. Tribiani if he answered the question would be 6.46 Euros. The next two items response time and due date for the answer to be provided are same a previously described for the request.

At 2310, the user information for Mr. Tribiani is shown. Again, it shows that there is one open request before Mr. Tribiani.

At 2312, the possible actions that Mr. Tribiani can take are shown. He can forward the request to another intermediary, answer the question, or send the question back to the entity that sent it to him. There is a fourth action that was previously discussed which is do nothing and let the response time run out and it will be treated as if Mr. Tribiani decided to sent it back.

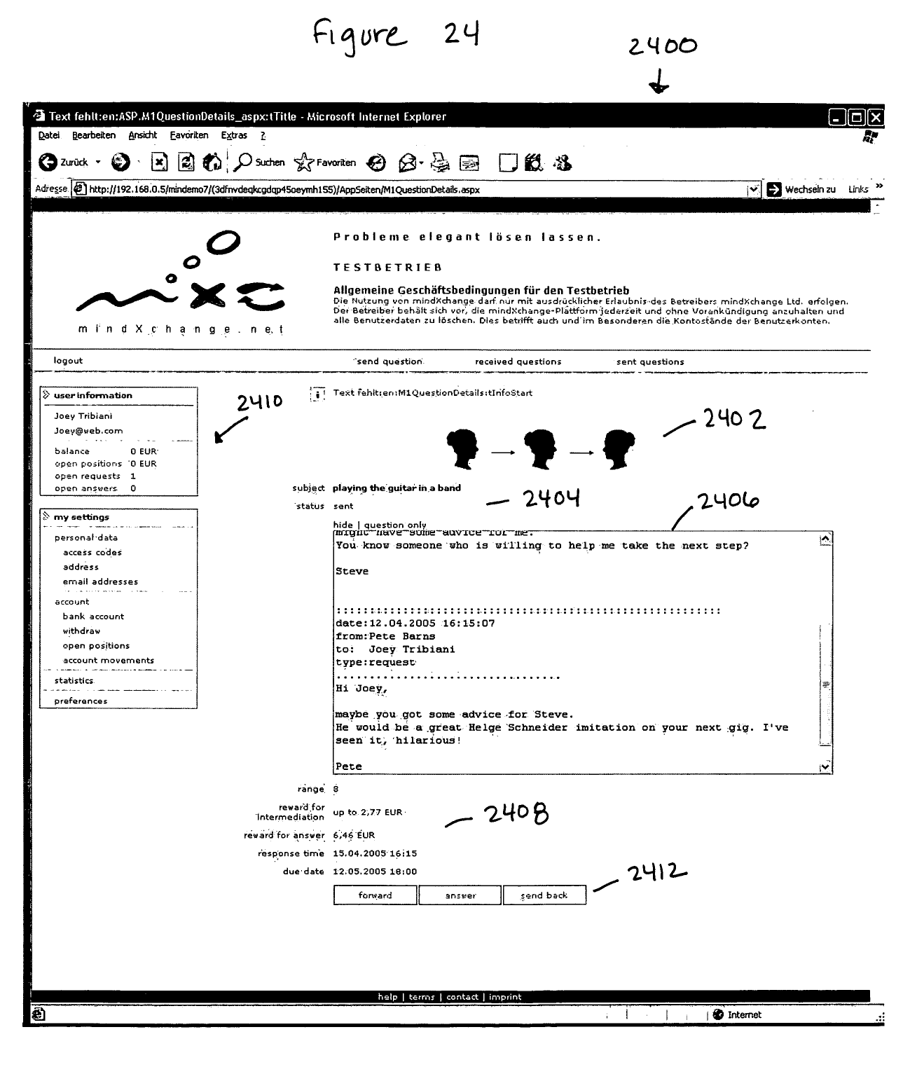

FIG. 24, generally at 2400, shows the message that Mr. Barns sent Mr. Tribiani that accompanied the request. This is accessed by scrolling through the messages at 2406. All of the other information on this screen display is the same as on the screen display shown in FIG. 23. Therefore, the descriptions for 2402, 2404, 2408, 2410, and 2412 were the same as previously described for 2302, 2304, 2308, 2310, and 2312 in FIG. 23. Those descriptions are incorporated here by reference.

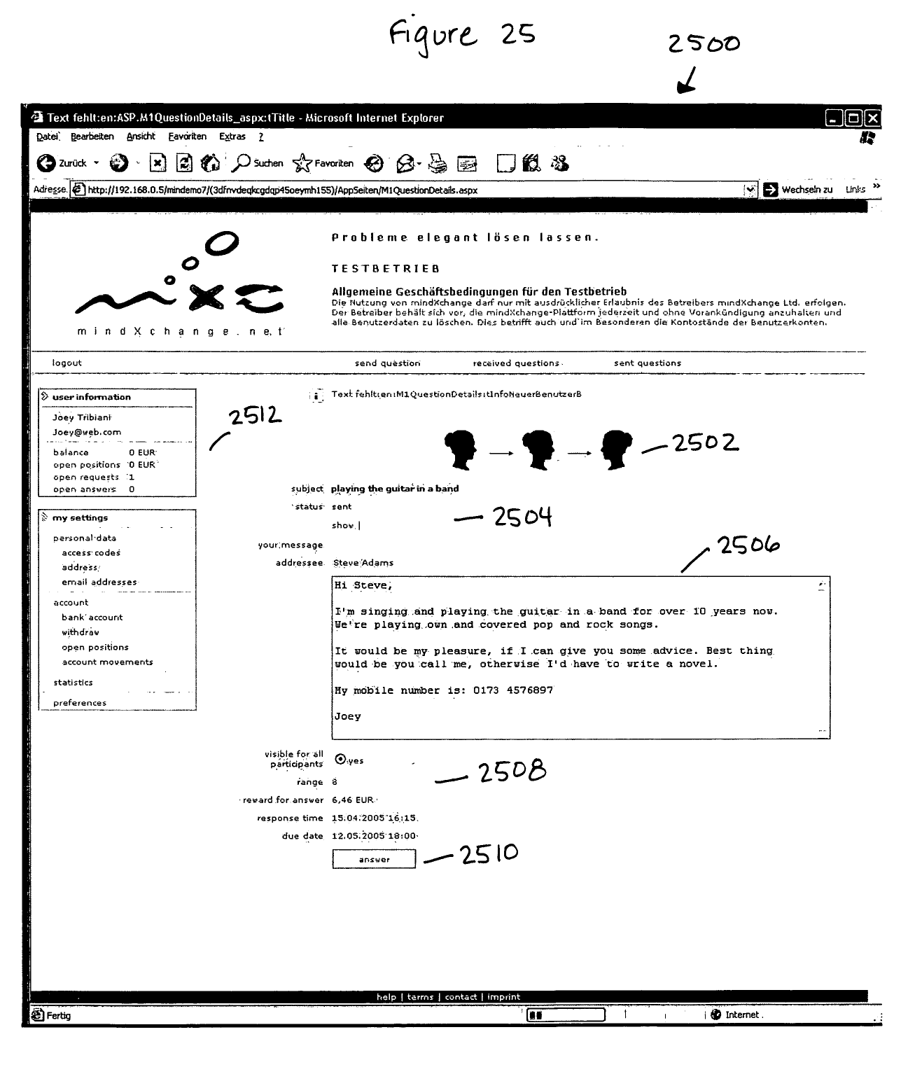

FIG. 25, generally at 2500, shows the answer that Mr. Tribiani sent to Mr. Adams. At 2502, again the display screen shows graphically that Mr. Tribiani is the second intermediary in the process of the present invention. The subject and status are provided at 2504. Below this, the addressee of the answer message is shown. At 2506, the actual message that Mr. Tribiani is sending to Mr. Adams is shown.

At 2508, information about the reward will be seen by all process participants. However, the system may be confirmed to make this controllable by the potential service provider. Also, at 2508, the range, response time, and due date for the answer are shown. Finally, at 2508, the amount that Mr. Tribiani will receive for providing the answer is shown, which at this level is 6.46 Euros.

At 2510, the screen display indicates that the action taken by Mr. Tribiani is answering the question.

At 2512 the user information for Mr. Tribiani is shown. Again, it shows that there is one open request that will remain until his answer is sent to Mr. Adams.

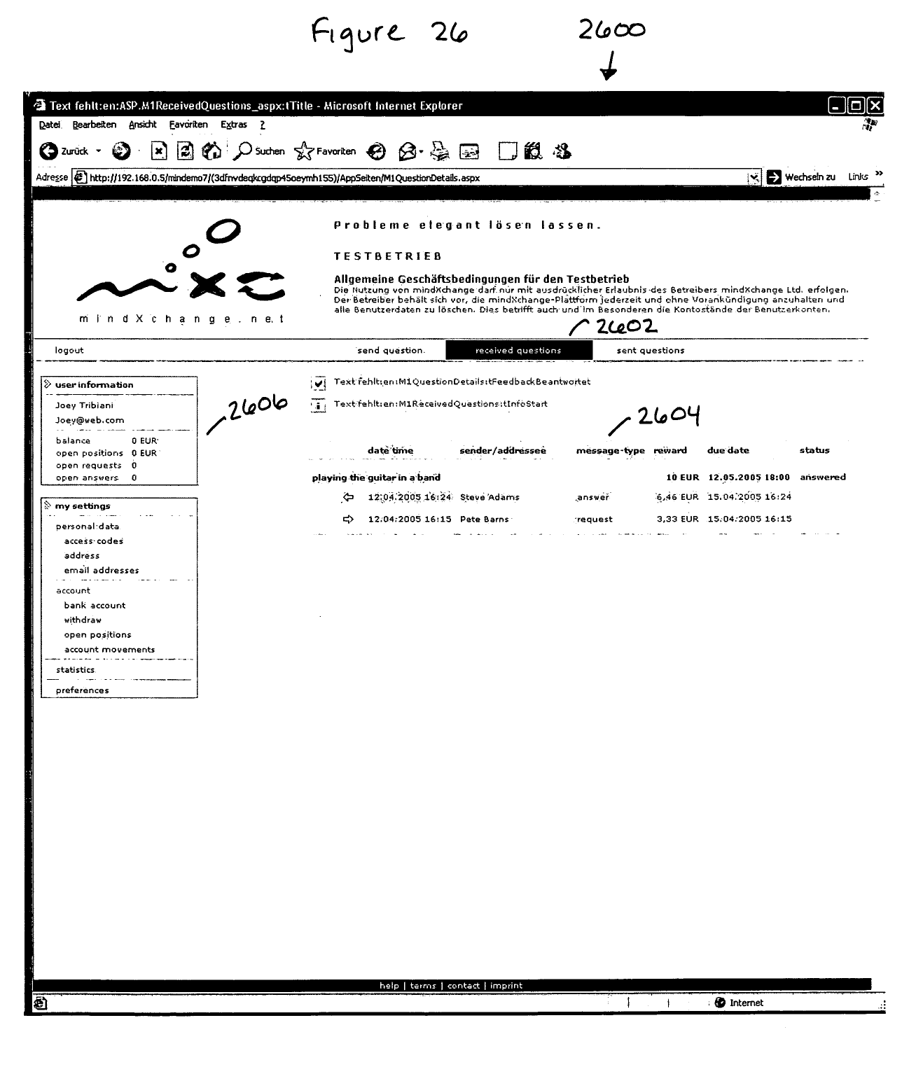

FIG. 26, generally at 2600, shows a screen display that would be generated by the system with regard to Mr. Tribiani's activity at the point of sending the answer to Mr. Adams. At 2602, the screen display indicates that the information below is directed to questions received by Mr. Tribiani. At 2604, the first line shows the subject of the question, reward, due date for the answer to be provided, and status of the question as being “answered.”

The second line shows the time the answer was forwarded to Mr. Adams, that the addressee of answer was Mr. Adams, the message type: “answer,” that the reward of 6.46 Euros is due Mr. Tribiani for answering the question, and the due date for the response to the answer message to be responded to by the requester (prospect). The arrow at the beginning of the line indicates that answer message was sent by Mr. Tribiani to Mr. Adams.

The third line indicates the time the request was sent to Mr. Tribiani, that Mr. Barns sent the request to Mr. Tribiani, the message type: “request,” that the reward of 3.33 Euros is due Mr. Barns as a value-generating intermediary, and the due date for the response to the request message. The arrow at the beginning of the line indicates the message was sent by Mr. Barns to Mr. Tribiani.

Since Mr. Tribiani answered the question, any value-generating intermediaries will be in his transaction chain. This is why the reward to Mr. Barns is shown here.

The user information for Mr. Tribiani is shown at 2606. This information has changed because once Mr. Tribiani sent the answer to Mr. Adams, Mr. Tribiani no longer had an open request before him. This is reflected in the open requests being “0.”

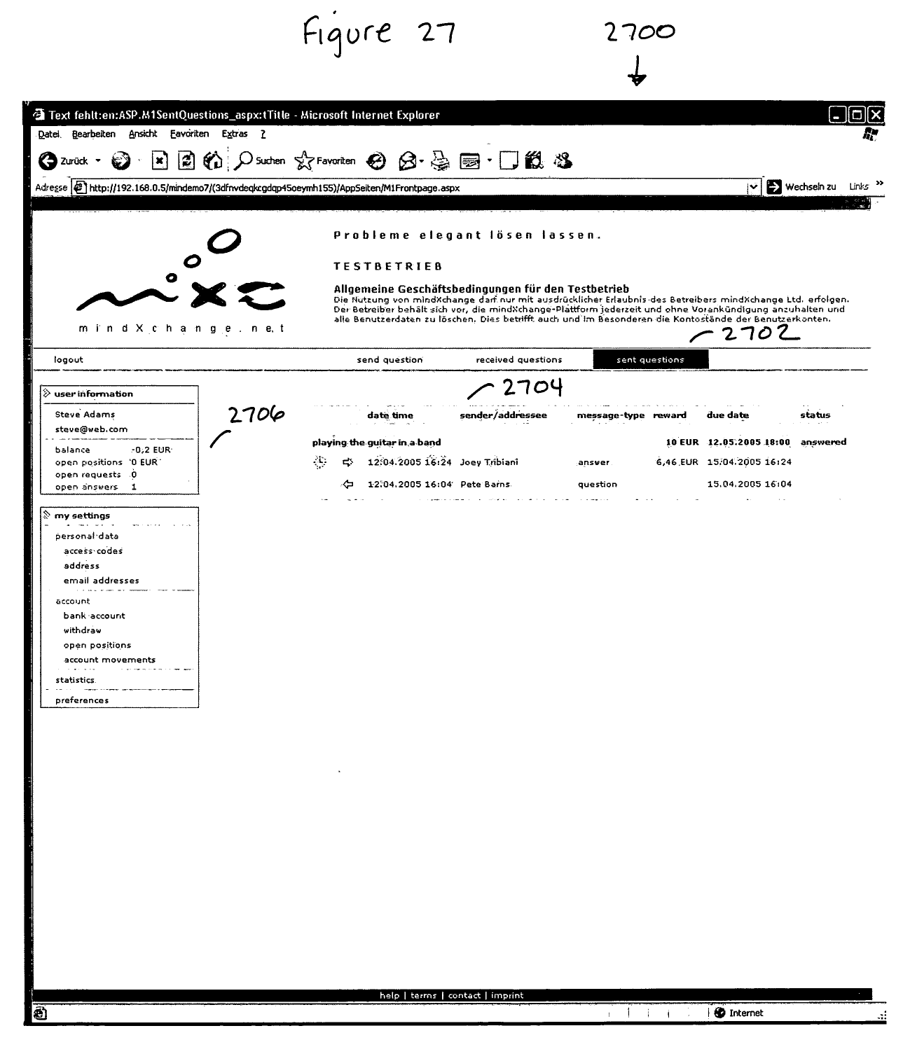

FIG. 27, generally at 2700, shows a screen display that would be generated by the system with regard to Mr. Adams' activity at the point in the process when he received the answer. At 2702, the screen display indicates that the information below is directed to questions sent by Mr. Adams. At 2704, the first line shows the subject of the question, reward, due date for the answer to be provided, and status of the question as being “answered.”

The second line shows the time the answer was forwarded to Mr. Adams, that the answer was sent by Mr. Tribiani, the message type: “answer,” that the reward of 6.46 Euros is due to Mr. Tribiani for answering the question, and the due date for the response by the requester (prospect). The arrow at the beginning of the line indicates that answer message was sent by Mr. Tribiani to Mr. Adams.

The third line provides the time the question was sent to Mr. Barns, that Mr. Barns sent the question, the message type: “question,” and the due date for a response to the question message. The arrow at the beginning of the line indicates the message was sent by Mr. Adams to Mr. Barns.

The user information for Mr. Adams is shown at 2706. This information indicates that Mr. Adams has an account balance of −0.2 Euros and there is an open answer that must be accepted or rejected. The −0.2 Euro account balance does not provide sufficient funds to pay the 10 Euro reward. Therefore, Mr. Adams must add funds to his account balance.

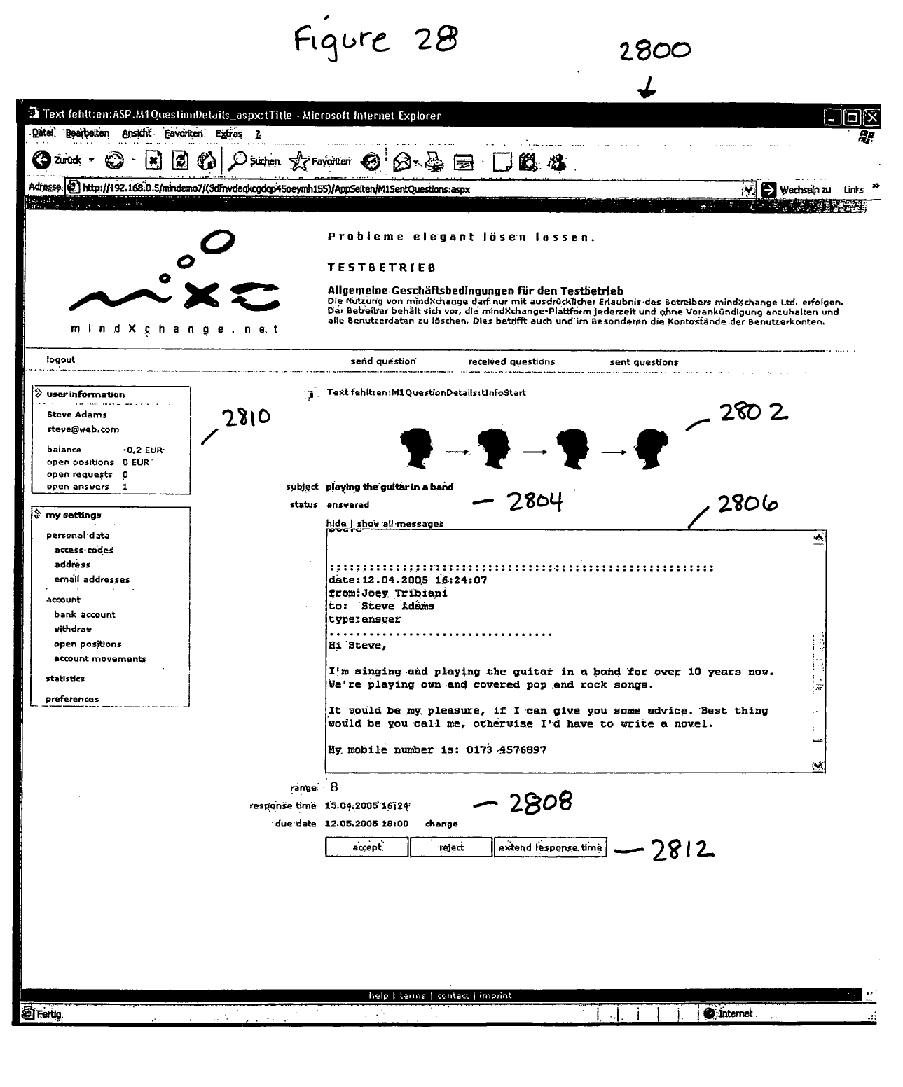

FIG. 28, generally at 2800, shows the answer message that Mr. Adams received from Mr. Tribiani. At 2802, the display screen shows Mr. Adams graphically as the last addressee in the process of the present invention. The subject and status are provided at 2804. At 2806, the actual answer that Mr. Tribiani sent to Mr. Adams is shown. The message includes the time the answer was sent, the entity that sent the answer, the recipient of the answer, and the message type: “answer.” Following this, the actual answer is shown.

At 2808, information about the relating to the answer is provided. Since there has been no further action to the question, the range remains at 8. The next two items, the response time and due date for the answer to be provided, are the same as previously described for the answer message.

At 2810, the user information for Mr. Adams is shown. This information indicates that Mr. Adams has an account balance of −0.2 Euros and there is an open answer for him to accept or reject. The −0.2 Euro account balance does not provide sufficient funds to pay the reward. Therefore, as stated, Mr. Adams must take some action to rectify this.

At 2812, the possible actions that Mr. Adams can take are shown. He can accept the answer, reject the answer, or grant the proposed service provider an extension of time. If, however, Mr. Adams does nothing and time expires, then it will be treated as if he accepted the answer.

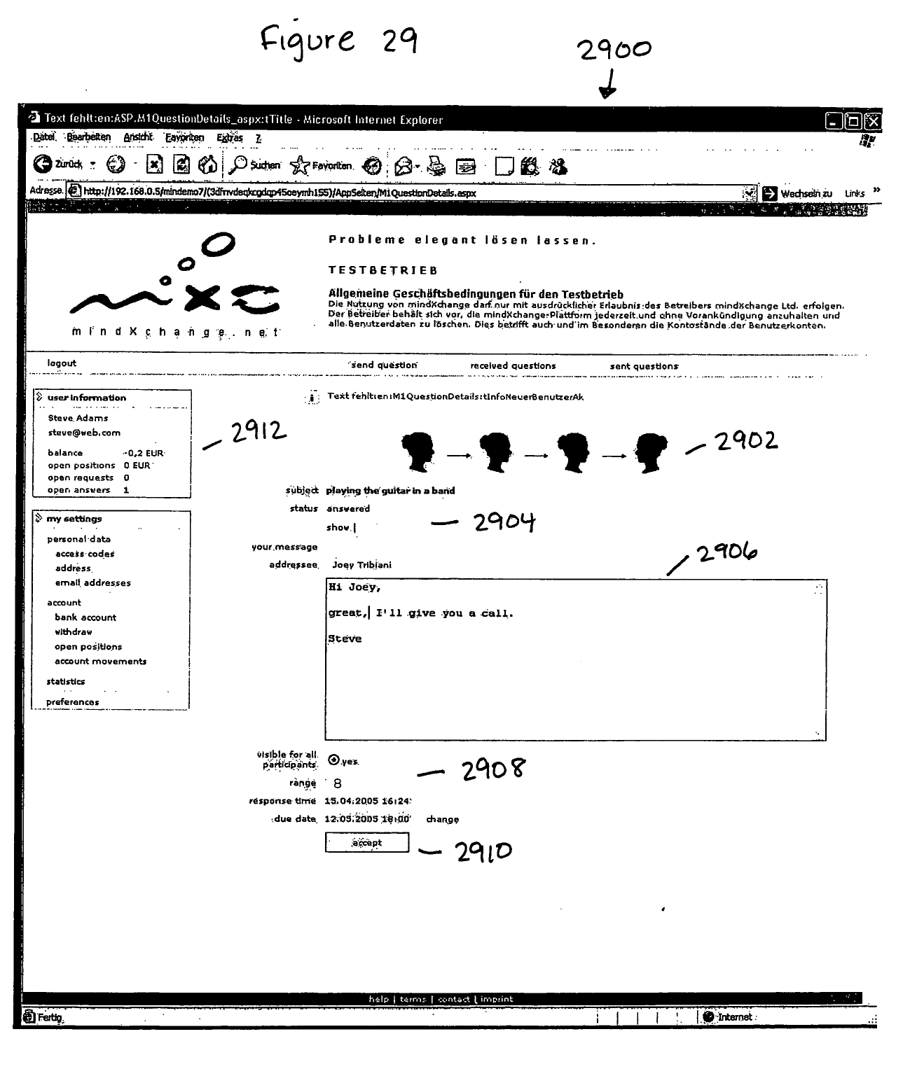

FIG. 29, generally at 2900, shows the answer-acceptance message that Mr. Adams sent to Mr. Tribiani. At 2902, again the display screen shows graphically that Mr. Adams is the third forwarding action in the process of the present invention. The subject and status are provided at 2904. Below this, the addressee of the answer-acceptance message is shown as Mr. Tribiani. At 2906, the actual message that Mr. Adams is sending to Mr. Tribiani is shown.

At 2908, information about the answer-acceptance is shown to all process participants. However, as before, the system may be configured to make the display of this information controllable by the requester (prospect). Also at 2908, the range, response time, and due date for the answer to be provided are shown.

At 2910, the screen display indicates that the action being taken by Mr. Adams is accepting the answer.

At 2912, the user information for Mr. Adams is the same as described for 2810 in FIG. 28. Those descriptions are incorporated here by reference.

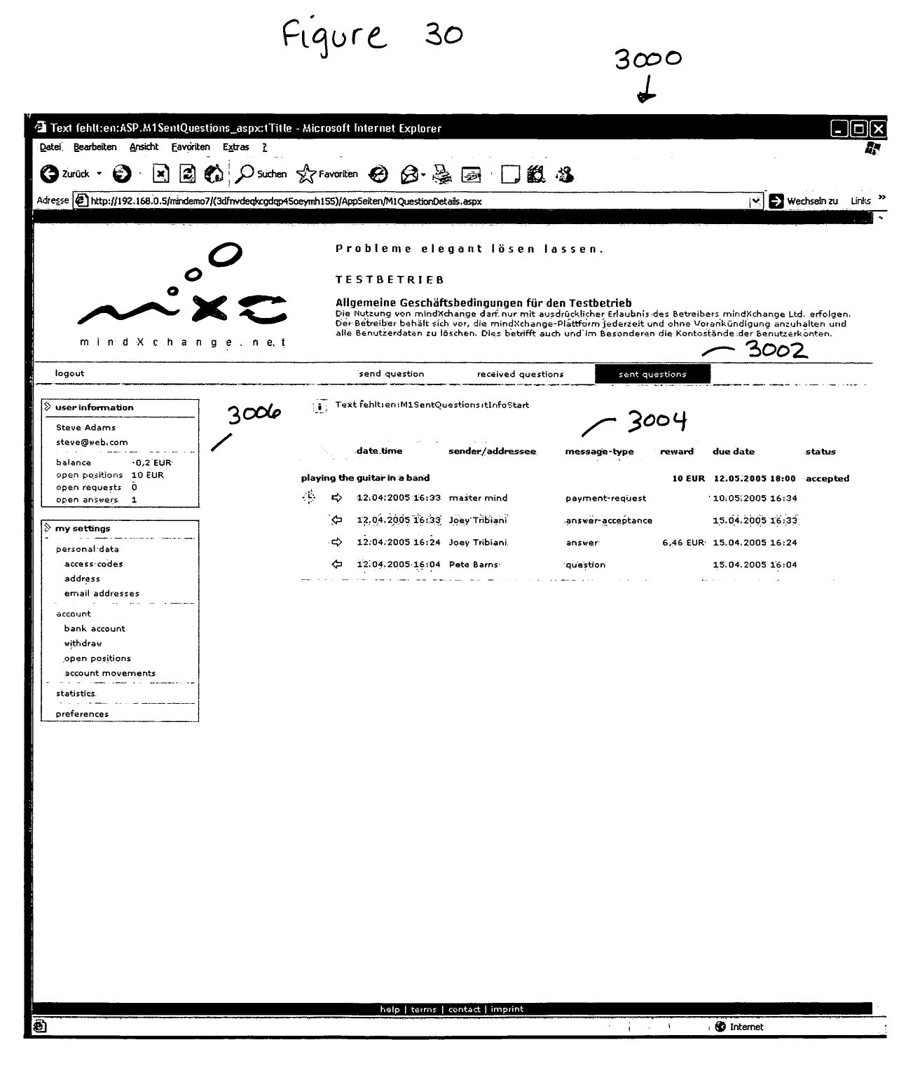

FIG. 30, generally at 3000, shows a screen display that would be generated by the system with regard to payment-request message being sent to Mr. Adams. At 3002, the screen display indicates that the information below is directed to the questions sent by Mr. Adams. At 3004, the first line shows the subject of the question, the reward, the due date for the answer to be provided, and the status of the answer as being “accepted.”

The second line provides that the system generated a payment-request message that it sent to Mr. Adams because, as shown at 3006, Mr. Adams had an account balance of −0.2 Euros and a reward of 10 Euros to pay. The second line includes the time the payment-request message was sent to Mr. Adams, the originator the message (the system master mind), the message type: “payment-request,” and the due date for responding to the payment-request message, which is May 10, 2005 at 16:34. The arrow at the beginning of the second line indicates that the message was sent from the system to Mr. Adams.

The third line shows the time the answer-acceptance message was sent, that it was sent to Mr. Tribiani, the message type: “answer-acceptance,” and the due date for the answer-acceptance message to be sent. The arrow at the beginning of the line shows that the answer-acceptance was sent from Mr. Adams to Mr. Tribiani.

On the fourth line, it shows the time the answer was forwarded to Mr. Adams, that the answer was sent by Mr. Tribiani, the message type: “answer,” that the reward of 6.46 Euros is due to Mr. Tribiani, and the due date for the response to the answer message to be sent. The arrow at the beginning of the line indicates that answer was sent by Mr. Tribiani to Mr. Adams.

The fifth line includes the time the question was sent to Mr. Barns, that Mr. Barns was sent the question, the message type: “question,” and the due date for the response to the question message to be sent. The arrow at the beginning of the line indicates the message was sent by Mr. Adams to Mr. Barns.

The user information for Mr. Adams is shown at 3006. The open positions are set to 10 Euros, hence Mr. Adams has an award of this amount to pay. The remaining information is the same as in FIGS. 28 and 29. As such, the information in these Figures relating to user information is incorporated here by reference.

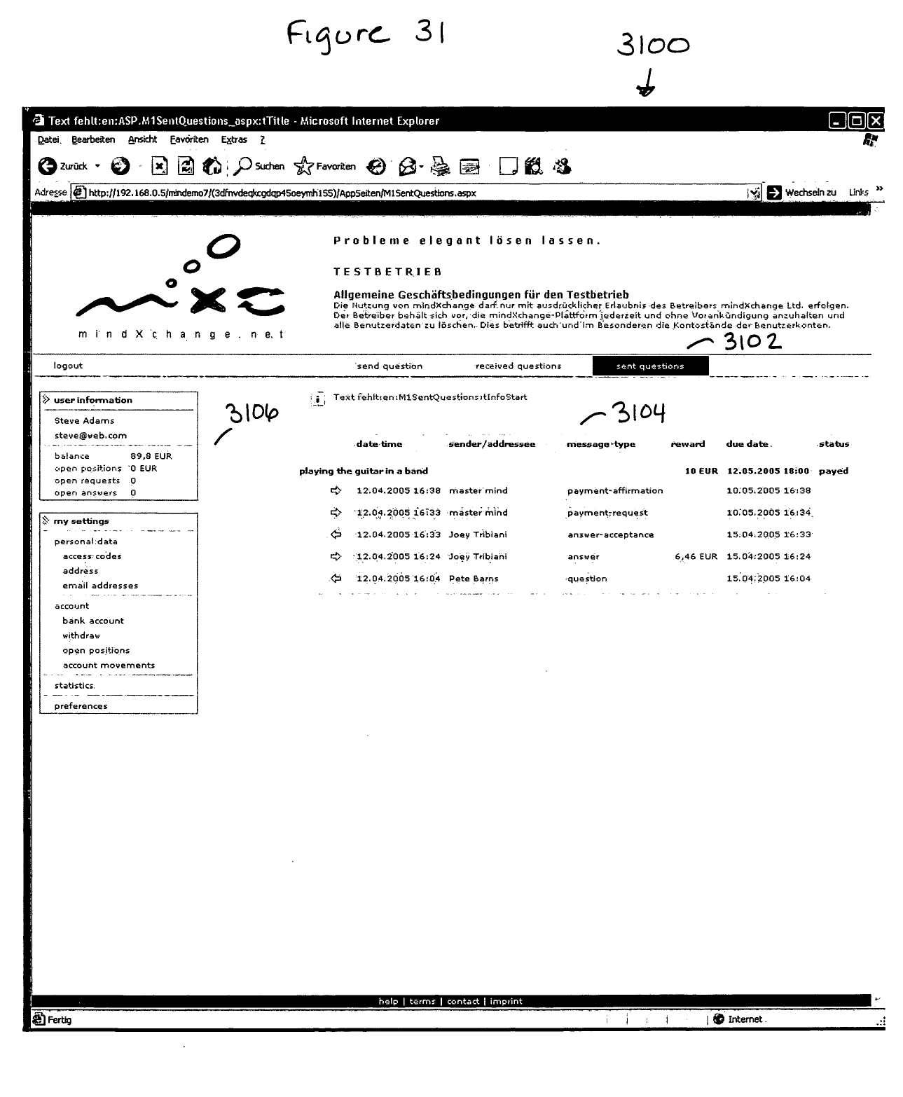

FIG. 31, generally at 3100, shows a screen display that would be generated by the system with regard to Mr. Adams' activities relating to the payment-affirmation message. Moreover, it shows all of Mr. Adams' activities in the process. At 3102, the screen display indicates that the information below is directed to the questions sent by Mr. Adams. At 3104, the first line shows the subject of the question, the reward, the due date for the answer to be provided, and the status of the reward as being “paid.”

The second line is directed to the payment-affirmation message that it sent to Mr. Adams. This message was generated by the system after Mr. Adams completes the instructions provided to add sufficient funds to his account-balance to cover the amount of the reward. Mr. Adams paid 100 Euros into his account, which is sufficient to pay the 10 Euros reward that is due. This payment will be discussed in detail subsequently. The second line includes the time the payment-affirmation message was sent, the originator of the message (the system master mind), the message type: “payment-affirmation,” and the due date for the response to payment-affirmation message. The arrow at the beginning of the second line indicates that the message was sent from the system the Mr. Adams.

The third, fourth, fifth, and sixth lines are the same as the second, third, fourth, and fifth lines of FIG. 30. Therefore, those descriptions are incorporated here by reference.

The user information for Mr. Adams is shown at 3106. This information indicates that Mr. Adams has an account balance of 89.8 Euros and there is no longer any open question or answers. The balance is 89.8 Euros because the 10 Euros reward and the −0.2 Euro starting balance had to be deducted from 100 Euros added to Mr. Adams' account balance. The open positions are also reset to 0 Euros.

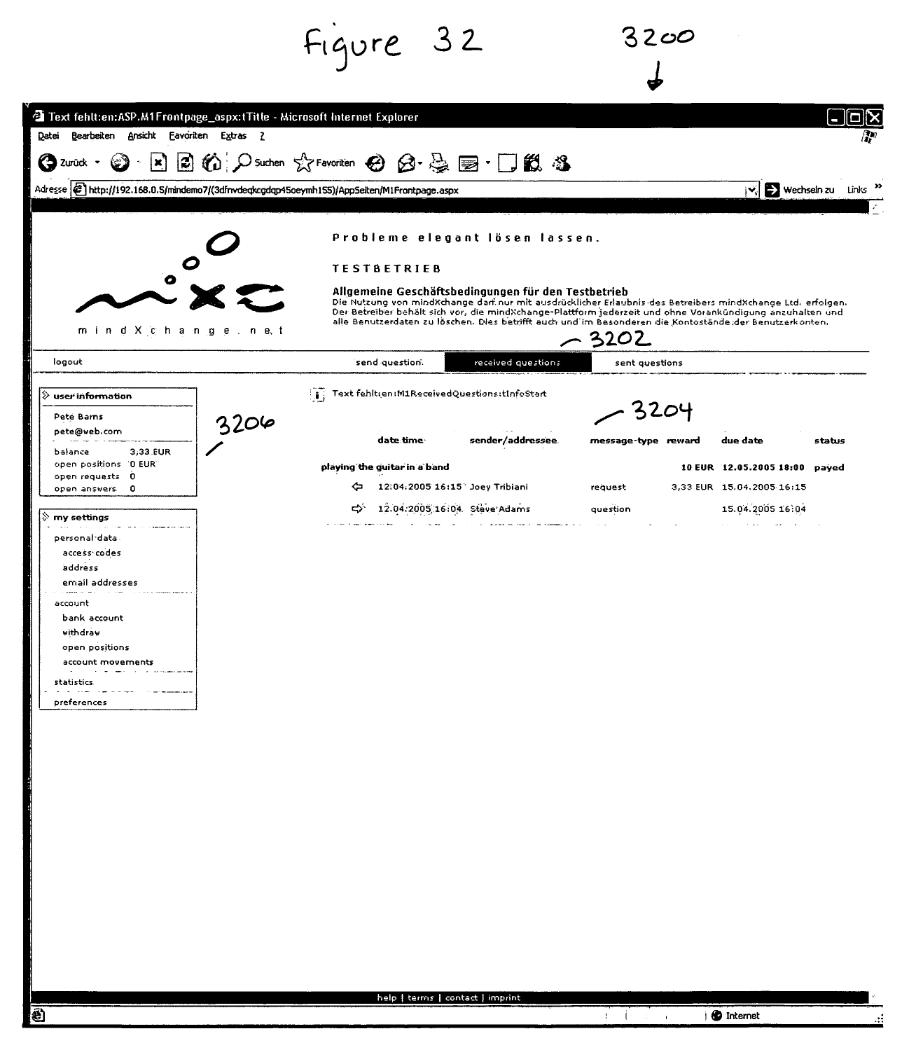

FIG. 32, generally at 3200, shows a screen display that would be generated by the system with regard to all of Mr. Barns' activities in the process. At 3202, it indicates that the information below is directed the questions received by Mr. Barns. At 3204, the first line shows the subject of the question, the reward, the due date for the answer to be provided, and the status that the reward has been “paid.”

The second line shows the time the request was forwarded to Mr. Tribiani, that the request was sent to Mr. Tribiani, that the message type: “request,” that Mr. Barns is due a reward of 3.33 Euros as a value-generating intermediary, and the due date for a response to the request message. The arrow at the beginning of the line indicates that request was sent by Mr. Barns to Mr. Tribiani.

The third line includes the time the question was sent to Mr. Barns, that Mr. Adams sent the question, the message type: “question,” and the due date for a response to the question message. The arrow at the beginning of the line indicates the message was sent by Mr. Adams to Mr. Barns.

The user information for Mr. Barns is shown at 3206. This information indicates Mr. Barns' account has had 3.33 Euros added to it as the reward for being a value-generating intermediary.

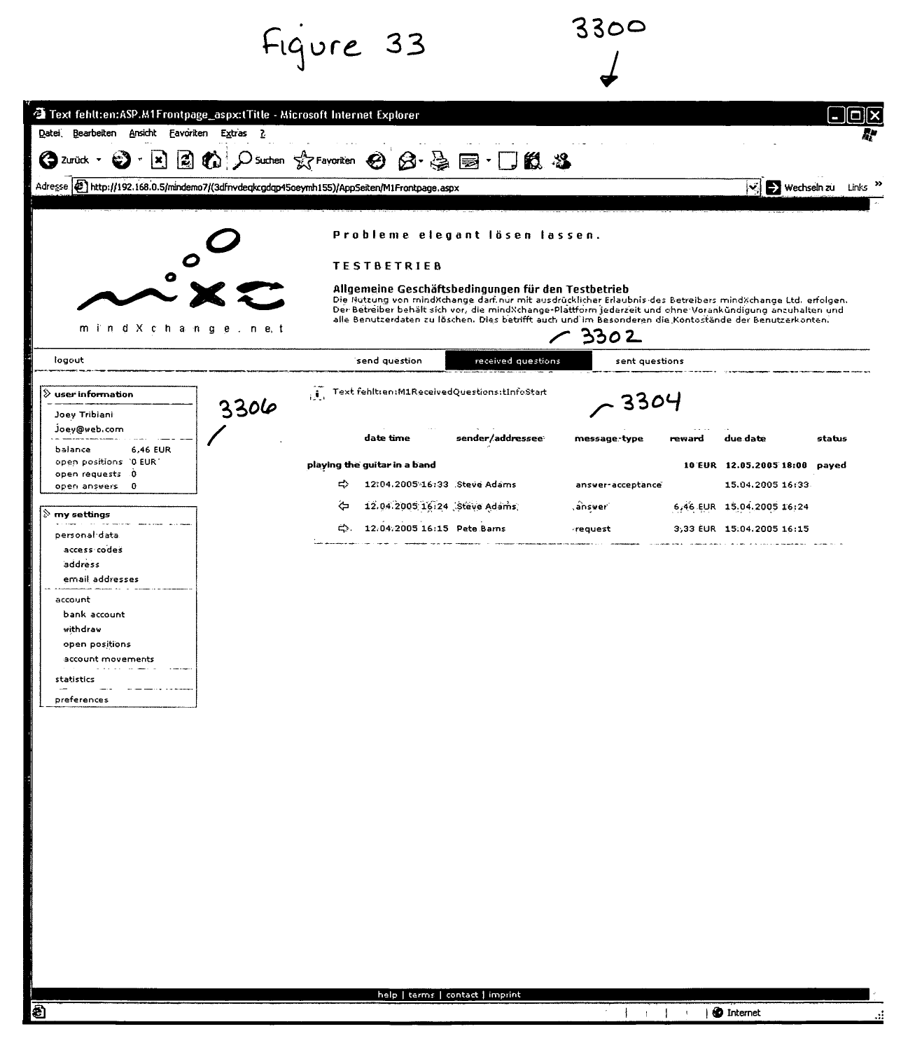

FIG. 33, generally at 3300, shows a screen display that would be generated by the system with regard to all of Mr. Tribiani's activities in the process. At 3302, the screen display indicates that the information below is directed to the questions received by Mr. Tribiani. At 3304, the first line shows the subject of the question, the reward, the due date for the answer to be provided, and the status of the reward as being “paid.”

The second line shows the time the answer-acceptance message was sent by Mr. Adams to Mr. Tribiani, that the message was sent from Mr. Adams, the message type: “answer-acceptance,” and the due date for a response to the answer-acceptance message. The arrow at the beginning indicated that the message was sent from Mr. Adams to Mr. Tribiani.

The third line shows the time the answer was forwarded to Mr. Adams, that the answer was sent to Mr. Adams, the message type: “answer,” the reward of 6.46 Euros is due Mr. Tribiani for answering the question, and the due date for a response to the answer message. The arrow at the beginning of the line indicates that answer was sent by Mr. Tribiani to Mr. Adams.

The fourth line shows the time the request was sent to Mr. Tribiani, that the request was sent from Mr. Barns, the message type, “request,” the reward of 3.33 Euros that is due Mr. Barns as a value-generating intermediary, and the due date for a response to the request message. The arrow at the beginning of the line indicates the message was sent by Mr. Barns to Mr. Tribiani.

The user information for Mr. Tribiani is shown at 3306. This information indicates Mr. Tribiani's account has had 6.46 Euros added to it as the reward for being the service provider.

The following is the calculation of the entitlement amounts for Mr. Barns as a value-generating intermediary and Mr. Tribiani as the service provider according to the reward algorithm that includes expressions (1)-(6) previously disclosed in the specification. The parameters for use in the reward algorithm are the following:

Reward = 10 Euros
Intermediation factor = 0.5
Participants = 2
System Fee = 3%
Mr. Tribiani's Entitlement

| Calculated | | |
|---|---|---|
| Term | Expression | Value |
| B | X * (1 − Y) = 10 * (1 − 0.5) = 10 * 0.5 | 5 |
| IS | B * (Y)^{P} = 5 * (0.5)⁰ = 5 * 1 | 5 |
| R | (Y)^{P} = (0.5)² | 0.25 |
| IE | $\frac{IS}{( 1 - R )} = \frac{5}{1 - 0.25} = \frac{5}{0.75}$ | 6.66 |
| F | IE * SF = 6.66 * 0.03 | 0.20 (plus 0.01 to |
| | | balance reward |
| | | amount) |
| E | IE − F = 6.66 − 0.20 | 6.46 |

Mr. Barns' Entitlement

| Calculated | | |
|---|---|---|
| Term | Expression | Value |
| B | X * (1 − Y) = 10 * (1 − 0.5) = 10 * 0.5 | 5 |
| IS | B * (Y)^{P} = 5 * (0.5)¹ = 5 * 0.5 | 2.5 |
| R | (Y)^{P} = (0.5)² | 0.25 |
| IE | $\frac{IS}{( 1 - R )} = \frac{2.5}{1 - 0.25} = \frac{2.5}{0.75}$ | 3.33 |
| F | Not Calculated for last Value-Generating | 0.00 |
| | Intermediary | |
| E | IE − F = 6.66 − 0.20 | 3.33 |

Where,
E =entitlement.
B = basic value for reward.
X = the reward amount.
IS = interim shares.
P = intermediaries position from the service provider.
Y = intermediation factor that is determined by the requester (prospect).
IE = the entitlement before the removal of system fees.
R = calculated constant for the number of participants.
PT = the total number of participants.
F = calculated fee amount.
SF = system fee percentage.

### EXAMPLE II

Example II will follow the same process transactions that were followed in the Example I to the point where Mr. Barns forwarded the request to Mr. Tribiani. At this point in the Example II, the process will take a different path that will further assist in describing the rule-based system and method of the present invention. Accordingly, the actions of Messrs. Adams, Barns, and Tribiani that follow FIGS. 16-24 are incorporated herein by reference in the Example II process.

FIG. 34, generally at 3400, shows a screen display for a request-rejection that is being sent from Mt. Tribiani to Mr. Barns after Mr. Tribiani, instead of answering the question as in Example I, decided to reject it.

At 3402, the display screen shows graphically that Mr. Tribiani is the second intermediary in the process of the present invention. The subject and status are provided at 3404. Below this, the addressee of the send back message is shown, which in this case is Pete Barns. At 3406, the actual message that Mr. Tribiani is sending to Mr. Barns is shown that explains why he cannot act on the request. By sending the rejection, Mr. Tribiani becomes a non-intermediary and not entitled to any part of the reward.

At 3408, information about the reward is shown along with Mr. Tribiani's desire to have his message seen by all system. Also, at 3408, the range, response time, and due date for the answer to be provided are shown. Another item shown is the amount that Mr. Tribiani would have received for providing the answer, which at this level would have been 6.46 Euros or for being a value-generating intermediary, which would have been up to 2.77 Euros.

At 3410, the screen display indicates that the action taken by Mr. Tribiani was to send the request back to Mr. Barns because Mr. Tribiani had to leave town.

At 3412, the user information for Mr. Tribiani is shown. The account information shows that Mr. Tribiani has a balance of 6.46 Euros from a previous transaction. The user information also indicates that one request is open, which is the one that Mr. Tribiani is sending back to Mr. Barns.

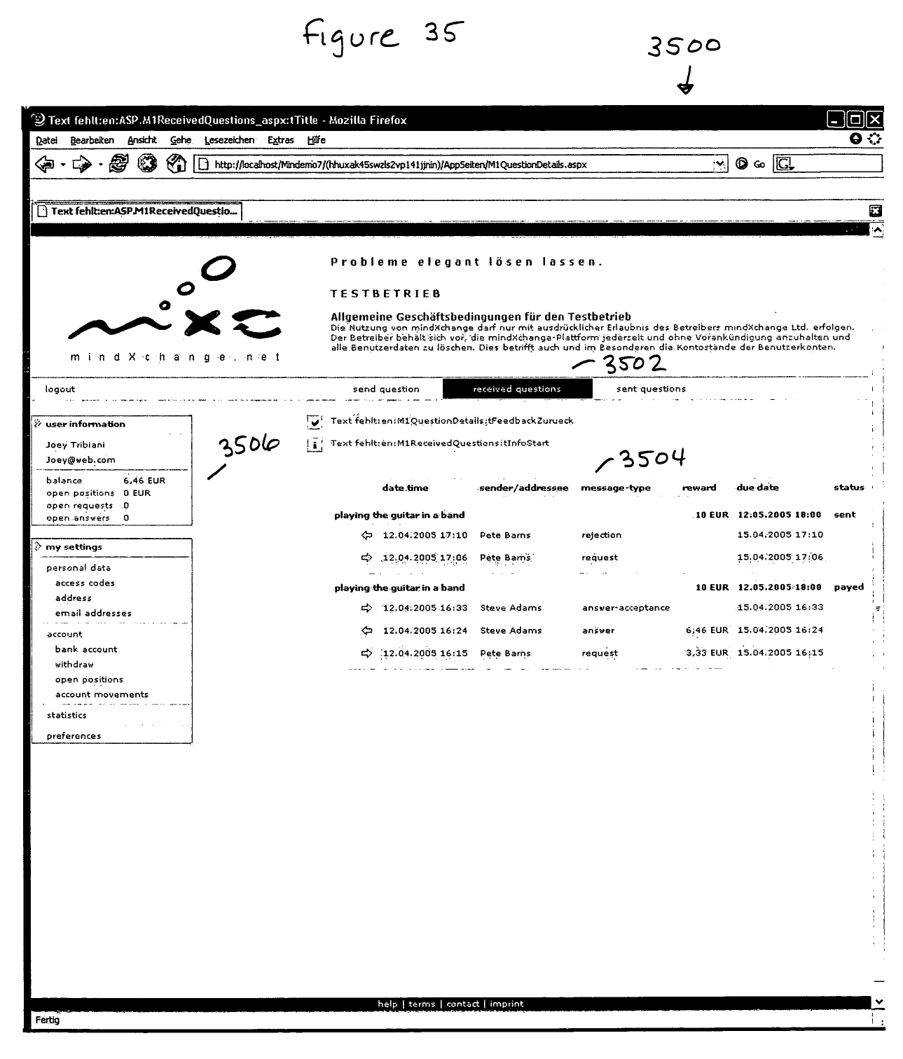

FIG. 35, generally at 3500, shows a screen display that would be generated by the system with regard to Mr. Tribiani's activity after sending the request back to Mr. Barns. At 3502, it indicates that the information below is directed the questions received by Mr. Tribiani. At 3504, the first line of the new process shows the subject of the question: “playing the guitar in a band,” which is the same as the subject of the first question, but this refers to a different problem to be solved. On the same line, the reward is shown, along with the due date for the answer to be provided, and the status of the question as being “sent.”

The second line shows the time the rejection was sent to Mr. Barns, that Mr. Barns was the addressee of the rejection, the message type: “rejection,” and the due date for a response to the rejection message. The arrow at the beginning of the line indicates that a rejection was sent by Mr. Tribiani to Mr. Barns.

The third line includes the time the request was sent to Mr. Tribiani, that Mr. Barns was the one that sent the request, the message type: “request,” and the due date for a response to the request message. The arrow at the beginning of the line indicates the message was sent by Mr. Barns to Mr. Tribiani.

At 3506, the user information for Mr. Tribiani is shown. The account information shows that Mr. Tribiani has a balance of 6.46 Euros from a previous transaction. The user information has changed to indicate that there are no open requests for Mr. Tribiani because the one that he had open was sent back to Mr. Barns, so it shows “0.”

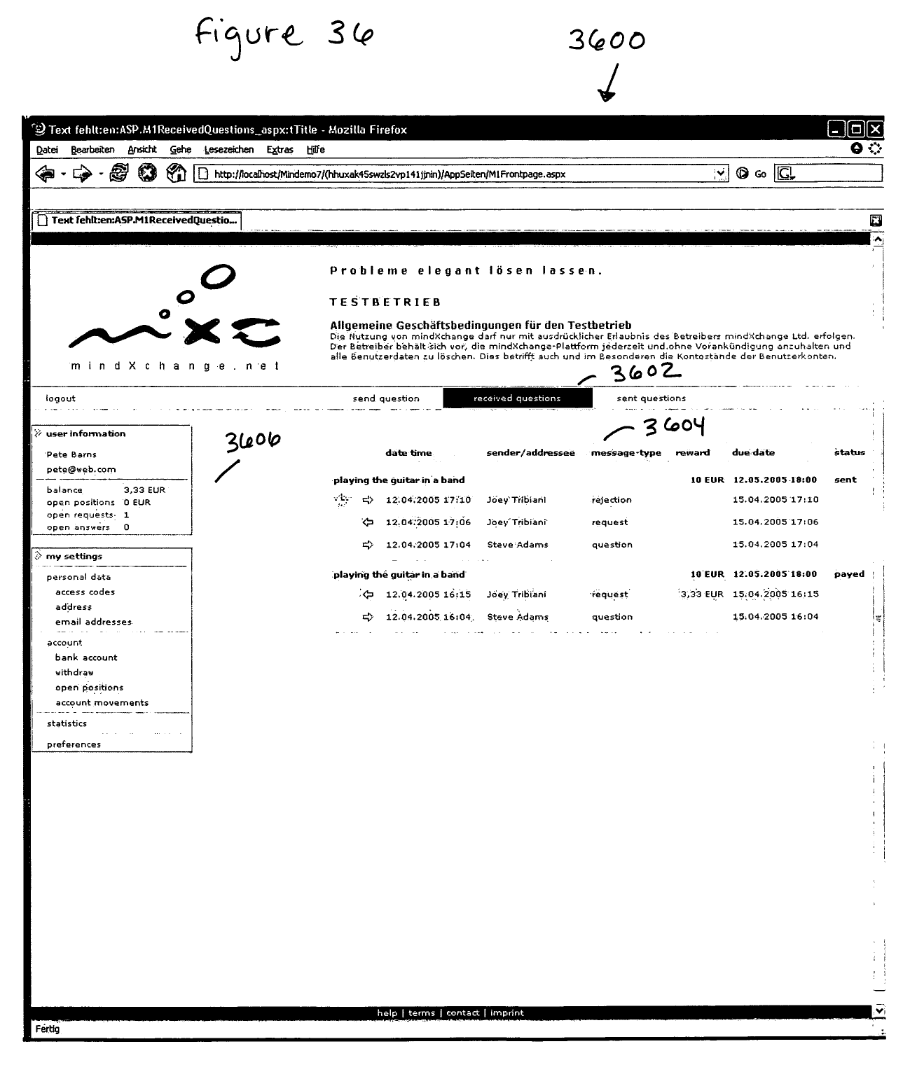

FIG. 36, generally at 3600, shows a screen display that would be generated by the system with regard to Mr. Barns after he receives the request back. At 3602, it indicates that the information below is directed the questions received by Mr. Barns. At 3604 with regard to the new process, the first line shows the subject of the question, the reward, the due date for the answer to be provided, and the status of the question as being “sent.”

The second line provides the time the rejection was sent by Mr. Tribiani, that the sender of the rejection was Mr. Tribiani, the message type: “rejection,” and the due date for a response to the rejection message. The arrow at the beginning of the line indicates that the message was sent from Mr. Tribiani to Mr. Barns.

The third line shows the time the request was forwarded to Mr. Tribiani, that the request was sent to Mr. Tribiani the message type: “request,” and the due date for a response to the request message. The arrow at the beginning of the line indicates that request was sent by Mr. Barns to Mr. Tribiani.

The fourth line includes the time the question was sent to Mr. Barns that Mr. Adams sent the question, the message type: “question,” and the due date for a response to the question message. The arrow at the beginning of the line indicates the message was sent by Mr. Adams to Mr. Barns.

At 3606, the user information for Mr. Barns is shown. The account information shows that Mr. Barns has a balance of 3.33 Euros from a previous transaction. The user information also indicates that one request is open, which is the one that Mr. Tribiani just sent back to Mr. Barns.

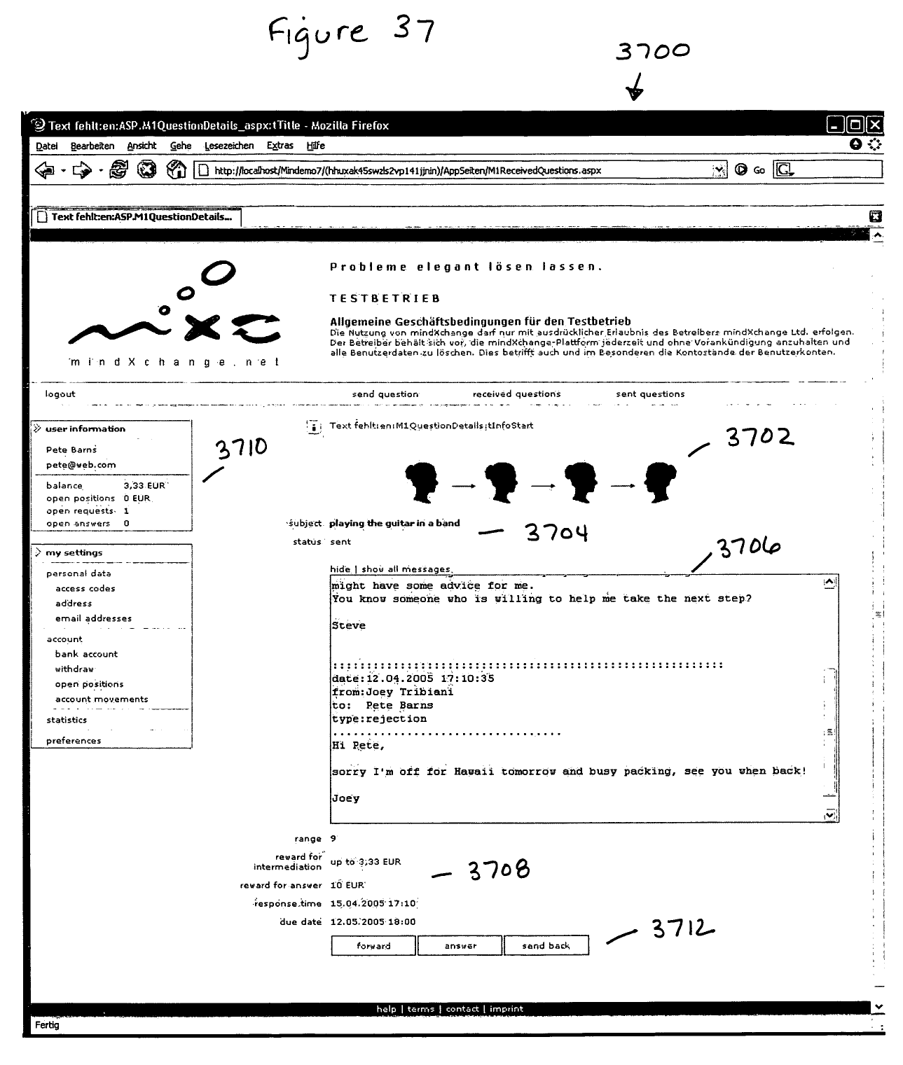

FIG. 37, generally at 3700, shows screen display that Mr. Barns will see when he logs onto the system. At 3702, the display screen shows Mr. Barns graphically as the last addressee in the process. The subject and status are provided at 3704. At 3706, the rejection message is provided to Mr. Barns. The rejection message will include the time the rejection was sent, the entity that sent the rejection, the recipient of the rejection, and the message type: rejection. Following this, the actual rejection message is presented.

At 3708, information about the parameters for receiving the reward is shown. Since the request was sent back to Mr. Barns, the range will be incremented by 1 to equal 9. The reward for intermediation at this level would be up to 3.33 Euros for Mr. Barns if he sent the question to another entity that answered it with no further forwarding. However, the reward for Mr. Barns if he answered the question would be 10 Euros. The next two items are the response time and due date for the answer to be provided.

At 3710, the user information for Mr. Barns is shown. The account information shows that Mr. Barns has a balance of 3.33 Euros from a previous transaction. The user information also indicates that one request is open, which is the one that Mr. Tribiani sent back to Mr. Barns.

At 3712, the possible actions that Mr. Barns can take are shown. He can forward the request to another intermediary, answer the question, or send the question back to the entity that sent it to him. As stated before, there is a fourth action which is do nothing and let the response time run out and it will be treated as if Mr. Barns decided to sent it back.

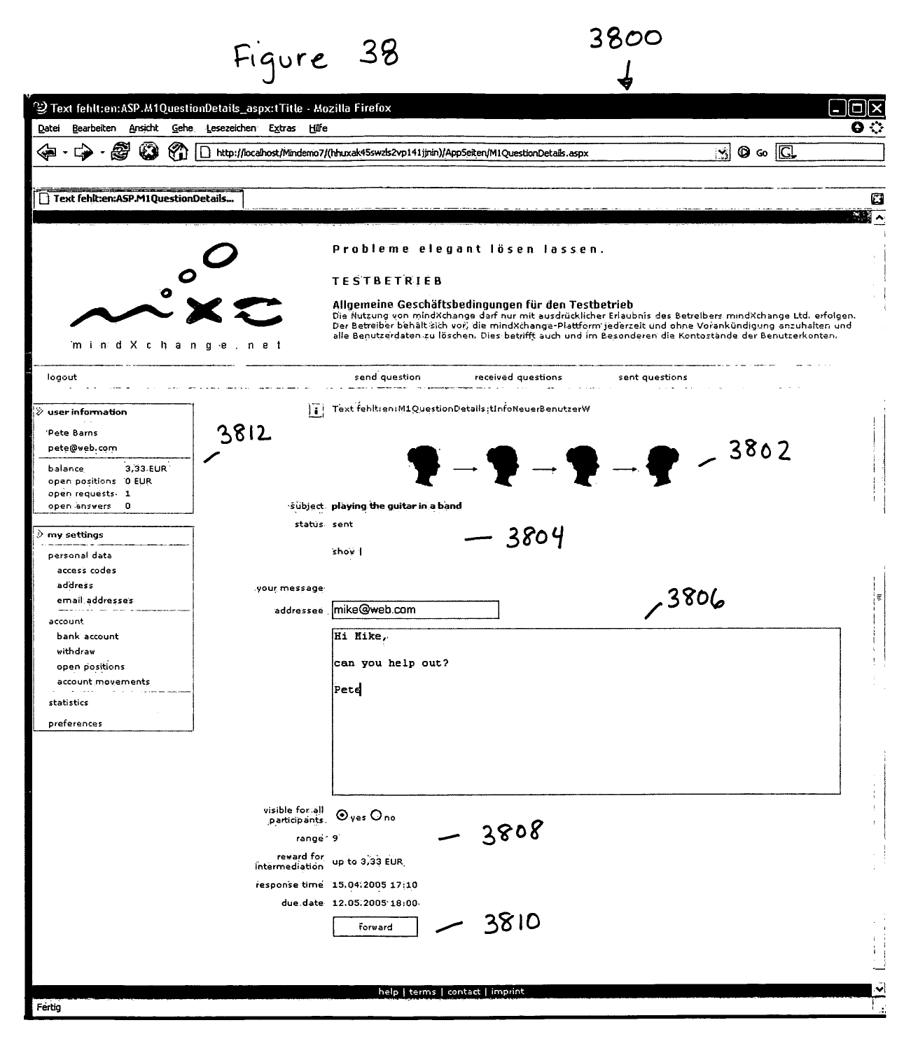

FIG. 38, generally at 3800, shows the screen display for Mr. Barns when he decided to forward the question to Mike Miller to hopefully provide the answer. At 3802, it shows graphically that a message exchange is taking place. At 3804, the subject of the question is shown, along with its status as “sent.” Next, Mr. Miller's e-mail address is shown. Following this, Mr. Barns' message to Mr. Miller is shown.

At 3808, information about the reward is shown along with Mr. Barns' desire to have his message seen by all process participants. At 3808, the range, response time, and due date the answer is to be provided are shown. Lastly, at 3808, the maximum amount for intermediation is shown because Mr. Barns is forwarding the question.

At 3810, the screen display indicates that the action taken by Mr. Barns is forwarding the question.

At 3812, the user information for Mr. Barns is shown. The account information shows that Mr. Barns has a balance of 3.33 Euros from a previous transaction. The user information also indicates that one request is open, which is the one that Mr. Tribiani sent back to Mr. Barns. This will change if the request is forwarded.

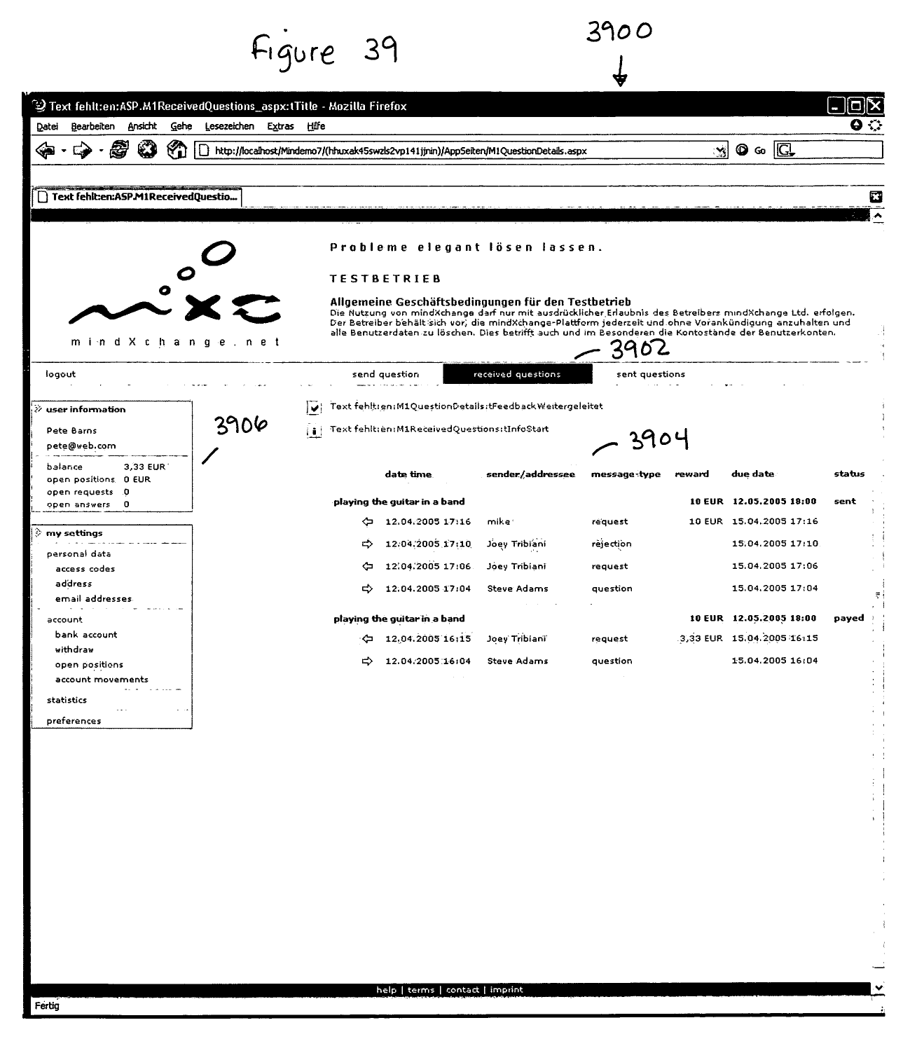

FIG. 39, generally at 3900, shows a screen display that would be generated by the system with regard to Mr. Barns' activities at this point in the new process. At 3902, it indicates that the information below is directed to the questions received by Mr. Barns. At 3904, with regard to this process, the first line shows the subject of the question, the reward, the due date the answer is to be provided, and the status of the question as being “sent.”

The second line provides the time the request was sent to Mr. Miller, that Mr. Miller was the addressee, the message type: “request,” the reward amount of 10 Euros, and the due date for the response to the request message. The arrow at the beginning of the second line indicates that the request was sent to Mr. Miller.

The third line includes the time the rejection was sent by Mr. Tribiani, that the sender of the rejection was Mr. Tribiani, the message type: “rejection,” and the due date for the response to the rejection message. The arrow at the beginning of the line indicates that the message was sent from Mr. Tribiani to Mr. Barns.

The fourth line shows the time the request was forwarded to Mr. Tribiani, that the request was sent to Mr. Tribiani, the message type: “request,” and the due date for the response to the request message. The arrow at the beginning of the line indicates that request was sent by Mr. Barns to Mr. Tribiani.

The fifth line of 3904 shows the time the question was sent to Mr. Barns, that Mr. Adams sent the question, the message type, “question,” and the due date for the response to the question message. The arrow at the beginning of the line indicates the message was sent by Mr. Adams to Mr. Barns.

At 3906, the user information for Mr. Barns is shown. The account information shows that Mr. Barns has a balance of 3.33 Euros from a previous transaction. The user information has changed to indicate that there are no open requests for Mr. Barns because the one open request that he had was forwarded to Mr. Miller.

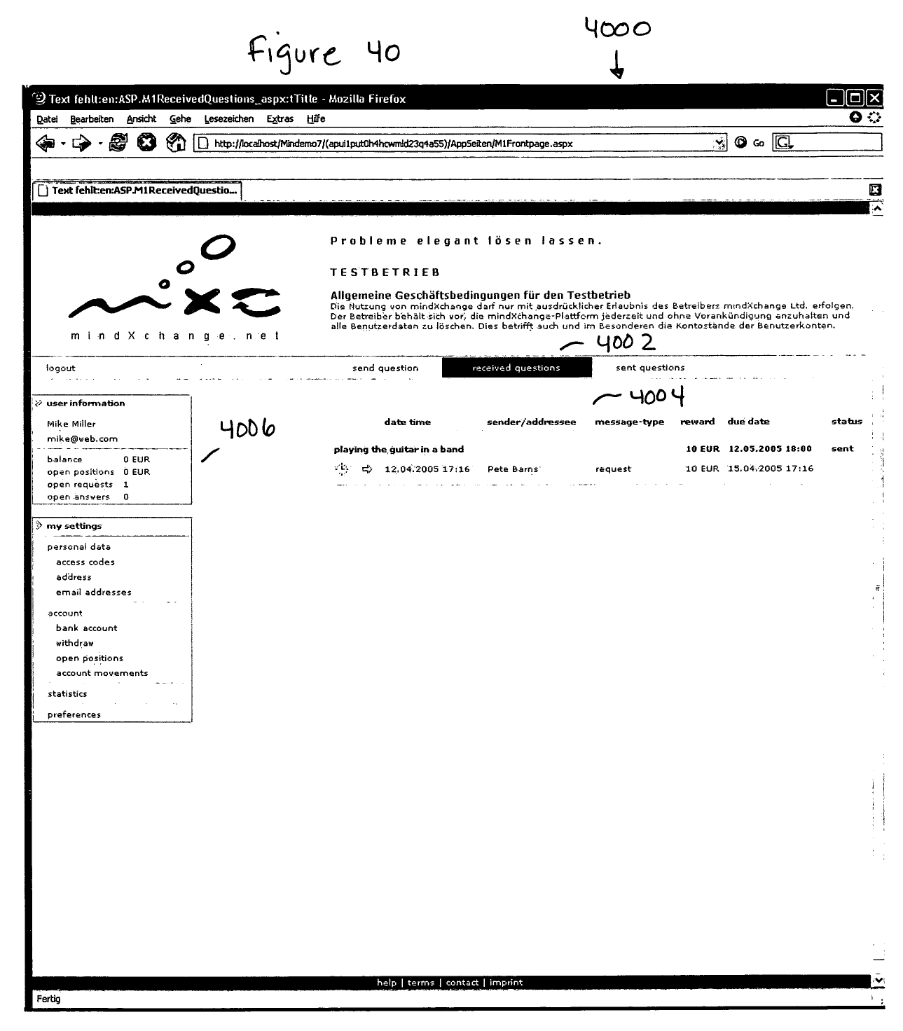

FIG. 40, generally at 4000, shows a display screen that would be generated by the system of the present invention to show the information relating to Mr. Miller once the request has been forwarded to him. At 4002, the screen display indicates that the information below is directed to the questions received by Mr. Miller. At 4004, the information about the request received by Mr. Miller is shown.

The first line shows the subject of the question along with the reward, the due date for the answer to be provided, and the status of the question as being “sent.” The next line provides the time the request was sent to Mr. Miller, that Mr. Barns was the entity that sent the request to Mr. Miller, the message type: “request,” the reward amount of 10 Euros, and the due date for a response to the request message. The arrow at the beginning of the line indicates that the request was sent from Mr. Barns to Mr. Miller.

At 4006, the user information for Mr. Miller is shown. The information shows that there is one open request, which is the one that was just forwarded from Mr. Barns.

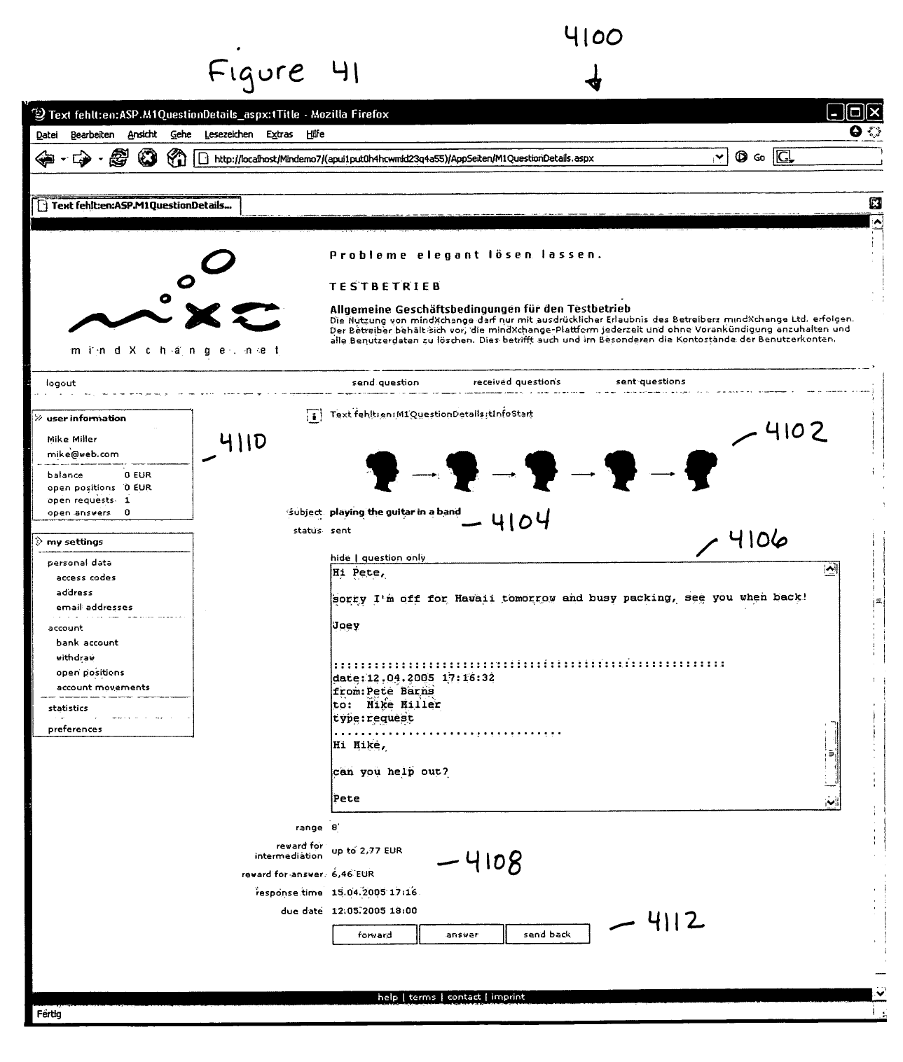

FIG. 41, generally at 4100, shows the message that Mr. Barns sent Mr. Miller that accompanies the request. At 4102, the display screen shows Mr. Miller graphically as the last addressee in the process. The subject and status are provided at 4104. At 4106, the message that Mr. Barns sent to Mr. Miller is shown. The message includes the time the request was sent, the entity that sent the request, the recipient of the request, and the message type: “request.” Following this, the actual message that Mr. Miller received is shown.

At 4108, information about the parameters for receiving the reward is shown. Since this is the second forwarding of the question (the rejection does not count as a forwarding of the question), the range changes to 8. The reward for intermediation at this level would be up to 2.77 Euros for Mr. Miller if he sends the question to another entity that answered it with no further forwarding. However, the reward for Mr. Miller if he answered the question would be 6.46 Euros. The next two items, response time and due dates, are same a previously described for the request.

At 4110, the user information for Mr. Miller is shown. As in FIG. 40 at 4006, it shows that there is one open request before Mr. Miller.

At 4112, the possible actions that Mr. Miller can take are shown. He can forward the request to another intermediary, answer the question, or send the question back to the entity that sent it to him. There is the previously discussed fourth action, which is do nothing and let the response time run out and it will be treated as if Mr. Miller decided to sent the question back.

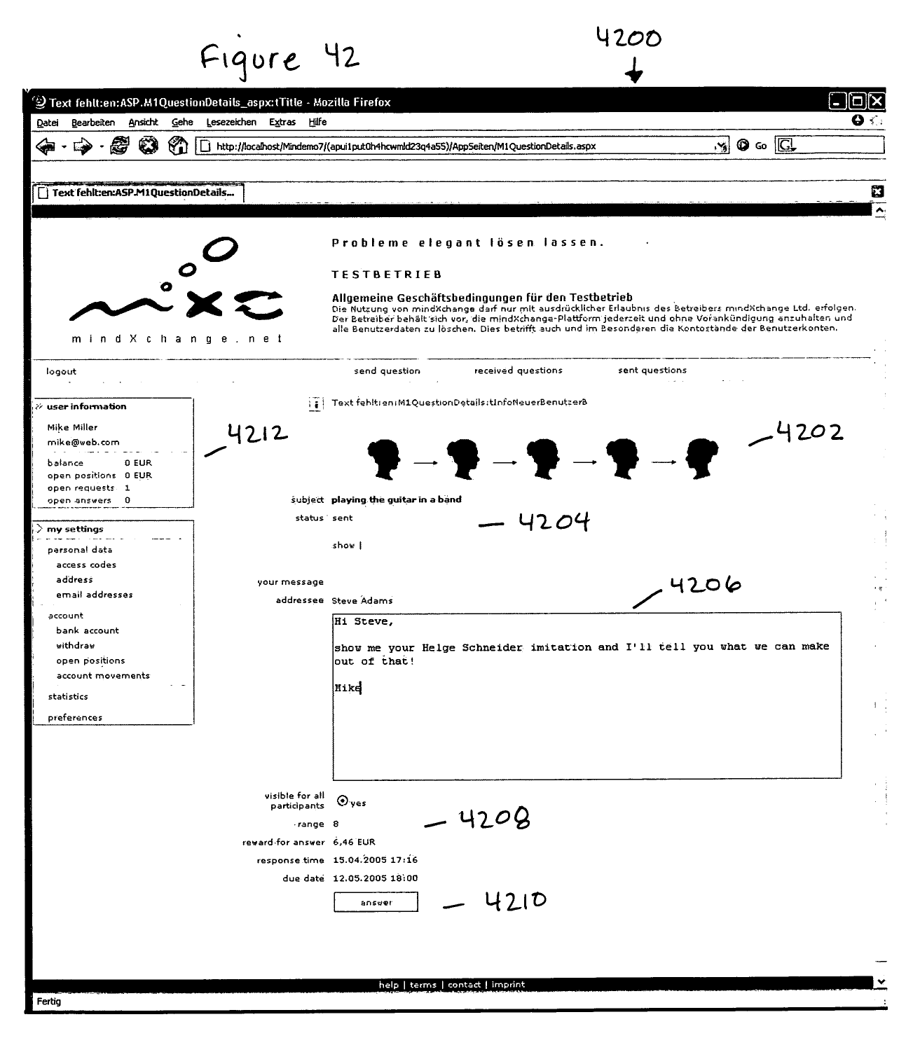

FIG. 42, generally at 4200, shows the answer that Mr. Miller sent to Mr. Adams. At 4202, the display screen shows Mr. Miller graphically as the last addressee in the process. The subject and status are provided at 4204. Below this, the addressee of the answer message is shown, “Steve Adams.” At 4206, the actual message that Mr. Miller is sending to Mr. Adams is shown.

At 4208, information about the reward is shown along with Mr. Miller's desire to have his message seen by all process participants. Also at 4208, the range, response time, and due date for the answer to be provided are shown. Finally, at 4208, the amount that Mr. Miller will receive for providing the answer is shown which at this level is 6.46 Euros.

At 4210, the screen display indicates that the action taken by Mr. Miller is answering the question.

At 4212, the user information for Mr. Miller is shown. It shows that there is one open request that will remain until his answer is sent to Mr. Adams.

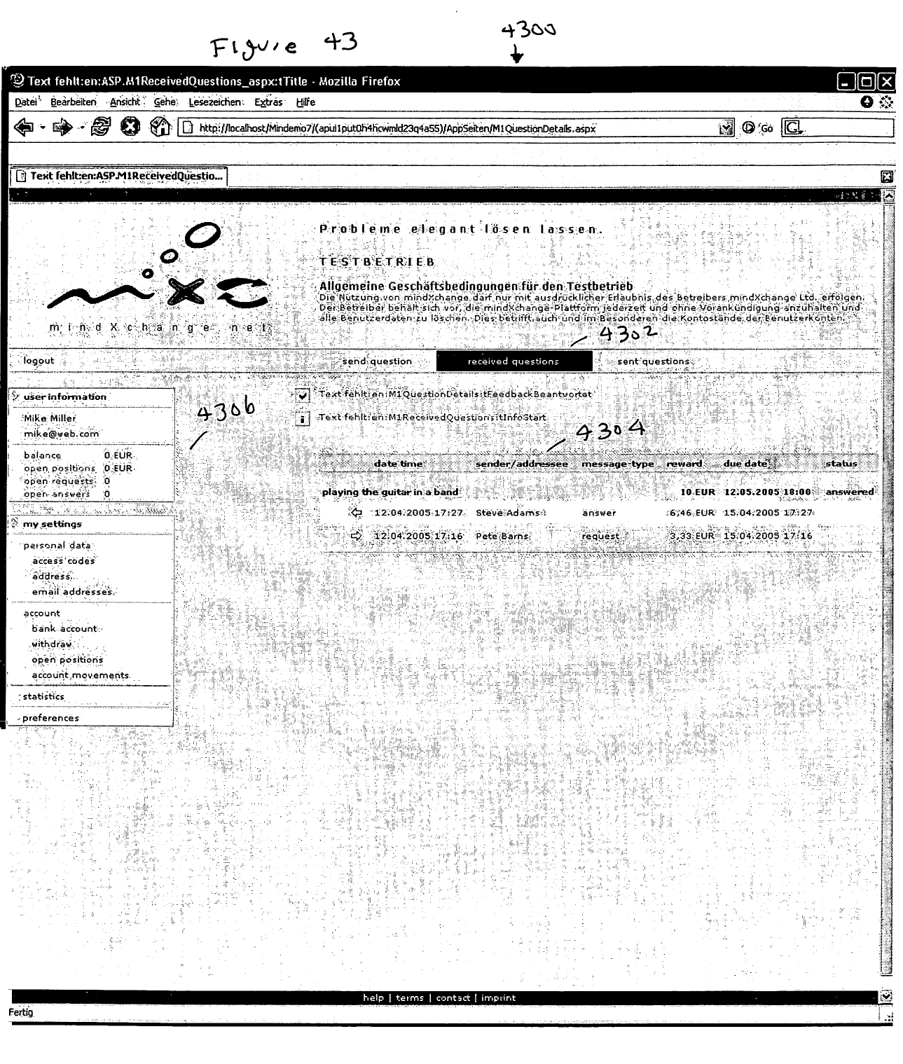

FIG. 43, generally at 4300, shows a screen display that would be generated by the system with regard to Mr. Miller's activities at the point he sent the answer to Mr. Adams. At 4302, the screen display indicates that the information below is directed to the questions received by Mr. Miller. At 4304, the first line shows the subject of the question, the reward, the due date for the answer to be provided, and the status of the question as being “answered.”

The second line includes the time the answer was forwarded, that the answer was sent to Mr. Adams, the message type: “answer,” the reward of 6.46 Euros that is due Mr. Miller for answering the question, and the due date for a response to the answer message. The arrow at the beginning of the line indicates that answer was sent by Mr. Miller to Mr. Adams.

The third line provides the time the request was sent to Mr. Miller, that Mr. Barns that sent the request, the message type, “request,” the reward of 3.33 Euros that is due Mr. Barns as a value-generating intermediary, and the due date for a response to the request message. The arrow at the beginning of the line indicates the message was sent by Mr. Barns to Mr. Miller.

The user information for Mr. Miller is shown at 4306. This information has changed because Mr. Miller has sent the answer to Mr. Adams. As such, Mr. Miller no longer has an open request before him. This is reflected in the open requests being “0.”

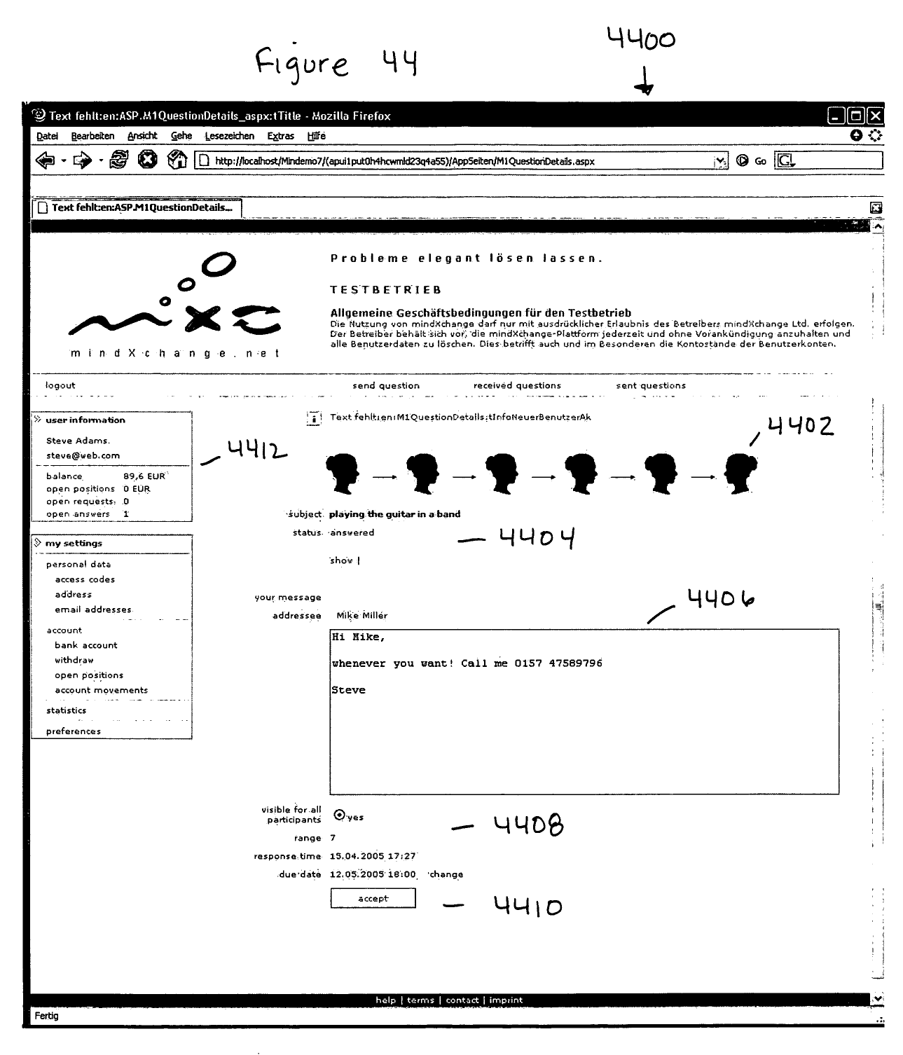

FIG. 44, generally at 4400, shows the answer-acceptance message that Mr. Adams sent to Mr. Miller. At 4402, the display screen shows Mr. Adams graphically as the last addressee in the process. The subject and status are provided at 4404. Below this, the addressee of the answer-acceptance message, Mr. Miller, is shown. At 4406, the actual message that Mr. Adams is sending to Mr. Miller is shown.

At 4408, information about the answer-acceptance is shown along with Mr. Adams' desire to have his message seen by all process participants. Also at 4408, the range, response time, and due date for the answer to be provided are shown.

At 4410, the screen display indicates that the action taken by Mr. Adams is accepting the answer.

At 4412, the user information for Mr. Adams is shown. This information indicates that Mr. Adams has an account balance of 89.6 Euros and there is an open answer for him to accept or reject. The 89.6 Euro account balance provides sufficient funds to pay the reward. Therefore, Mr. Adams does not need to add funds to his account balance to pay the reward.

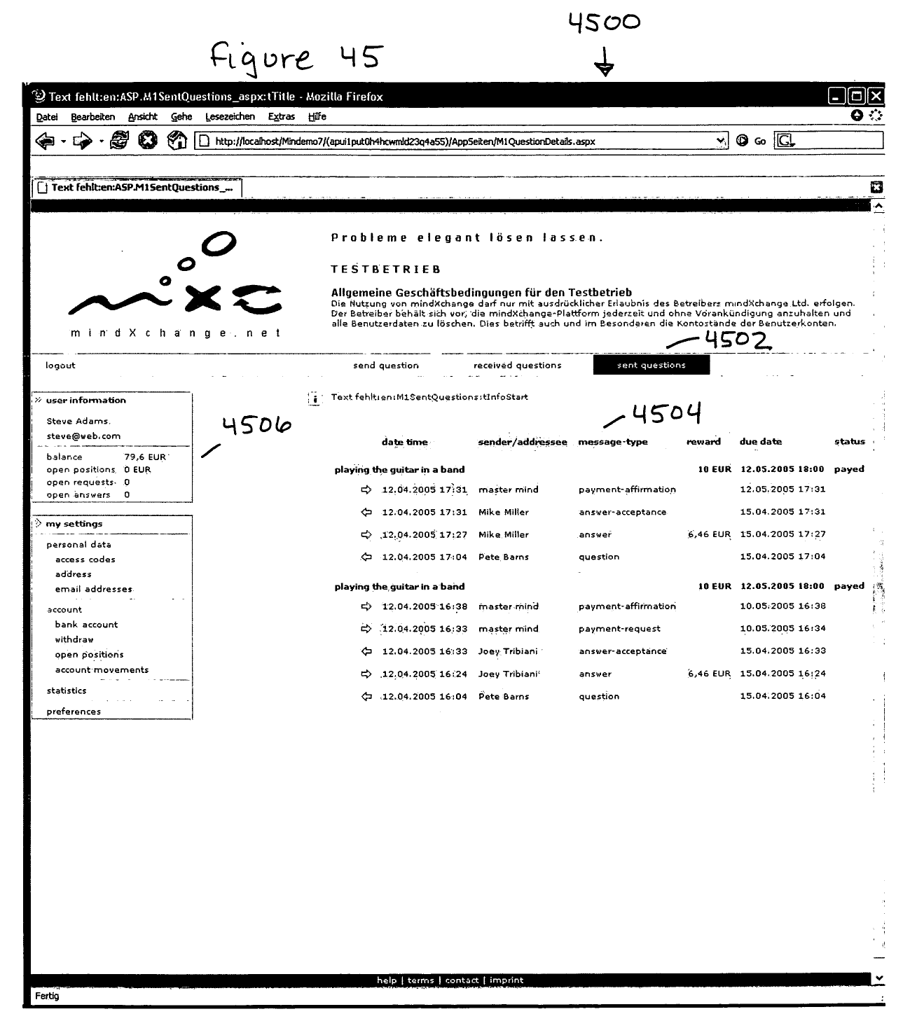

FIG. 45, generally at 4500, shows a screen display that would be generated by the system with regard to payment-affirmation. At 4502, the screen display indicates that the information below is directed to the questions sent by Mr. Adams. At 4504, the first line shows the subject of the question, the reward, the due date for the answer to be provided, and the status of the reward as being “paid.”

The second line shows that the system generated a payment-affirmation message that it sent to Mr. Adams. The second line includes the time the payment-affirmation message was sent, the originator of the message (the system master mind), the message type: “payment-affirmation,” and the due date for a response to the payment-affirmation message. The arrow at the beginning of the second line indicates that the message was sent from the system to Mr. Adams.

The third line provides the time the answer-acceptance message was sent, that it was sent to Mr. Miller, the message type: “answer-acceptance,” and the due date for a response to the answer-acceptance message. The arrow at the beginning of the line shows that the answer-acceptance was sent from Mr. Adams to Mr. Miller.

The fourth line includes the time the answer was forwarded to Mr. Adams, that the answer was sent by Mr. Miller, the message type: “answer,” the reward of 6.46 Euros that is due to Mr. Miller for answering the question, and the due date for a response to the answer message. The arrow at the beginning of the line indicates that answer was sent by Mr. Miller to Mr. Adams.

The fifth line shows the time the question was sent to Mr. Barns, that Mr. Barns sent the question, the message type: “question,” and the due date for a response to the question message. The arrow at the beginning of the line indicates the message was sent by Mr. Adams to Mr. Barns.

The user information for Mr. Adams is shown at 4506. This information indicates that Mr. Adams has a 79.6 Euros because the 10 Euros reward was deducted from the previous 89.6 Euro account balance.

In Example II, there were 2 participants that will share in the reward. These are Mr. Miller, as the service provider, and Messrs. Barns, as the value-generating intermediary. The calculation of the entitlement for Mr. Miller will be the same as it was for Mr. Tribiani in Example I and Mr. Barns will receive the same as he did in Example I. As such, these calculations are incorporated here by reference.

The terms and expressions that are employed herein are terms or descriptions and not of limitation. There is no intention in the use of such terms and expressions of excluding the equivalents of the feature shown or described, or portions thereof, it being recognized that various modifications are possible within the scope of the invention as claimed.

1. A method for intermediation for effecting a problem solution using a scale-free network, comprising the steps of:
(A) a requester determining a problem for which intermediation is required for reaching a solution to the problem within a predetermined period of time;
(B) the requester selecting and contacting an entity in the scale-free network for intermediation to provide the solution to the problem;
(C) the entity selected and contacted at step (B) choosing one course of action from a group of potential actions consisting of forwarding the problem to another entity for intermediation, providing the solution to the problem to the requester, and rejecting the problem, with
(1) forwarding the problem resulting in the method proceeding to step (D),
(2) providing a solution to the problem to the requester resulting in the method proceeding to step (E), and
(3) rejecting the problem and sending it back to the requester resulting in the method proceeding to step (B);
(D) the entity in the scale free network that selected the action of forwarding the problem at step (C) or (F) selecting a new entity for intermediation of the problem, with the new entity choosing one course of action from the group of actions consisting of forwarding the problem to another entity for intermediation, providing a solution to the problem to the requester, and rejecting the problem, with
(1) forwarding the problem resulting in repeating steps (D) and (D)(1) for a maximum predetermined number of times with an entity in the scale-free network that has not been previously selected for intermediation of the problem;
(2) providing the solution to the problem to the requester resulting in the method proceeding to step (E), and
(3) rejecting the problem resulting in the method proceeding to step (F);
(E) the requester
(1) accepting the intermediated solution to the problem and ending the method or
(2) rejecting the intermediated solution and returning the problem to the entity in the scale-free network that provided the intermediated solution, with that entity receiving the problem back choosing one course of action from a group of potential actions consisting of forwarding the problem to another entity for intermediation, providing the solution to the problem, and rejecting the problem, with
(a) forwarding the problem resulting in the method proceeding to step (D),
(b) providing a solution to the problem being providing a different solution and repeating step (E), and
(c) rejecting the problem resulting in the method proceeding to step (F); and
(F) the entity in the scale-free network receiving the problem back and sending the problem back to the entity in the scale-free network that sent the problem to that entity, with the entity being sent back the problem choosing one course of action from a group of potential actions consisting of forwarding the problem to another entity in the scale-free network for intermediation, providing a solution to the problem, and rejecting the problem, with
(1) forwarding the problem resulting in the method proceeding to step (D),
(2) if the problem is received back from step (E), then providing a solution to the problem by providing a different solution to the problem and repeating step (E),
(3) if the problem is received back from step (D), then providing a solution to the problem and proceeding to step (E), and
(4) rejecting the problem resulting in repeating step (F) until the problem is returned to the requester.

2. The method as recited in claim 1, wherein the requester determines the number of times the problem may be forwarded during the predetermined time within which the intermediated solution to the problem is required to be reached.

3. The method as recited in claim 1, wherein the method includes providing remuneration to an entity that provided an accepted intermediated solution to the problem.

4. The method as recited in claim 3, wherein providing remuneration to each entity in a forwarding path between the requester and the entity that provided the accepted intermediated solution to the problem.

5. The method as recited in claim 4, wherein the remuneration includes legal tender or virtual currency.

6. The method as recited in claim 4, wherein the payment of the remuneration becomes due upon the requester accepting the intermediated solution to the problem.

7. The method as recited in claim 1, wherein the requester of the scale free network includes humans, legal entities, or software agents.

8. The method as recited in claim 1, wherein the entities of the scale free network include humans, legal entities or software agents.

9. The method as recited in claim 1, wherein if a problem is sent back to the requester based on a rejection at step (C)(3) or step (F)(4), then the requester selecting and contacting an entity in the scale-free network other than the entity that rejected the question at this step (C) or step (F) for intermediation of the problem or the requester ending the intermediation method.

10. A method for determining if an intermediation method should be used to find a solution to a problem using a scale-free network, comprising the steps of:
determining a service value (SV) of the solution to the problem;
determining a reward value (RV) of a solution to the problem;
determining a minimum intermediary reward (MIR) for the solution to the problem;
determining a minimum service provider reward (MSR) for the solution to the problem;
determining a system intermediary reward (SIR) for the solution to the problem;
determining a system service reward (SSR) for the solution to the problem; and
using the intermediation method if at least SV is greater than RV, SIR is greater than MIR, and SSR is greater than MSR.

11. The method as recited in claim 6, wherein SSR includes being determined by the expression
SSR=X*(1−Y)
where,
X=a reward amount
Y=an intermediation factor that includes a value according to 0 <Y <1.

12. The method as recited in claim 7, wherein SSR includes being determined by the expression
SIR=SSR*(Y)
where,
SSR=system service reward
Y=an intermediation factor that includes a value according to 0<Y<1.

13. A method for intermediation for effecting a problem solution using a scale-free network, comprising the steps of:
(A) a requester determining a problem for which intermediation is required for reaching a solution to the problem within a predetermined period of time;
(B) the requester selecting and contacting an entity in the scale-free network for intermediation to provide the solution to the problem;
(C) the entity selected and contacted at step (B) choosing one course of action from a group of potential actions consisting of forwarding the problem to another entity for intermediation, providing the solution to the problem to the requester, and rejecting the problem, with
(1) forwarding the problem resulting in the problem being forwarded for intermediation by another entity in the scale-free network,
(2) answering the problem resulting in the problem being answered and sending a solution to the requester;
(3) rejecting the problem resulting in sending the problem back to the requester or entity in the scale-free network that sent it to the entity sending it back; and
(D) repeating at least the three choices at step (C) for each entity in the scale-free network that is selected and contacted for intermediation by the requester or an entity in the scale-free network that receives the problem by forwarding or rejection.

14. The method as recited in claim 13, wherein the requester determines the number of times the problem may be forwarded during the predetermined time within which the intermediated solution to the problem is required to be reached.

15. The method as recited in claim 13, wherein the method includes providing remuneration to an entity that provided an accepted intermediated solution to the problem.

16. The method as recited in claim 15, wherein providing remuneration to each entity in a forwarding path between the requester and the entity that provided the accepted intermediated solution to the problem.

17. The method as recited in claim 16, wherein the remuneration includes legal tender or virtual currency.

18. The method as recited in claim 16, wherein the payment of the remuneration becomes due upon the requester accepting the intermediated solution to the problem.

19. The method as recited in claim 13, wherein the requester of the scale free network includes humans, legal entities, or software agents.

20. The method as recited in claim 13, wherein the entities of the scale free network include humans, legal entities, or software agents.

21. A method for intermediation for effecting a problem solution using a scale-free network and a communications network (CN), comprising the steps of:
(A) a requester determining a problem for which intermediation is required for reaching a solution to the problem within a predetermined period of time;
(B) the requester selecting an entity in the scale-free network and contacting that entity using the CN for intermediation to provide the solution to the problem;
(C) the selected entity in the scale-free network accessing information regarding the problem using the CN and choosing one course of action from a group of potential actions consisting of forwarding the problem to another entity in the scale-free network for intermediation and proceeding to step (D), providing the solution to the problem to the requester using the CN and proceeding to step (E), and rejecting the problem, and contacting and sending the problem back to the requester or entity in the scale-free network that sent the problem using the CN to the selected entity of step (C) and proceeding to step (F),
(D) the entity in the scale-free network that selected the action of forwarding the problem at step (C) or (F) selecting and contacting a new entity in the scale-free network using the CN for intermediation of the problem, with the new entity in the scale-free network proceeding to step (C),
(E) the requester receiving the solution to the problem over the CN
(1) accepting the intermediated solution the problem and ending the method, or
(2) rejecting the intermediated solution and returning the problem to the entity in the scale-free network that provided the intermediated solution using the CN, and proceeding to step (C) for the entity in the scale-free network receiving the problem back over the CN choosing one course of action from the group of potential actions; and
(F) the requester or entity in the scale-free network receiving the problem back from over the CN, with
(1) the requester proceeding to step (B) and selecting an entity in the scale-free network for intermediation other than the entity that rejected the problem, or
(2) the entity in the scale-free network receiving the problem back proceeding to step (C) and selecting, and if forwarding is selected, selecting an entity for intermediation other than the entity in the scale-free network that rejected the problem.

22. The method as recited in claim 21, wherein the CN includes the Internet, an intranet, a Lotus Notes infrastructure, a Microsoft Exchange infrastructure, a cellular telephone network, a local area network, a municipal area network, or a wide area network.

23. The method as recited in claim 21, wherein the requester determines the number of times the problem may be forwarded during the predetermined time within which the intermediated solution to the problem is required to be reached.

24. The method as recited in claim 21, wherein the method includes providing remuneration to an entity that provided an accepted intermediated solution to the problem.

25. The method as recited in claim 24, wherein providing remuneration to each entity in a forwarding path between the requester and the entity that provided the accepted intermediated solution to the problem.

26. The method as recited in claim 25, wherein the remuneration includes legal tender or virtual currency.

27. The method as recited in claim 25, wherein the payment of the remuneration becomes due upon the requester accepting the intermediated solution to the problem.

28. The method as recited in claim 21, wherein the requester of the scale free network includes humans, legal entities, or software agents.

29. The method as recited in claim 21, wherein the entities of the scale free network include humans, legal entities, or software agents.

30. The method as recited in claim 21, wherein the requester communicates with the CN using a computer-based system.

31. The method as recited in claim 21, wherein each entity in the scale-free network communicates with the CN using a computer-based system.

32. The method as recited in claim 21, wherein the requester and each entity in the scale-free network connect to a central computer-based system for communications.

33. The method as recited in claim 32, wherein the CN is connected to the central computer-based system.

34. The method as recited in claim 33, wherein the requester communicates with the central computer-based system with computer terminal equipment.

35. The method as recited in claim 33, wherein each entity in the scale-free network communicates with the central computer-based system with computer terminal equipment.

36. A method for intermediation for effecting a problem solution using a scale-free network, comprising the steps of:
(A) a requester determining a problem for which intermediation is required for reaching a solution to the problem within a predetermined period of time;
(B) the requester selecting and contacting an entity in the scale-free network for intermediation to provide the solution to the problem;
(C) the entity selected and contacted choosing one course of action from a group of potential actions consisting of forwarding the problem to another entity for intermediation, providing the solution to the problem to the requester, and rejecting the problem, with
(1) forwarding the problem by selecting and contacting another entity in the scale-free network for intermediation to provide the solution to the problem resulting in the method proceeding to step (C),
(2) answering the problem resulting in the problem being answered and sending a solution to the requester;
(3) rejecting the problem by selecting and contacting:
(a) the requester, if the requester sent the problem to the entity sending it back resulting in the requester ending the intermediation or proceeding to step (B) or
(b) the entity in the scale-free network that sent the problem to the entity sending the problem back, with the entity receiving the problem back proceeding to step (C).

37. The method as recited in claim 36, wherein the requestor of the scale free network includes humans, legal entities, or software agents.

38. The method as recited in claim 36, wherein the entities of the scale free network include humans, legal entities, or software agents.

39. The method as recited in claim 36, wherein the method includes providing remuneration to an entity that provided an accepted intermediated solution to the problem.

40. The method as recited in claim 39, wherein providing remuneration to each entity in a forwarding path between the requester and the entity that provided the accepted intermediated solution to the problem.

41. The method as recited in claim 40, wherein the remuneration includes legal tender or virtual currency.

42. The method as recited in claim 40, wherein the payment of the remuneration becomes due upon the requester accepting the intermediated solution to the problem.
